(19) United States
(12) Patent Application Publication
(10) Pub. No.: US 2005/0203718 A1
(43) Pub. Date: Sep. 15, 2005

(54) Knowledge management system with integrated product document management for computer-aided design modeling

(76) Inventors: Rick A. Carek, University Heights, OH (US); Roger M. Mikulandra, Chardon, OH (US)

Correspondence Address: BROMBERG & SUNSTEIN LLP, 125 SUMMER STREET, BOSTON, MA, 02110-1618, US

(21) Appl. No.: 10/800,051

(22) Filed: Mar. 12, 2004

(51) Int. Cl. G06F 17/50

(52) U.S. Cl. 703/1

(57) ABSTRACT

A knowledge management system captures, stores, manages, and applies rules for modeling geometric objects and related non-geometric attributes, and includes integrated support for one or more third party product document management systems. The knowledge management system can store documents in the product document management system, such as templates for generated computer-aided design system components. An add-in program may be executed by the computer-aided design system for creating and managing template documents in the product document management system for use by the knowledge management system.

### FIELD OF THE INVENTION

The present invention relates generally to computer-aided design, and, more particularly, to a knowledge management system with integrated product document management for computer-aided design modeling.

### BACKGROUND OF THE INVENTION

Computer-aided design (CAD) systems can be used to produce and manipulate geometric models. CAD systems often include very sophisticated algorithms for producing complex geometric models, manipulating those models, and analyzing the components of those models. For example, a CAD system may be used to model a complex structure having a curved surface, view the structure at various angles, and calculate the surface area of the curved surface and the volume of the structure as a whole. It might be useful to know the surface area of the curved surface, for example, to determine how much paint would be needed to cover the surface. It might be useful to know the volume of the structure, for example, to determine how much material would be needed to produce the structure.

While CAD systems can be very powerful modeling tools, they are generally limited to geometric modeling. Thus, CAD systems generally require the user to apply product design rules and practices necessary to produce the model. For example, if the user is required by an employer to use certain practices (such as, for example, always using a certain size bolt to connect two components), then the user must apply those practices to the model. The user is typically also required to make successive changes to a model when changing a component of the model. For example, each time the user changes an attribute of a component (such as, for example, the outside diameter of a component), the user may have to change attributes of one or more other components that connect or otherwise interact with that component, and the effects of these changes may cascade through many components of the model. The user is typically also required to handle non-geometric attributes of the model (such as, for example, component pricing and manufacturing processes). As a result of these limitations, CAD systems can be difficult to use, particularly for casual CAD users (such as engineers, architects, or managerial staff) who may not be proficient with the CAD system but often need to make modifications to drawings or models on an as-needed basis.

Knowledge-based engineering (KBE) attempts to combine some level of knowledge management with design automation. Knowledge management typically includes such things as best practices, lessons learned (e.g., from earlier models), common practices (e.g., industry standards, company policies), product design rules, and quality metrics. Knowledge management might be applied to design automation, for example, to reduce the number of parts a company needs to order (e.g., by reusing parts from one model in another model), reduce design time, reduce product cost, and produce higher quality and reliability. KBE functionality is typically implemented within a CAD system or as an add-on to a CAD system (e.g., as a plug-in) so as to provide the CAD system with additional knowledge management capabilities.

CAD systems are often used in conjunction with computer-aided engineering (CAE) analysis tools for performing advanced model analysis. CAD systems are also often used in conjunction with product document management (PDM) tools for generating and maintaining product documentation. These CAE and PDM tools can be implemented as stand-alone applications or as add-ons to a CAD system. The KBE functionality may interact with the CAE and PDM tools to gather or provide information.

### SUMMARY OF THE INVENTION

In various embodiments of the present invention, a knowledge management system captures, stores, manages, and applies rules for modeling geometric objects and related non-geometric attributes, and includes integrated support for one or more third party product document management systems. The knowledge management system can store documents in the product document management system, such as templates for generated computer-aided design system components. An add-in program may be executed by the computer-aided design system for creating and managing template documents in the product document management system for use by the knowledge management system.

Thus, in one aspect of the invention there is provided a computer-aided modeling system having a computer-aided design system, a product document management system, and a knowledge management system. The knowledge management system interacts with the product document management system for storing and retrieving modeling documents and interacts with the computer-aided design system for generating computer-aided design models based on the modeling documents. The knowledge management system includes integrated support for the product document management system. Among other things, this integrated support for the product document management system allows the use of the product document management system to be substantially transparent to a user.

The knowledge management system typically includes a knowledge management application and a document access manager in communication with the product document management system. The knowledge management application interfaces with the product document management system through the document access manager. The document access manager may be implemented as a dynamic link library. The computer-aided modeling system may include a fileshare accessible by the document access manager, in which case the document access manager selects between the product document management system and the fileshare for managing documents.

The product document management system typically includes at least one predefined document management object specific to the knowledge management system for storing knowledge management system documents related to corresponding computer-aided design system documents. The product document management system typically includes a plurality of knowledge management system specific document management objects, each associated with a different type of computer-aided design system document. The product document management system typically includes a part template object associated with corresponding computer-aided design system part documents and an assembly template object associated with corresponding computer-aided design system assembly documents. The knowledge management system stores documents in the product document management system using the objects.

The knowledge management application may generate part numbers for computer-aided design system parts based on parametrically defined part objects stored in the product document management system. The knowledge management application typically maps a part to an existing part number if one is available, or else creates a new part number for the part.

The computer-aided modeling system may include an add-in program for the computer-aided design system. The add-in program provides for interaction between the computer-aided design system and the product document management system for creation and management of template documents to be used by the knowledge management system at run-time. The add-in program typically creates a knowledge management system specific menu in the computer-aided design system. The add-in program typically allows a user to connect to the product document management system, to locate and open existing documents in the product document management system, to insert a document from the product document management system into a computer-aided design model, to classify an active document in the product document management system for part number research, to unlock active documents in the product document management system, and/or to upload a document into the product document management system for use by the knowledge management system.

Thus, an apparatus for computer-aided design modeling may include means for storing and managing knowledge management documents in a product document management system and means for generating instructions to a computer-aided design system based on the knowledge management documents. The apparatus may also include means for generating part numbers for computer-aided design system parts based on part number documents stored in the product document management system.

### BRIEF DESCRIPTION OF THE DRAWINGS

In the accompanying drawings:

FIG. 1 is a block diagram showing an exemplary modeling system in accordance with an embodiment of the present invention;

FIG. 2 is a block diagram showing the relevant components of the knowledge management system in accordance with an embodiment of the present invention;

FIG. 3A is a block diagram showing relevant components of the CAD system in accordance with an embodiment of the present invention;

FIG. 3B is a block diagram showing the relevant components of a CAD program in accordance with an embodiment of the present invention;

FIG. 4 is a block diagram showing an exemplary computer-aided modeling system in accordance with an embodiment of the present invention;

FIG. 5 shows an exemplary user interface screenshot for importing information from the CAD system relating to a mounting assembly, such as might be generated by the knowledge management application in accordance with an embodiment of the present invention;

FIG. 6 shows an exemplary user interface screenshot for defining a new geometric specification relating to the Mounting part family, such as might be generated by the knowledge management application in accordance with an embodiment of the present invention;

FIG. 7 shows an exemplary user interface screenshot displaying information upon entry of the name of a new CAD part file, such as might be generated by the knowledge management application in accordance with an embodiment of the present invention;

FIG. 8 shows an exemplary user interface screenshot for defining a geometry feature, such as might be generated by the knowledge management application in accordance with an embodiment of the present invention;

FIG. 9 shows an exemplary user interface screenshot showing geometry features (properties) defined for the CAD part file, such as might be generated by the knowledge management application in accordance with an embodiment of the present invention;

FIG. 10 shows an exemplary user interface screenshot for defining a mating, such as might be generated by the knowledge management application in accordance with an embodiment of the present invention;

FIG. 11 shows an exemplary user interface screenshot showing mating definitions, such as might be generated by the knowledge management application in accordance with an embodiment of the present invention;

FIG. 12 shows an exemplary user interface screenshot showing a rule for determining a fan area for the fan, such as might be generated by the knowledge management application in accordance with an embodiment of the present invention;

FIG. 13 shows an exemplary user interface screenshot including an embedded graphical representation of a model generated by the CAD system, such as might be generated by the knowledge management application in accordance with an embodiment of the present invention;

FIG. 14 shows a first exemplary user interface screenshot including a sub-window generated by the CAD system, such as might be generated by the knowledge management application in accordance with an embodiment of the present invention;

FIG. 15 shows a second exemplary user interface screenshot including a sub-window generated by the CAD system, such as might be generated by the knowledge management application in accordance with an embodiment of the present invention;

FIG. 16 shows a third exemplary user interface screenshot including a full view window generated by the CAD system, such as might be generated by the knowledge management application in accordance with an embodiment of the present invention;

FIG. 17 shows an exemplary user interface screenshot including a window generated by a two-dimensional CAD system, such as might be generated by the knowledge management application in accordance with an embodiment of the present invention;

FIG. 18 shows an exemplary user interface screenshot including an analysis window, such as might be generated by the knowledge management application in accordance with an embodiment of the present invention;

FIG. 19 shows the relationship between the user (engineer), knowledge management application, knowledge database, and the integrated systems controlled by the knowledge management application in accordance with an embodiment of the present invention; and

FIG. 20 shows the relationship between the knowledge management application and the integrated systems in greater detail;

FIG. 21 is a logic flow diagram showing exemplary logic for class-based rules in accordance with an embodiment of the present invention;

FIG. 22 is a logic flow diagram showing exemplary logic for the knowledge management application in accordance with an embodiment of the present invention;

FIG. 23 shows an exemplary computer-aided modeling system with integrated product document management support in accordance with an embodiment of the present invention;

FIG. 24 shows an exemplary document object hierarchy in accordance with an embodiment of the present invention;

FIG. 25 is a screenshot of an exemplary user interface screen for defining classes for Rulestream integration with SmarTeam in accordance with an embodiment of the present invention;

FIG. 26 is a screenshot of an exemplary user interface screen for defining class attributes and indexes for Rulestream integration with SmarTeam in accordance with an embodiment of the present invention;

FIG. 27 is a screenshot of an exemplary user interface screen for defining class composition and hierarchical link attributes for Rulestream integration with SmarTeam in accordance with an embodiment of the present invention;

FIG. 28 is a screenshot of an exemplary user interface screen for designing a profile card form for Rulestream integration with SmarTeam in accordance with an embodiment of the present invention;

FIG. 29 is a screenshot of an exemplary user interface screen for creating default sequences for Rulestream integration with SmarTeam in accordance with an embodiment of the present invention;

FIG. 30 is a screenshot of an exemplary user interface screen for allowing a user to add a new sequence in accordance with an embodiment of the present invention;

FIG. 31 is a screenshot of an exemplary user interface screen for adding information relating to a new sequence in accordance with an embodiment of the present invention;

FIG. 32 is a screenshot of an exemplary user interface screen displayed to the user upon logging into SmarTeam Form Designer Application in accordance with an embodiment of the present invention;

FIG. 33 is a screenshot of an exemplary user interface screen for selecting a field to be tied to a newly created sequence in accordance with an embodiment of the present invention;

FIG. 34 is a screenshot of an exemplary user interface screen for selecting properties for the newly created sequence in accordance with an embodiment of the present invention;

FIG. 35 is a screenshot of an exemplary user interface screen for selecting the property sequence to be tied to the field in accordance with an embodiment of the present invention;

FIG. 36 is a screenshot of an exemplary user interface screen showing attributes for SolidWorks assemblies in accordance with an embodiment of the present invention;

FIG. 37 is a screenshot of an exemplary user interface screen showing attributes for SolidWorks parts in accordance with an embodiment of the present invention;

FIG. 38 is a screenshot of an exemplary user interface screen showing attributes for SolidWorks drawings in accordance with an embodiment of the present invention;

FIG. 39 is a screenshot of an exemplary user interface screen showing attributes for a specific customer in accordance with an embodiment of the present invention;

FIG. 40 is a screenshot of an exemplary user interface screen showing a Rulestream menu in SolidWorks in accordance with an embodiment of the present invention;

FIG. 41 is a screenshot showing an exemplary PDM system login screen in accordance with an embodiment of the present invention;

FIG. 42 is a screenshot of an exemplary user interface search screen in accordance with an embodiment of the present invention;

FIG. 43 is a screenshot of an exemplary user interface screen showing document objects that match specified search criteria in accordance with an embodiment of the present invention;

FIG. 44 is a screenshot of an exemplary user interface screen for classifying an active document in accordance with an embodiment of the present invention;

FIG. 45 is a screenshot of an exemplary user interface screen showing attributes attached to a classification in accordance with an embodiment of the present invention;

FIG. 46 is a screenshot of an exemplary user interface screen for setting a default value for a researchable property in accordance with an embodiment of the present invention;

FIG. 47 is a screenshot of an exemplary user interface screen for uploading a document to a product document management system in accordance with an embodiment of the present invention;

FIG. 48 is a screenshot of an exemplary user interface error message screen in accordance with an embodiment of the present invention;

FIG. 49 is a block diagram showing the relationships between various documents in accordance with an embodiment of the present invention;

FIG. 50 is a logic flow diagram showing exemplary part numbering logic in accordance with an embodiment of the present invention; and

FIG. 51 is a logic flow diagram showing exemplary check-in logic in accordance with an embodiment of the present invention.

### DETAILED DESCRIPTION OF A PREFERRED EMBODIMENT

In embodiments of the present invention, a knowledge management system captures, stores, manages, and applies rules for modeling geometric objects and related non-geometric attributes, and includes integrated support for one or more third party product document management (PDM) systems for storing and managing knowledge management system documents. An exemplary knowledge management system is described below and in related U.S. patent application Ser. No. 10/675,809 entitled KNOWLEDGE MANAGEMENT SYSTEM FOR COMPUTER-AIDED DESIGN MODELING, which was filed on Sep. 30, 2003 in the names of David W. Vredenburgh, Gregory J. Smith, and Robert J. Mattern, and is hereby incorporated herein by reference in its entirety. The knowledge management system may be referred to as “Rulestream” or “Navion.”

The knowledge management system preferably supports rules relating to geometric attributes that can be represented and manipulated by a CAD system as well as rules relating to various other attributes that generally cannot be represented and manipulated by the CAD system, such as certain “negative” geometric attributes (e.g., a specification for producing a hole in a component or for removing material from a component so as to form a feature of that component), certain geometry-based attributes that are not modeled as physical features of a structure or assembly, and non-geometric attributes (e.g., pricing, processes, component relationships, component classes, user intentions, and abstractions). The rules are typically stored in a central database so that the rules can be manipulated independently of any modeling. The rules can be derived from various sources, including general engineering principles, user-provided information, and information obtained from a PDM system. The knowledge management system can tracks rule changes over time, and can apply a particular version of the rules to a model. The knowledge management system defines the components and parameters for a particular model based on the rules being applied. The knowledge management system can incorporate predefined components (such as components created in a CAD system) or dynamically defined components into the model.

The knowledge management system is generally independent of the CAD system, although the knowledge management system can interface with a CAD system for, among other things, importing/integrating component specifications from the CAD system for use in modeling, instructing the CAD system to produce a geometric model incorporating the components and parameters defined by the knowledge management system, and obtaining geometric information relating to a model (e.g., sizes, surface areas, volumes) for use by the knowledge management system (e.g., for computing the cost of a component based on its volume according to pricing rules provided by a user). A geometric model produced by the CAD system can be viewed and manipulated as usual using the CAD system, although it is preferable for any and all changes to the model to be coordinated through the knowledge management system so that the appropriate rules can be applied to the changes.

In certain embodiments of the present invention, the knowledge management system interfaces with the CAD system through an application program interface (API) of the CAD system. Specifically, the CAD system includes an API through which certain functions of the CAD system can be performed. The CAD system API is typically used for such things as macros (i.e., programs that perform a series of function steps for the user) and add-ons (i.e., programs that add functionality to the CAD system). In embodiments of the present invention, however, the knowledge management system uses the API to control the CAD system such that the CAD system runs only when activated by the knowledge management system. The knowledge management system typically activates the CAD system for such things as displaying a model to the user and obtaining geometric information relating to model components.

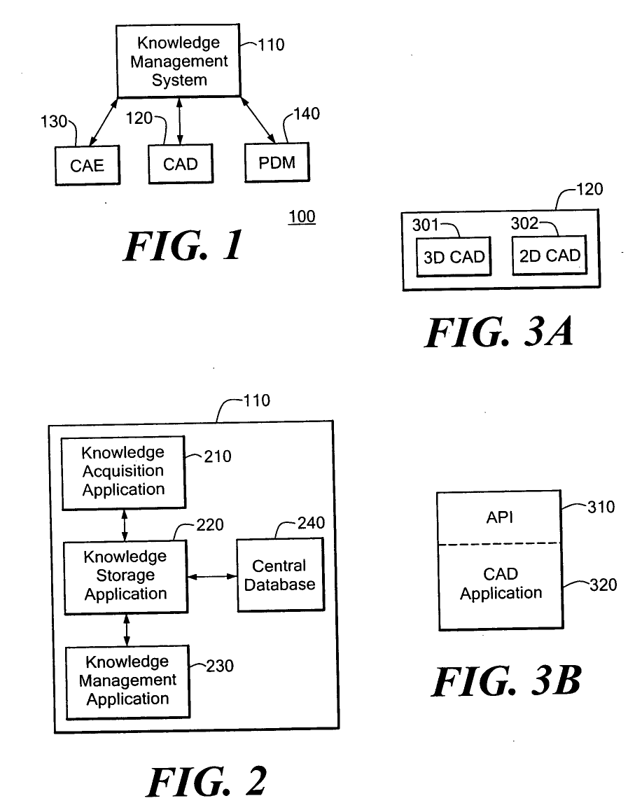

FIG. 1 is a block diagram showing an exemplary modeling system 100 in accordance with an embodiment of the present invention. Among other things, the modeling system 100 includes a knowledge management system 110 in communication with a CAD system 120. The knowledge management system 110 controls the CAD system 120, specifically by generating instructions for modeling a geometric structure based on a set of modeling rules and communicating the instructions to the computer-aided design system 120 for generating a model of the geometric structure. The knowledge management system 110 can also interface with a CAE application 130 for analysis and with a PDM application 140 for product document management.

FIG. 2 is a block diagram showing the relevant components of the knowledge management system 110 in accordance with an embodiment of the present invention. Among other things, the knowledge management system 110 includes a knowledge acquisition application 210 for capturing and generating rules, a knowledge storage application 220 for storing rules and models in a central database 240, and a knowledge management application 230 for generating models based on the rules. The knowledge management application may be referred to as “nact” or “nAct Engineer,” the knowledge acquisition application may be referred to as “nAct Expert,” and the knowledge storage application may be referred to as “nPlatform.” Among other things, the knowledge acquisition application 210 generates rule programs based on information obtained from a user and communicates the rule programs to the knowledge storage application 220 for storage in the central database 240. The knowledge management application 230 obtains rule programs from the knowledge storage application 220 and applies the rule programs for building a model. The knowledge management application 230 may communicate model information to the knowledge storage application 220 for storage in the central database 240.

More specifically, the knowledge acquisition application 210 captures modeling rules and generates rule programs for storage by the knowledge storage application 220. The knowledge acquisition application 210 interacts with a user through a user interface through which the user enters information regarding components, design processes, engineering and manufacturing rules, and customer and marketing requirements. The knowledge acquisition application 210 generates rule programs from the user information, and sends the rule programs to the knowledge storage application 220 for storage. The knowledge acquisition application 210 allows rules to be modified quickly and easily.

The knowledge storage application 220 stores modeling information in a relational database, including, among other things, rule programs generated by the knowledge acquisition application 210 and models generated by the knowledge management application 230. The knowledge storage application 220 also tracks revision histories, design status, and user group security. Multiple revisions of a rule can be stored so that a particular version of a rule can be applied to a model while another version of the rule is being created or modified. A design can be modeled using an earlier version of a rule if desired.

The knowledge management application 230 applies rules to create detailed computer models. The knowledge management application 230 can model two-dimensional schematics or three-dimensional geometries. The knowledge management application 230 can also model a bill of materials for the components of an assembly. The knowledge management application 230 can automatically update a previously completed model under revised or new rules. In this way, models can be generated by manipulating the rules through the knowledge management system rather than manipulating the model itself through the computer-aided design system.

FIG. 3A is a block diagram showing relevant components of the CAD system 120 in accordance with an embodiment of the present invention. Among other things, the CAD system 120 includes a 3D CAD program 301, such as such as SOLIDWORKS(™) from SolidWorks Corporation, 300 Baker Avenue, Concord, Mass. 01742, and may also include a 2D CAD program 302, such as VISIO(™) from Microsoft Corporation. Each of the CAD programs has its own API through which it interacts with the knowledge management application. FIG. 3B is a block diagram showing the relevant components of a CAD program, such as the 3D CAD program 301 or the 2D CAD program 302, in accordance with an embodiment of the present invention. Among other things, the CAD program includes a CAD application 320 having an API 310 through which certain functions of the CAD application 320 can be controlled. The interactions between the knowledge management application and different CAD systems depend to a large degree on the CAD system API. The SOLIDWORKS(™) three-dimensional CAD program has an internal macro/recording language and also supports an application programming interface language that is accessible through an OLE (Object Linking and Embedding) interface with support for VISUAL BASIC(™) and VISUAL C++(™). In an exemplary embodiment of the present invention, the knowledge management application is substantially reactive to the VISIO(™) two-dimensional CAD system, while the knowledge management application actively controls the SOLIDWORKS(™) three-dimensional CAD system. Thus, support for each particular CAD system generally requires some level of integration by the knowledge management application to work with the specific functions and API of the CAD program.

In certain embodiments of the present invention, the various functions of the knowledge management system 110 are divided among different devices that communicate over a communication network, such as the public Internet or public or private intranets. In an exemplary embodiment of the present invention, knowledge storage functions reside in one or more storage servers that incorporate the knowledge storage application 220 and central database 240, while knowledge acquisition and management functions reside in user workstations (such as personal computers) or terminals that incorporate the knowledge acquisition application 210, the knowledge management application 230, and the CAD system 120. The user workstations or terminals typically include a user interface for interacting with a user and a network interface for communicating with the storage server over a communication network.

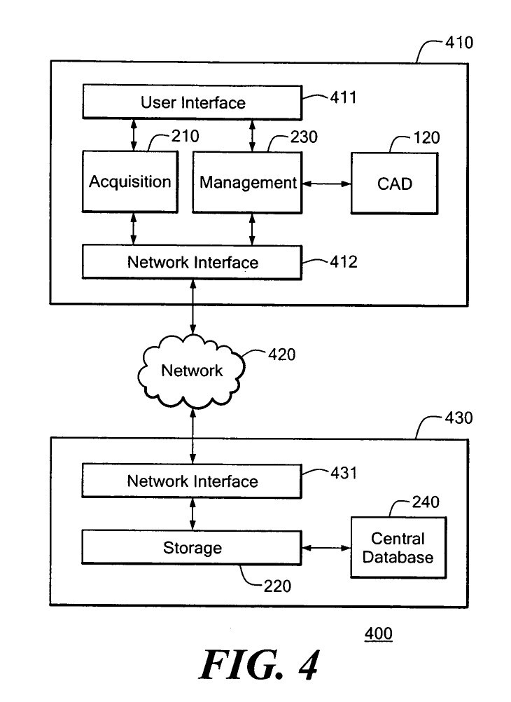

FIG. 4 is a block diagram showing an exemplary computer-aided modeling system in accordance with an embodiment of the present invention. Among other things, the system 400 includes one or more user workstations 410 in communication with one or more storage servers 430 over a communication network 420. The workstation 410 incorporates the knowledge acquisition application 210, the knowledge management application 230, and the CAD system 120, and also includes a user interface for interacting with the user and a network interface for communicating over the communication network 420 with the storage server(s) 430. The user interface 411 is typically a graphical user interface that provides for both displaying information to the user and receiving inputs from the user. The storage server 430 incorporates the knowledge storage application 220 and the central database 240, and also includes a network interface 431 for communicating over the communication network 420 with the user workstation(s) 410.

Within the user workstation 410, the knowledge acquisition application 210 and the knowledge management application 230 interact with the user through the user interface 411, and also interact with the knowledge storage application 220 in the storage server 430 through the network interface 412 using a client-server paradigm. The knowledge management application 230 also controls the CAD system 120 through an API of the CAD system 120. The user workstation 410 is typically a general-purpose computer, and the knowledge acquisition application 210, the knowledge management application 230, and the CAD system 120 are typically software programs that run on the general-purpose computer.

Within the storage server 430, the knowledge storage application 220 interacts with the central database 240 through a database interface (not shown), and interacts with the knowledge acquisition application 210 and the knowledge management application 230 in the user workstation 410 through the network interface 431. The storage server 430 is typically a general-purpose computer, and the knowledge storage application 220 is typically a software program that runs on the general-purpose computer. The central database 240 is typically a relational database.

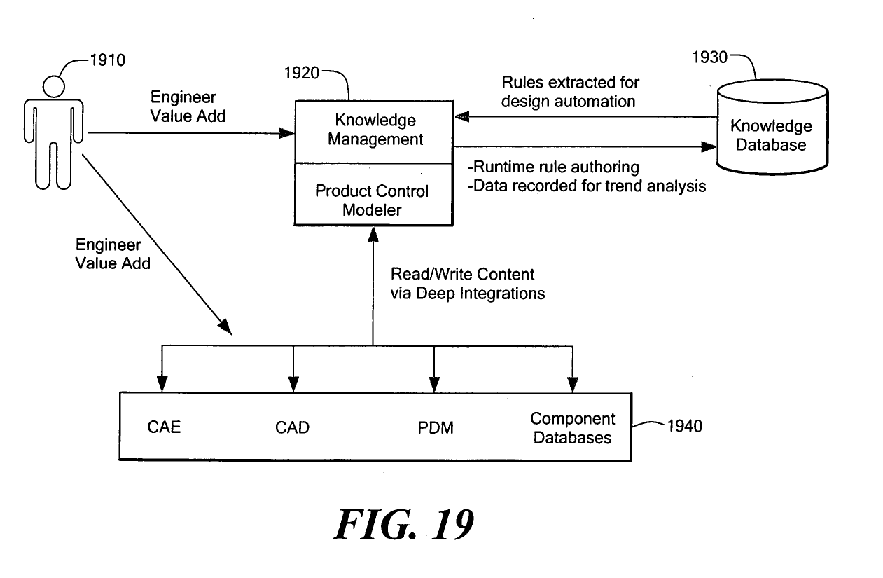

FIG. 19 shows the relationship between the user (engineer) 1910, knowledge management application 1920, knowledge database 1930, and the integrated systems 1940 controlled by the knowledge management application 1920, including CAD system(s) and possibly also a CAE application, a PDM application, and a component databases. The knowledge management application 1920 extracts rules for design automation from the knowledge database 1930. The knowledge management application 1920 may also receive specifications, rules, and other information relating to modeling. A product control modeler element of the knowledge management application 1920 interacts with the integrated applications as necessary for modeling, analysis, product document management, and component selection. Information generated by the knowledge management application 1920, such as runtime rule authoring and trend analysis, may be stored in the knowledge database 1930.

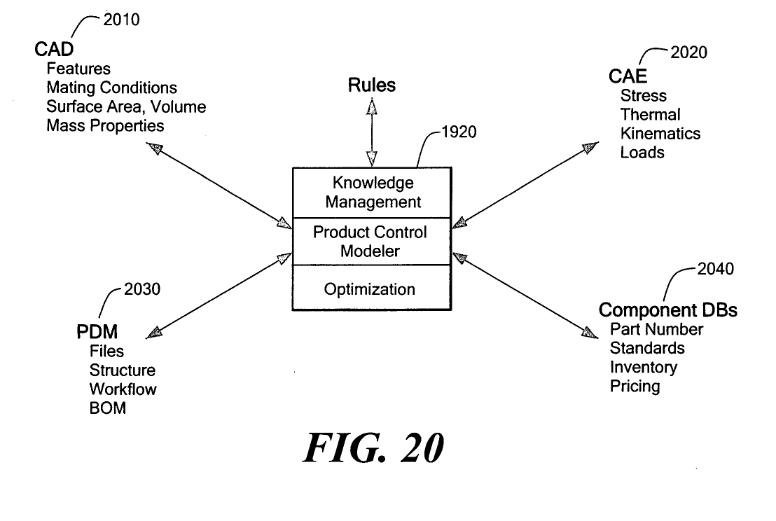

FIG. 20 shows the relationship between the knowledge management application and the integrated systems in greater detail. The knowledge management application 1920 interacts with the CAD system 2010 for modeling such things as features, mating conditions, surface area, volume, and mass properties. The knowledge management application 1920 interacts with the CAE analysis application 2020 for such things as stress, thermal, kinematics, and loads analysis. The knowledge management application 1920 interacts with the PDM application 2030 to generate and utilize such things as files, structure, workflow, and bill of materials (BOM). The knowledge management application 1920 interacts with component databases 2040 for such things as part numbers, standards, inventory, and pricing.

In typical embodiments of the present invention, a model may include multiple geometric components. Each component can be associated with both geometric attributes and non-geometric attributes. Rules can be established for defining relationships between components without necessarily defining that actual parameters of the relationship (such as, for example, a rule that a fan blade assembly must mate with a motor shaft, without necessarily defining the shape or size of the shaft which might affect the type of mating). Components can be organized into classes (such as, for example, three possible motors for a fan assembly can be organized into a “motors” class), and rules can be established for the class as a whole such that the rules are applied to whatever class member is selected for inclusion in a particular model (such as, for example, a generic rule that any of the class of motors must mate with a fan blade component). Rules can be established for selecting a particular member of a class for a particular model (such as, for example, a rule for selecting a particular motor based on the amount of power or the rotational speed required for a model, or a rule for selecting the number of fan blades for the fan blade component based on the volume of air to be moved and other parameters such as the motor selected and the diameter of the fan blade component). Rules relating to “negative” attributes can be defined (such as, for example, a rule that a motor frame must include a hole in a particular location for bolting the motor frame to a chassis) and applied to a model component as a library feature. Rules relating to various non-geometric attributes can be established (such as, for example, rules for deriving manufacturing processes based on the components incorporated into a selected model, or rules for estimating component, sub-assembly, product, and manufacturing costs).

As discussed above, the knowledge management application controls the CAD system through a CAD system API. While the actual CAD functions that can be performed through the API are substantially limited by the API (and are subject to change by the CAD system provider), the specific API functions used and the manner in which the API functions are used are determined by the knowledge management application for performing specific knowledge management operations. In an exemplary embodiment of the present invention, the knowledge management application controls the SOLIDWORKS(™) three-dimensional CAD system through its API. In order to control the CAD system, the knowledge management application typically performs such operations as starting SOLIDWORKS(™), opening a part file, opening an assembly file, mating a component, deleting a mate, fixing a component, removing a part or assembly, suppressing a component, hiding/showing a component, suppressing a feature, inserting a library feature, removing a library feature, setting a part dimension, setting an assembly dimension, creating a component pattern, removing a component pattern, creating a feature pattern, removing a point in a sketch, removing a feature pattern, setting a custom property, setting component color, and closing SOLIDWORKS(™). This is not meant as an exhaustive list, and the knowledge management application can perform other operations as needed. Exemplary API calls and settings for performing the above operations in an exemplary embodiment of the invention are described below.

Starting SOLIDWORKS(™) may involve use of the following API functions:
Set SW=New SldWorks.SldWorks
SW.UserControl=False
Set Assembly=SW.OpenDoc6(strFilename, swDocPART, swOpenDocOptions_Silent, “ ”, lngErr, lngMess)

The following SOLIDWORKS(™) settings may be used:
swMateAnimationSpeed=0
swLargeAsmModeAutoActivate=swResponseNever
swPerformanceAssemRebuildOnLoad=swResponseAlways
swLoadExternalReferences=swResponseNever
swAutoSaveInterval=0
swBackupCopiesPerDocument=0
swShowErrorsEveryRebuild=False
swMaximizeDocumentOnOpen=True
swSnapToPoints=False
swLargeAsmModeAutoLoadLightweight=False
swLargeAsmModeUpdateMassPropsOnSave=False
swLargeAsmModeAutoRecover=False
swAutoLoadPartsLightweight=False
swPerformanceVerifyOnRebuild=False
swEnablePerformanceEmail=False
swUseFolderSearchRules=False
swExtRefUpdateCompNames=True
swFeatureManagerEnsureVisible=False

Opening a part file typically involves opening the part file, adding the part file as a component to a parent assembly, closing the part file, and rebuilding the top level assembly. The following API functions may be used:
Set objDoc=SW.OpenDoc6(strFilename, swDocPART, swOpenDocOptions_Silent, “ ”, lngErr, lngMess)
Assembly.AddComponent2(strFilename, 0, 0, 0)
SW.CloseDoc objDoc.GetTitle
Assembly.EditRebuild3

Opening an assembly file typically involves opening the part file, adding the part file as a component to a parent assembly, closing the part file, and rebuilding the top level assembly. If assembly dimensions are driven by the knowledge management application, then all components are typically renamed to ensure uniqueness. The following API functions may be used:
Set objDoc=SW.OpenDoc6(strFilename, swDocPART, swOpenDocOptions_Silent, “ ”, lngErr, lngMess)
Set objConfiguration=objDoc.GetActiveConfiguration( )
Set objComponent=obj Configuration.GetRootComponent( )
obj Component.GetChildren
Set objChildDoc=objChild.GetModelDoc
objChildDoc.SaveAs4 strNewFileName swSaveAsCurrentVersion, swSaveAsOptions_Silent, lngErr, lngWarnings
SWAssembly.AddComponent2(strFilename, 0, 0, 0)
SW.CloseDoc objDoc.GetTitle
SWAssembly.EditRebuild3

Mating a component typically involves putting the parent assembly in “edit” mode, selecting the features to mate, adding the mate, and rebuilding the assembly. The mate name is then found and noted by the knowledge management application in the case where a dependent property is changed and the mating is effected. The following API functions may be used:
ObjParentComponent.Select False
Assembly.EditAssembly

Selecting Plane, Axis, or Point
Assembly.SelectByID strFeatureName, strFeatureType, 0, 0, 0 (also used, strFeatureName & “@” & strComponentPath, and “Point1@” & strFeatureName)

Selecting Face or Edge (loop through Faces, or Faces and Edges to find name match)
objComponent.GetBody( ), objBody.GetFirstFace( ), objBody.GetNextFace( ), objFace.GetEdges, Assembly.GetEntityName(obj)
Assembly.AddMate lngMateType, lngAlignType, boolFlip, dbIDist, dblAngle
Assembly.EditRebuild3

Finding the Mate created (find the MateGroup, move to the last SubFeature)
Assembly.FeatureByPositionReverse(i)
objFeature.GetTypeName=“MateGroup”
objMateGroup.GetFirstSubFeature
objMate.GetNextSubFeature( )

Deleting a mate typically involves selecting the mate using the parent assembly's model document and deleting the selection. The following API functions may be used:
Assembly.SelectByID strMateName, “MATE”, 0, 0, 0
Assembly.DeleteSelection False
Assembly.EditRebuild3

Fixing a component typically involves setting the component transform, selecting the component, and fixing the component. The following API functions may be used:
objComponent.GetXform
objComponent.SetXform (varXForm)
objComponent.Select False
Assembly.FixComponent
Assembly.EditRebuild3

Removing a part or assembly typically involves selecting the parent assembly, putting the parent assembly in “edit” mode, selecting the component, and deleting the selection. The following API functions may be used:
objParentComp.Select False
Assembly.EditAssembly
objComponent.Select False
Assembly.DeleteSelection False
Assembly.ClearSelection
Assembly.EditAssembly
Assembly.EditRebuild3

Suppressing a component typically involves checking the suppression state of the component and setting the suppression state, if suppressing the document is saved. The following API functions may be used:
objComponent.IsSuppressed
Set oModelDoc=objComponent.GetModelDoc
oModelDoc.Save3 swSaveAsOptions_Silent, lngErr, lngWarnings
objComponent.Select False
Assembly.EditSuppress2 or Assembly.EditUnSuppress2
Assembly.EditRebuild3

Hiding or showing a component typically involves setting the hidden state appropriately. The following API functions may be used:
objComponent.IsHidden(False)
objComponent.Select False
Assembly.ShowComponent2, Assembly.HideComponent2
Assembly.EditRebuild3

Suppressing a feature typically involves traversing the model documents to find the named feature and setting its suppression state accordingly. The following API functions may be used:
objModelDoc.FirstFeature
objFeature.Name( )
objFeature.GetNextFeature( )
objFeature.IsSuppressed
objFeature.SetSuppression 0
objFeature.SetSuppression 2

Inserting a library feature typically involves selecting the component to receive the feature, putting the component in “edit” mode, selecting the references required for insertion, and inserting the library feature. The new feature and its sub-features are typically renamed. The following API functions may be used:
objParentComponent.Select2 False, 0
Assembly.EditPart2 True, True, lngErr
obj.Select2 True, intMark (Traversefeatures and select for Edges and Faces)
Assembly.AndSelectByMark(strFeatureName & “@” & strComponentPath, strFeatureType, 0, 0, 0, intMark) (Plane, Point, or Axis)
Assembly.InsertLibraryFeature(strFileName)
Assembly.SelectedFeatureProperties 0, 0, 0, 0, 0, 0, 0, 1, 0, strNewName)
objFeature.GetFirstSubFeature, subFeature.Name( ), subFeature.GetNextFeature( )
Assembly.EditAssembly
Assembly.EditRebuild3

Removing a library feature typically involves selecting component owning the feature, putting the component in “edit” mode, selecting the feature, and deleting the feature using the context of the top level assembly. The following API functions may be used:
objComponent.Select2 False, 0
Assembly.EditPart2 True, True, lngErr
Assembly.ClearSelection
Assembly.SelectByID strFeatureName & “@” & objComponentPath, “BODYFEATURE”, 0, 0, 0
Assembly.DeleteSelection False
Assembly.EditAssembly
Assembly.EditRebuild3

Setting a part dimension typically involves setting the read-only status of the dimension to false, setting the system value for the dimension, and resetting the read-only status of the dimension to true (this is because all dimensions controlled by the knowledge management application are preferably maintained as read-only to prevent modification through the CAD system). A dimension is typically references by a string (e.g. D1@Sketch1). The following API functions may be used:
objDoc.Parameter(strDimension).ReadOnly=False
objDoc.Parameter(strDimension).SystemValue=varValue
objDoc.Parameter(strDimension).ReadOnly=True

Setting an assembly dimension typically involves all of the steps for setting an assembly dimension, except Parameter is additionally checked for existence on the components. The following API functions may be used:
objDoc.Parameter(strDimension & “@” & strComponent).ReadOnly=False
objDoc.Parameter(strDimension & “@” & strComponent).SystemValue=varValue
objDoc.Parameter(strDimension & “@” & strComponent).ReadOnly=True
   —OR—
objDoc.Parameter(strDimension & “@” & strComponent & “.Part”).ReadOnly=False
objDoc.Parameter(strDimension & “@” & strComponent & “.Part”).SystemValue=varValue
objDoc.Parameter(strDimension & “@” & strComponent & “.Part”).ReadOnly=True
   —OR—
objDoc.Parameter(strDimension & “@” & strComponent & “.Assembly”).ReadOnly=False
objDoc.Parameter(strDimension & “@” & strComponent & “.Assembly”).SystemValue=varValue
objDoc.Parameter(strDimension & “@” & strComponent & “.Assembly”).ReadOnly=True

Creating a component pattern typically involves selecting the parent assembly, putting the parent assembly in “edit” mode, selecting the component and the feature pattern, and inserting the feature pattern. The Derived Pattern is typically renamed by traversing the parent assembly and finding the Derived Pattern using the seed component. The following API functions may be used:
objComponent.Select False
Assembly.EditAssembly
Assembly.ClearSelection
Assembly.SelectByID strComponentPath, “COMPONENT”, 0, 0, 0
Assembly.AndSelectByID strPatternName & “@” & strComponentPath2, “BODYFEATURE”, 0, 0, 0
Assembly.InsertDerivedPattern
Set objFeature=objDoc.FirstFeature
objFeature.GetTypeName=“DerivedSketchPattern”
arrSeed=def.SeedComponentArray( )
arrSeed(i).Name
def.ReleaseSelectionAccess
Set objFeature=objFeature.GetNextFeature

Removing a component pattern typically involves selecting the Derived Pattern from the parent model document and deleting the selection. In some models, the referenced configuration may need to be reset to prevent future selections from failing on this part. The following API functions may be used:
oParentDoc.ClearSelection
oParentDoc.SelectByID strPatternName, “COMPPATTERN”, 0, 0, 0
oParentDoc.DeleteSelection False
oParentComponent.ReferencedConfiguration=“ ”
Assembly.EditRebuild3

The knowledge management application typically requires a part for each feature in the pattern, and maintains a property containing the X and Y coordinates for each feature. In order to create a feature pattern, the is activated and is used to select the Sketch Pattern. A point for each component required is created, it's identifier is stored, the Sketch is inserted, and the document rebuilt. The Sketch and Feature are selected and a Pattern is created. The Sketch Pattern is then found and renamed by traversing the Document and finding the Pattern using the seed feature. The following API functions may be used:
SW.ActivateDoc2 objDoc.GetTitle, True, lngErr
objDoc.ClearSelection
objDoc.SelectByID strSketchName, “SKETCH”, 0, 0, 0
objDoc.SetAddToDB True
objDoc.EditSketch
Set oPoint=objDoc.CreatePoint2(lngX, lngY, 0)
arrPointID=oPoint.GetId( )
objDoc.InsertSketch
objDoc.EditRebuild3
objDoc.SelectByID strSketch, “SKETCH”, 0, 0, 0
objDoc.AndSelectByID strFeature, “BODYFEATURE”, 0, 0, 0
objDoc.ActivateSelectedFeature
objDoc.FeatureSketchDrivenPattern 1
Set objFeature=objDoc.FirstFeature
objFeature.GetTypeName=“SketchPattern”
arrSeed=def.PatternFeatureArray( )
Set subFeature=arrSeed(i)
objModelDoc.GetEntityName(subFeature)=strSeedName
defReleaseSelectionAccess
Set objFeature=objFeature.GetNextFeature
SW.ActivateDoc2 Assembly.GetTitle, True, lngErr
SW.CloseDoc objDoc.GetTitle

Removing a point in a sketch typically involves opening the document containing the sketch, putting the sketch in “edit” mode, traversing the sketch points to find the point with the corresponding identifier, selecting the point, and deleting the selected point. The following API functions may be used:
SW.ActivateDoc2 objDoc.GetTitle, True, lngErr
objDoc.ClearSelection
objDoc.SelectByID strSketchName, “SKETCH”, 0, 0, 0
objDoc.EditSketch
Set oSketch=objModelDoc.GetActiveSketch2( )
arrPoints=oSketch .GetSketchPoints
arrID=arrPoints(i).GetId
arrPoints(i).Select2 False, 0
objDoc.DeleteSelection False
objDoc.InsertSketch
objDoc.EditRebuild3
SW.ActivateDoc2 Assembly.GetTitle, True, lngErr
SW.CloseDoc objDoc.GetTitle

Removing a feature pattern typically involves selecting the derived pattern from the parent model document and deleting the selected derived pattern. The following API functions may be used:
oParentDoc.ClearSelection
oParentDoc.SelectByID strPatternName, “BODYFEATURE”, 0, 0, 0
oParentDoc.DeleteSelection False
Assembly.EditRebuild3

Setting a custom property typically involves verifying the value and setting the value if necessary. The following API functions may be used:
objDoc.GetCustomInfoValue(“ ”, strName)< >varArgument
objDoc.CustomInfo2(“ ”, strName)=varArgument
Assembly.EditRebuild3

Setting a component color typically involves retrieving the MaterialPropertyValues for the component from the component or the model document, changing the first three elements in the array to reflect the new color, and setting the new MaterialPropertyValues on the component. If the color is being removed, the RemoveMaterialProperty is called. The following API functions may be used:
arr=objComponent.MaterialPropertyValues( )
arr=objComponent.GetModelDoc.MaterialPropertyValues( )
objComponent.MaterialPropertyValues=arr
Assembly.EditRebuild3
objComponent.RemoveMaterialProperty

Closing SOLIDWORKS(™) typically involves closing the top level assembly (which is typically the only one open at this point) and calling the Exit App API function. The following API functions may be used:
SW.QuitDoc strTitle
SW.ExitApp

Various aspects of an exemplary embodiment of the present invention are described hereinafter with reference to modeling a fan. In accordance with an embodiment of the present invention, a fan includes various sub-parts, including a fan assembly, a housing assembly, a motor assembly, and a mounting assembly. Certain components of the fan might have fixed characteristics. For example, a company might purchase three different motors that can be used in a fan, and these motors have fixed dimensions that cannot be changed in the model. CAD models of the motors may be created in the CAD system and imported into the knowledge management application for storage by the knowledge storage application. Other components of the fan might have characteristics that can be determined dynamically during modeling. For example, the dimensions of a fan hub might depend on the motor selected for the model. Models of these components might be created in the CAD system and imported into the knowledge management application, or rules for defining these components might be established. For purposes of the following example, the CAD system is presumed to be the SOLIDWORKS(™) three-dimensional CAD system.

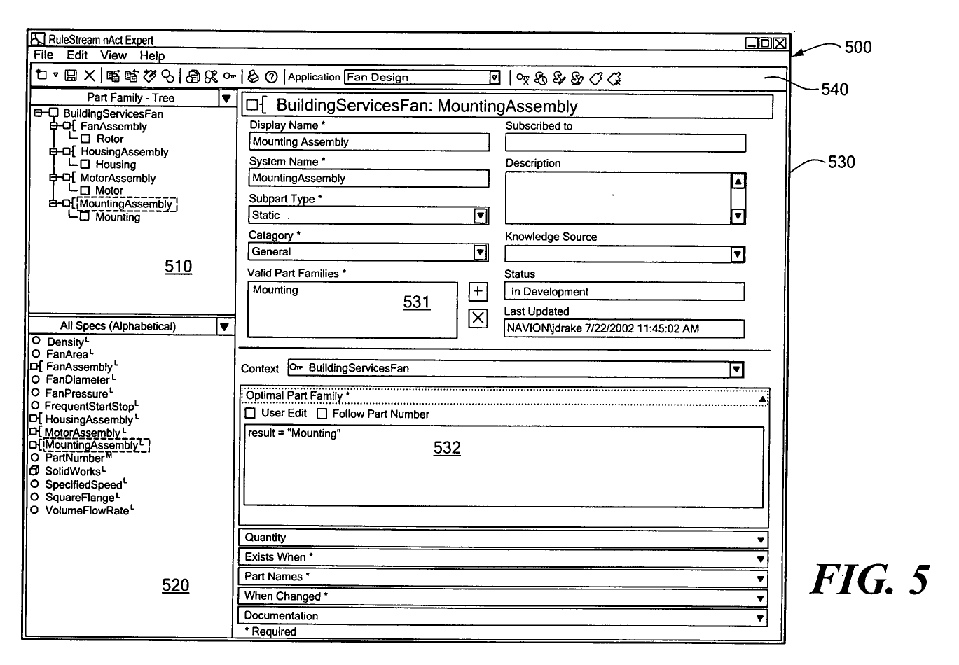

FIG. 5 shows an exemplary user interface screenshot 500 for importing information from the CAD system relating to a mounting assembly, such as might be generated by the knowledge management application in accordance with an embodiment of the present invention. The screenshot 500 displays, among other things, a hierarchical part family tree 510 showing that a BuildingServicesFan part family includes sub-parts entitled FanAssembly, HousingAssembly, MotorAssembly, and MountingAssembly, with the sub-parts having their own part families entitled Rotor, Housing, Motor, and Mounting, respectively. The screenshot 500 shows information relating to the MountingAssembly sub-part (as indicated by the MountingAssembly sub-part being highlighted in the part family tree 510), including a list of all specifications 520 relating to the MountingAssembly sub-part and a window 530 for entering information about the MountingAssembly sub-part. The screenshot 500 also includes a toolbar 540 from which various functions of the knowledge management application (such as creating a new part family, sub-part, property, connection, or CAD specification) can be accessed using either pull-down menus or icons. The window 530 includes a portion 531 showing that there is a single valid part family entitled Mounting associated with the MountingAssembly sub-part. It should be noted that there could be multiple part families associated with the MountingAssembly sub-part, and all valid part families would be displayed in the portion 531. The window 530 also includes a portion 532 for defining a rule to determine the optimal part family for a particular model (in this case, the optimal part family is the Mounting part family by default).

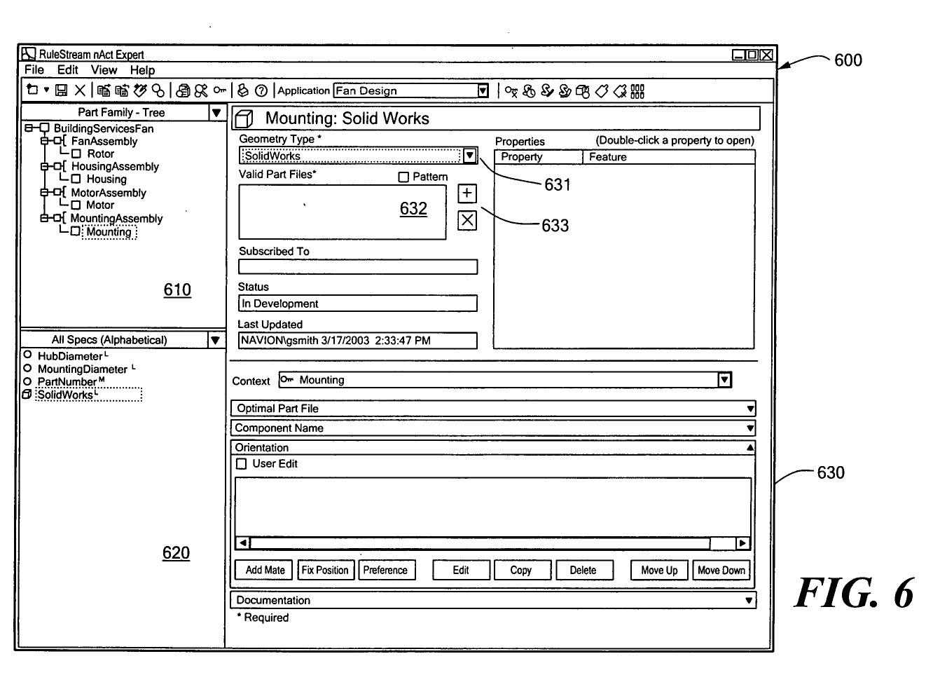

In order to associate a mounting component defined in the CAD system with the Mounting part family, the user might highlight “Mounting” in the part family tree 510 and then select a function from the toolbar 540 to create a new geometric specification (this function can be accessed from either the File menu or an icon on the toolbar). FIG. 6 shows an exemplary user interface screenshot 600 for defining a new geometric specification relating to the Mounting part family, such as might be generated by the knowledge management application in accordance with an embodiment of the present invention. The screenshot 600 shows information relating to the Mounting part family of the MountingAssembly sub-part (as indicated by the Mounting part family being highlighted in the part family tree 610), including a list of all specifications 620 relating to the Mounting part family and a window 630 for entering the new geometric specification for the Mounting part family. The window 630 shows the geometry type 631 (in this case, “SolidWorks”) and a list of valid CAD part files 632 associated with the Mounting part family (in this case, none have yet been specified).

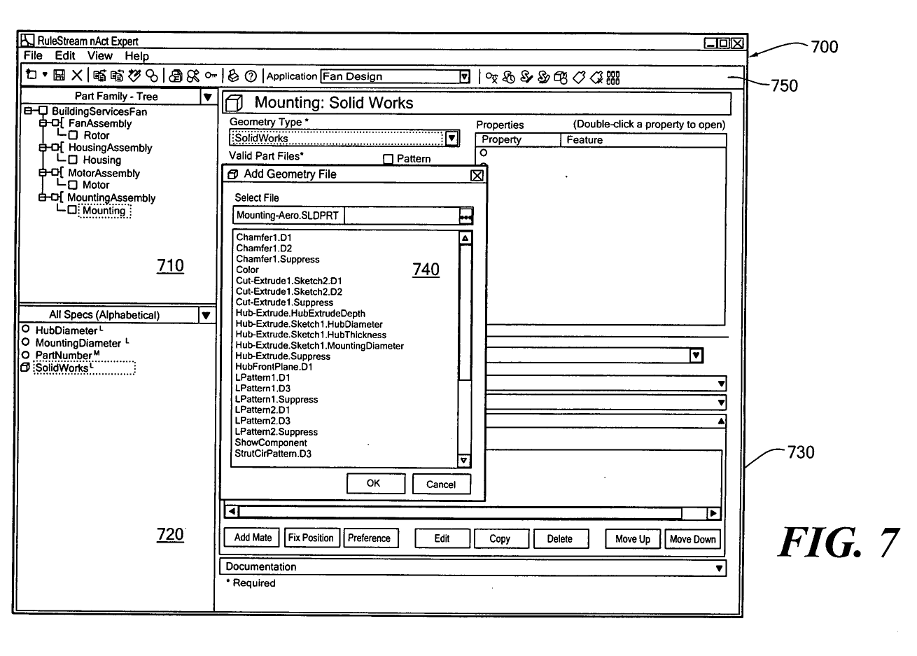

In order to associate a CAD part file with the Mounting part family, the user might select the “add part file” control 633 and enter the name of a CAD part file, in which case the knowledge management application imports from the CAD system information relating to the specified CAD part file. The knowledge management application preferably displays a list of parameters defined for the part in the CAD part file. FIG. 7 shows an exemplary user interface screenshot 700 displaying information upon entry of the name of a new CAD part file, such as might be generated by the knowledge management application in accordance with an embodiment of the present invention. The screenshot 700 shows the part family tree 710, a list of all specifications 720 relating to the Mounting part family, a window 730 showing the new valid part file (Mounting-Aero.SLDPR), and a window 740 displaying a list of parameters defined for the part in the CAD part file.

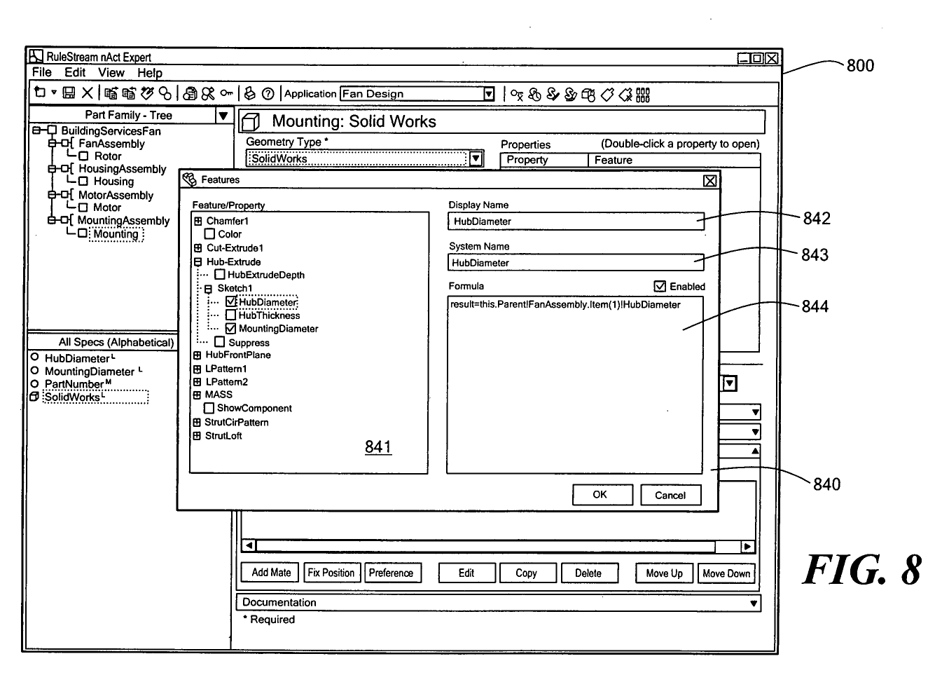

Once the CAD part file has been associated with the Mounting part family, the user typically defines various geometry features and associates the geometry features with specific CAD parts. In order to define a geometry feature and associate the geometry feature with one or more specific CAD parts, the user might select a function from the toolbar 750 to create a new geometry feature (this function can be accessed from either the File menu or an icon on the toolbar). FIG. 8 shows an exemplary user interface screenshot 800 for defining a geometry feature, such as might be generated by the knowledge management application in accordance with an embodiment of the present invention. The screenshot 800 includes a window 840 for defining a geometry feature and associating the geometry feature with one or more specific CAD parts. In this case, a geometry feature having a display name 842 HubDiameter and a system name HubDiameter 843 is associated with a corresponding CAD part entitled HubDiameter by specifying a formula in portion 844.

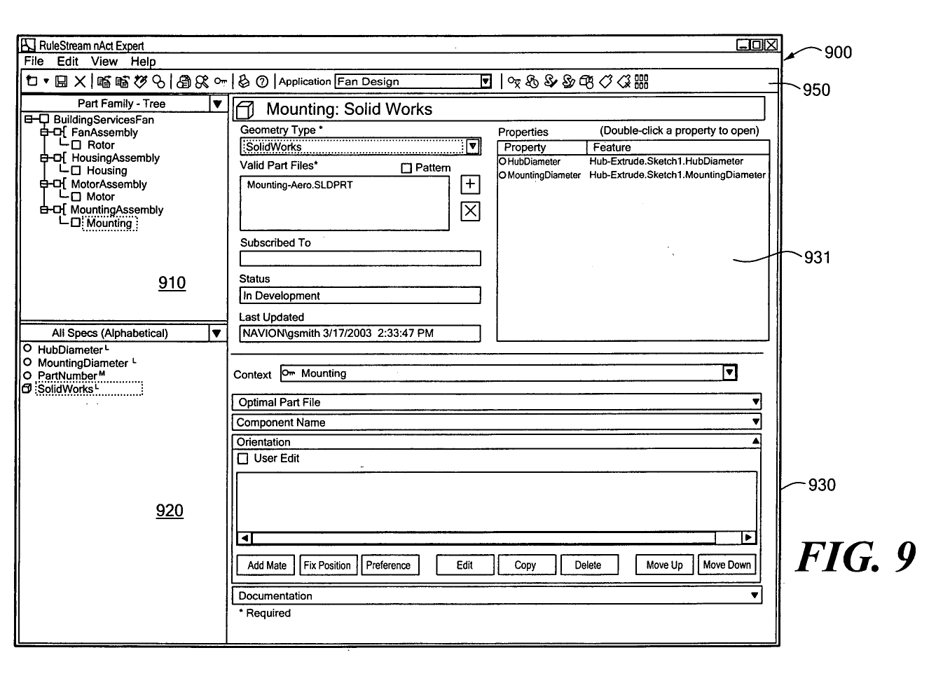

FIG. 9 shows an exemplary user interface screenshot 900 showing geometry features (properties) defined for the CAD part file, such as might be generated by the knowledge management application in accordance with an embodiment of the present invention. The screenshot 900 shows the part family tree 910, a list of all specifications 920 relating to the Mounting part family, and a window 930 including a properties portion 931 showing the geometry features associated with specific CAD parts (in this case, a HubDiameter geometry feature and a MountingDiameter geometry feature).

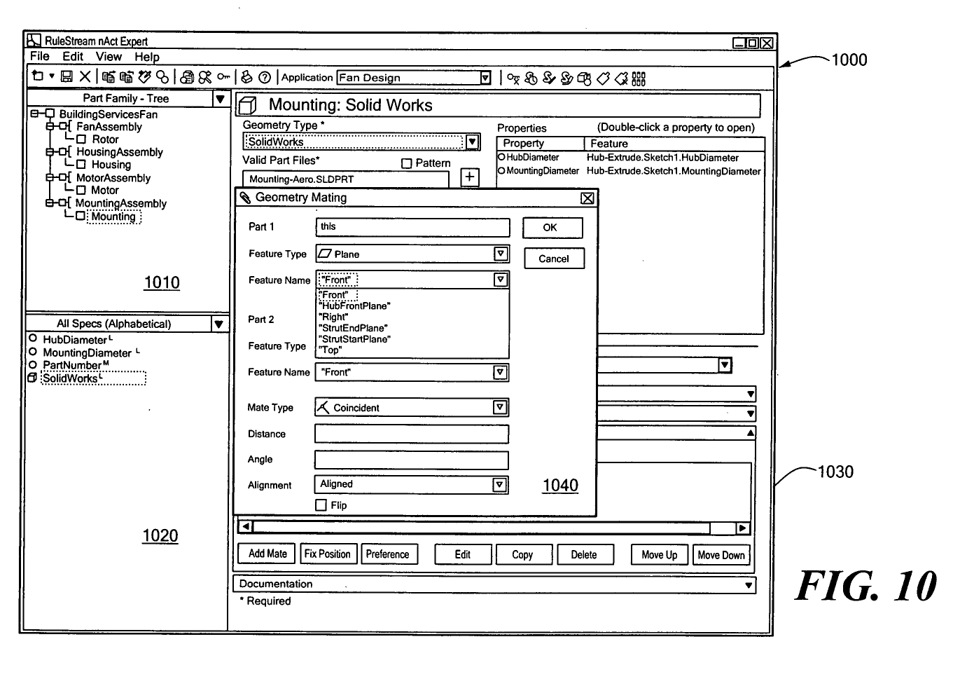

After the geometry features have been defined and associated with corresponding CAD parts, the user typically defines any mating rules associated with the CAD parts file. In order to define a mating, the user may select a function from the toolbar 950 (this function can be accessed from either the File menu or an icon on the toolbar). FIG. 10 shows an exemplary user interface screenshot 1000 for defining a mating, such as might be generated by the knowledge management application in accordance with an embodiment of the present invention. The screenshot 1000 shows the part family tree 1010, a list of all specifications 1020 relating to the Mounting part family, a part file window 1030, and a window 1040 for entering mating information.

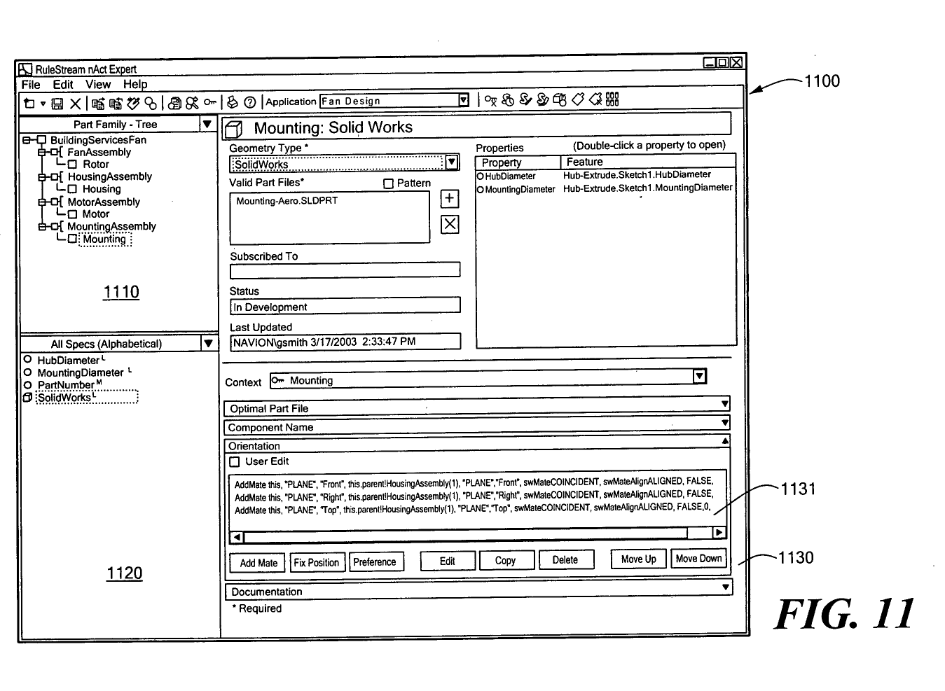

FIG. 11 shows an exemplary user interface screenshot 1100 showing mating definitions, such as might be generated by the knowledge management application in accordance with an embodiment of the present invention. The screenshot 1100 shows the part family tree 1110, a list of all specifications 1120 relating to the Mounting part family, and a window 1130 displaying various mating (orientation) definitions 1131 for the CAD part.

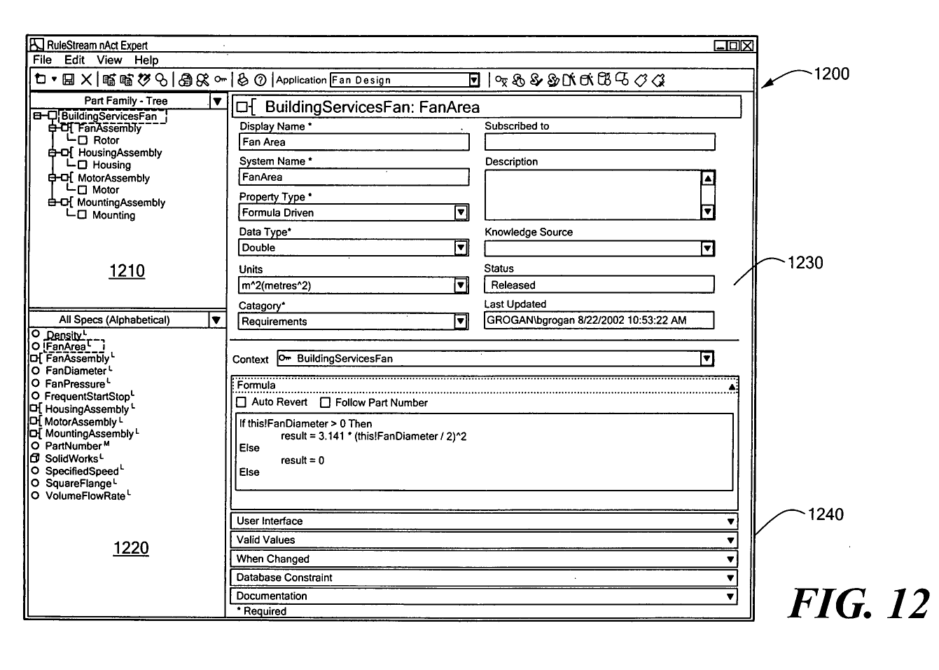

As discussed above, the user can establish rules for attributes that may be difficult or impossible to model in the CAD system, including certain geometric attributes (such as “negative” attributes), certain geometry-based attributes that are not modeled as physical features of a structure or assembly, and non-geometric attributes (such as pricing and processes). For example, continuing with the fan modeling scenario above, it might be useful to establish a rule for computing a non-modeled geometry-based attribute, such as area covered by the sweep of the fan blade component when rotating. While this fan area might be useful, for example, for computing the volume of air moved by a fan blade component having a specified number of blades rotating at a specified rate, the fan area is typically not modeled as a physical feature of the fan. FIG. 12 shows an exemplary user interface screenshot 1200 showing a rule for determining a fan area for the fan, such as might be generated by the knowledge management application in accordance with an embodiment of the present invention. The screenshot 1200 shows the part family tree 1210 (with the part family BuildingServicesFan highlighted), a list of all specifications 1220 relating to the BuildingServicesFan part family (with the FanArea specification highlighted), and a window 1230 displaying the rule 1240 for determining the fan area based on the diameter of the fan blade component. The user can establish other rules that utilize this FanArea value.

After component information has been imported from the CAD system and modeling rules have been established, the knowledge management application controls the CAD system through its API to produce a geometric model according to predetermined specifications. The specifications can be incorporated into the rules and/or provided by a user at run time. The CAD model may be produced for display to the user via the graphical user interface, or may be produced solely for the knowledge management application to obtain model-related information from the CAD system. As an example of the former, the knowledge management application can control the CAD system to generate a model and then produce a graphical display through the graphical user interface including a graphical representation of the model as generated by the CAD system (e.g., by displaying a display window generated by the computer-aided design system), with or without related information from the knowledge management system. As an example of the latter, the knowledge management application can control the CAD system to generate a model and then control the CAD system to compute the surface area of a component for a cost estimate to be produced by the knowledge management application.

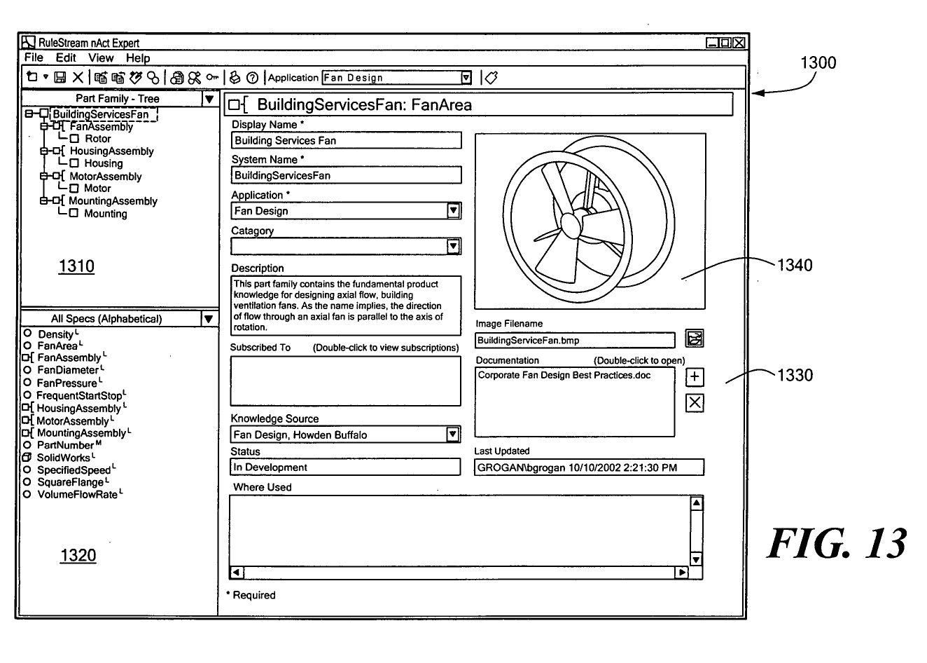

FIG. 13 shows an exemplary user interface screenshot 1300 including an embedded graphical representation of a model generated by the CAD system, such as might be generated by the knowledge management application in accordance with an embodiment of the present invention. The screenshot 1300 shows the part family tree 1310 (with the part family BuildingServicesFan highlighted), a list of all specifications 1320 relating to the BuildingServicesFan part family, and a window 1330 including a portion 1340 including a graphical representation of the model generated by the CAD system.

The user can specify how information is to be displayed by the knowledge management application. For example, the user can specify that the CAD system window be displayed under some conditions but not others, and can also specify what knowledge management system information to display along with the CAD system window.

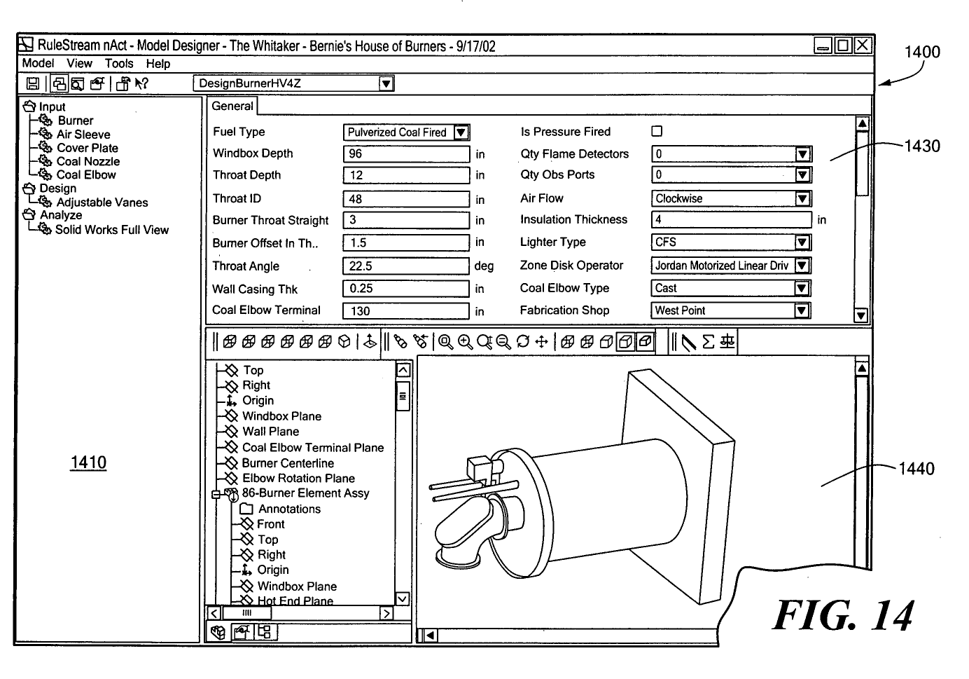

FIG. 14 shows a first exemplary user interface screenshot 1400 including a sub-window generated by the CAD system, such as might be generated by the knowledge management application in accordance with an embodiment of the present invention. The screenshot 1400 displays a function list 1410, information from the knowledge management system 1430, and a sub-window 1440 generated by the CAD system including a graphical representation of the model generated by the CAD system and controls for manipulating the model.

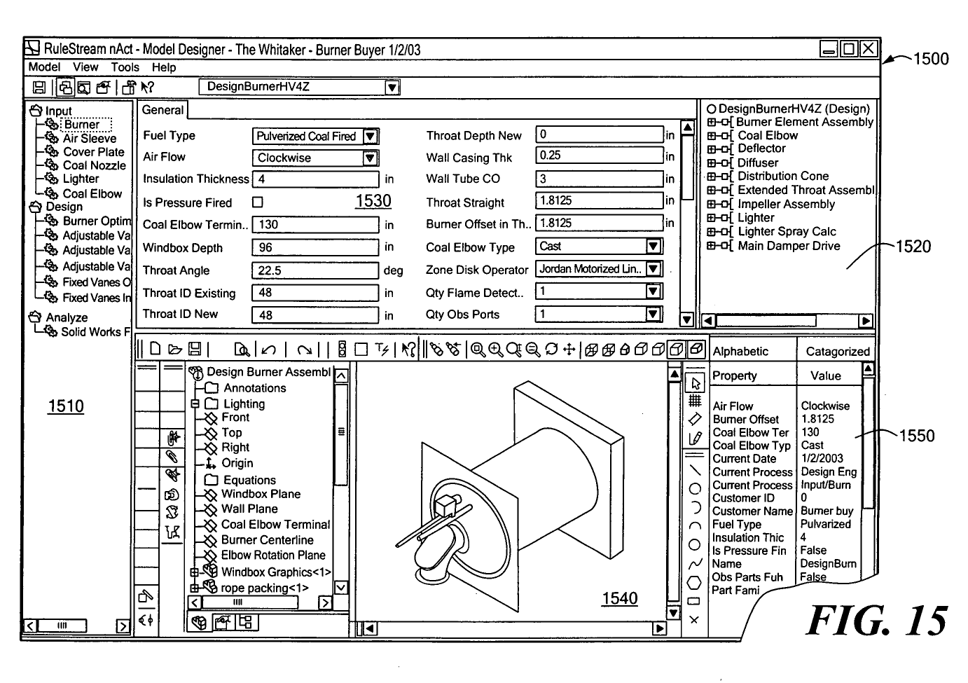

FIG. 15 shows a second exemplary user interface screenshot 1500 including a sub-window generated by the CAD system, such as might be generated by the knowledge management application in accordance with an embodiment of the present invention. The screenshot 1500 displays a function list 1510, a part family tree 1520, information from the knowledge management system 1530, a sub-window 1540 generated by the CAD system including a graphical representation of the model generated by the CAD system and controls for manipulating the model, and properties information 1550.

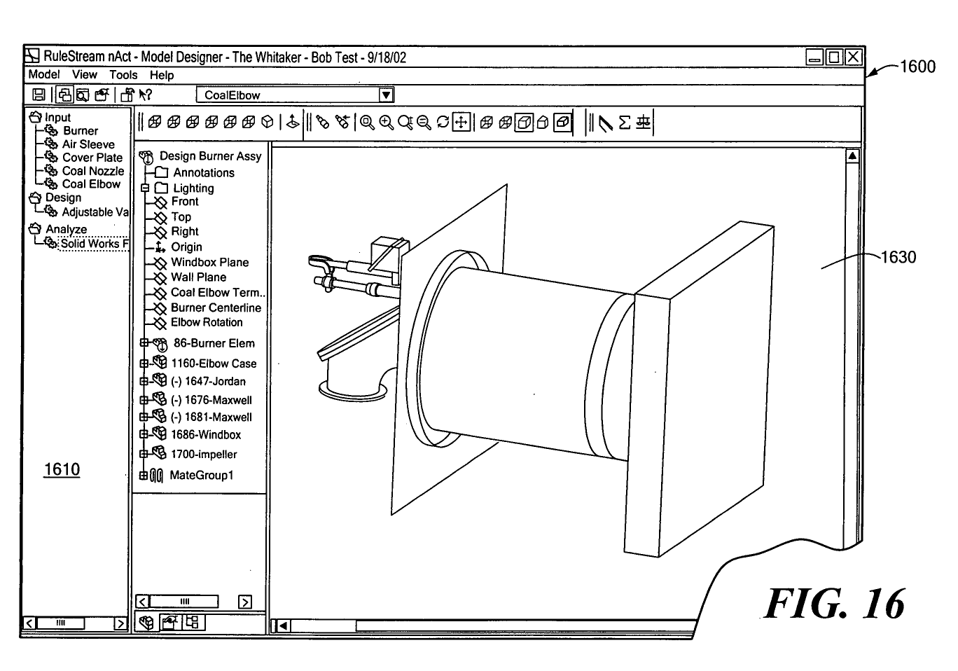

FIG. 16 shows a third exemplary user interface screenshot 1600 including a full view window generated by the CAD system, such as might be generated by the knowledge management application in accordance with an embodiment of the present invention. The screenshot 1600 displays a function list 1610 and a full view window 1630 generated by the CAD system.

In certain embodiments of the invention, the user can make rule changes on the fly, and the knowledge management application will control the CAD system to update the model accordingly and will display the updated graphical representation of the model to the user substantially in real time. In this way, the user essentially gets immediate feedback regarding the rule change.

In certain embodiments of the invention, changes to a model can be made in the CAD system, and the knowledge management application will identify those changes through interactions with the CAD system and will modify and apply rules accordingly. For example, if the user makes a change in the CAD system that overrides a particular rule, the knowledge management application might cause appropriate tracking information to be stored by the knowledge storage application, create one or more revised rules that reflect the change, and apply other rules to update other components of the model according to the rules. The manner in which the knowledge management application can identify CAD system changes depends to a large degree on the CAD system API. For example, the CAD system might communicate the changes to the knowledge management application, or the knowledge management application might monitor or poll the CAD system for changes.

In certain embodiments of the invention, the knowledge management application can cause a particular model part displayed in the CAD system window to be displayed or highlighted when the user is working on rules relating to that part. For example, with reference again to FIG. 13, if the user selects the Motor part family in the part family tree 1310, the knowledge management application might cause the motor to be highlighted in the window 1340, for example, by changing the color of the motor.

In certain embodiments of the invention, the knowledge management application can cause information relating to a particular model part to be displayed when the user highlights that part in the CAD system window. For example, with reference again to FIG. 13, if the user highlights the fan blade component in the CAD window 1340, the knowledge management application might cause information relating to the fan blade component to be displayed in the window 1330, with appropriate highlighting in the part family tree 1310 and the list of specifications 1320.

As discussed above, the knowledge management application can interoperate with two-dimensional CAD systems as well as three-dimensional CAD systems. In an exemplary embodiment of the present invention, the knowledge management application supports both the two-dimensional CAD system VISIO(™) and the three-dimensional CAD system SOLIDWORKS(™).

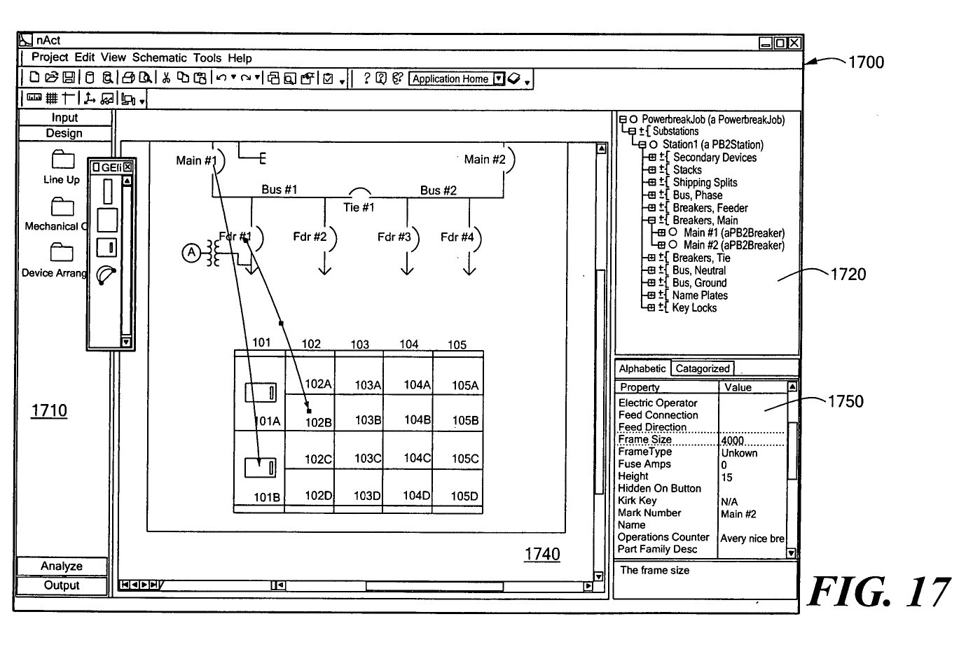

FIG. 17 shows an exemplary user interface screenshot 1700 including a window generated by a two-dimensional CAD system, such as might be generated by the knowledge management application in accordance with an embodiment of the present invention. The screenshot 1700 displays a function list 1710, a part family tree 1720, a CAD system window 1740, and properties information 1750.

The knowledge management application can also interoperate with various analysis applications. Typically, the knowledge management application exports information to the analysis application for analysis. The knowledge management application can display analysis information to the user.

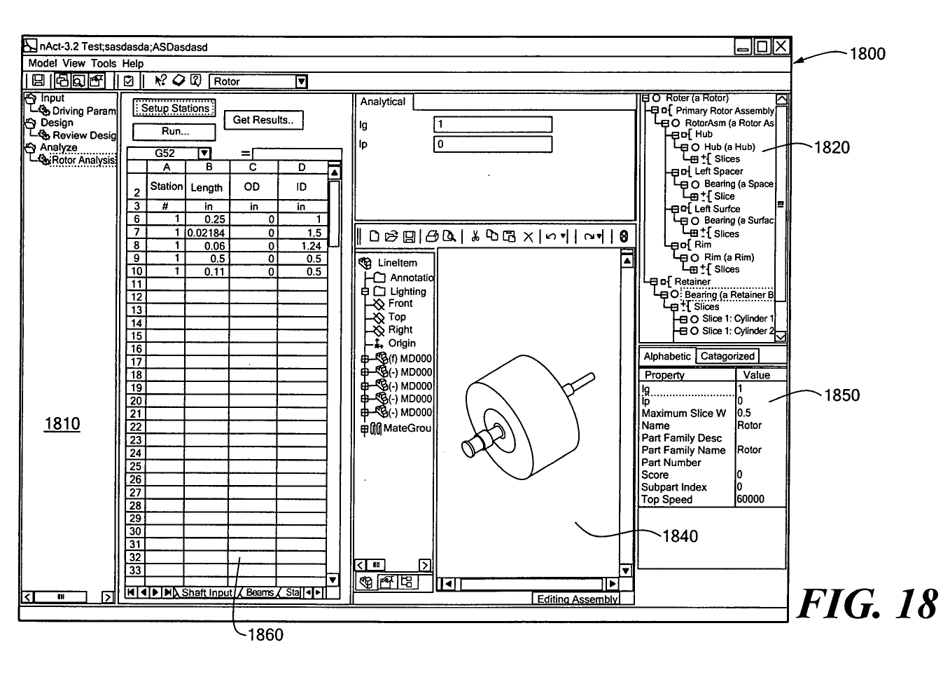

FIG. 18 shows an exemplary user interface screenshot 1800 including an analysis window, such as might be generated by the knowledge management application in accordance with an embodiment of the present invention. The screenshot 1800 displays a function list 1810, a part family tree 1820, a CAD system window 1840, properties information 1850, and an analysis window 1860 generated by the analysis application.

Thus, in certain embodiments of the present invention, structures are defined in a CAD system and are associated with a structure class. Rules are defined for the structure class. When one of the structures is selected by the knowledge management system for a computer-aided design model, the rules are applied to the selected structure. These class-based rules make it easier for the user to define rules, since a single rule defined by the user gets applied to an entire class of structures, and therefore the user does not have to define the rule individually for each structure of the structure class.

FIG. 21 is a logic flow diagram showing exemplary logic 2100 for class-based rules in accordance with an embodiment of the present invention. Starting in block 2102, structures (such as parts for an assembly) are defined in a CAD system, in block 2104. The structures are associated with a structure class (such as a part family) in a knowledge management system, in block 2106. At least one rule is defined that applies to the structure class, in block 2108. When one of the structures is selected for a computer-aided design model by the knowledge management system, in block 2110, the knowledge management system applies the rule(s) to the selected structure, in block 2112. The logic 2100 ends in block 2199.

As discussed above, the knowledge management application obtains a set of rules from a central database. The set of rules may include rules relating to geometric and non-geometric attributes. The non-geometric attributes may be dependent on geometric attributes. The knowledge management application generates instructions for modeling a geometric structure based on the set of rules. The knowledge management application communicates the instructions to a computer-aided design system, typically through an API of the computer-aided design system. The knowledge management application may produce a graphical display on a graphical user interface including information from the knowledge management system as well as information from the computer-aided design system (such as a graphical representation of a geometric model).

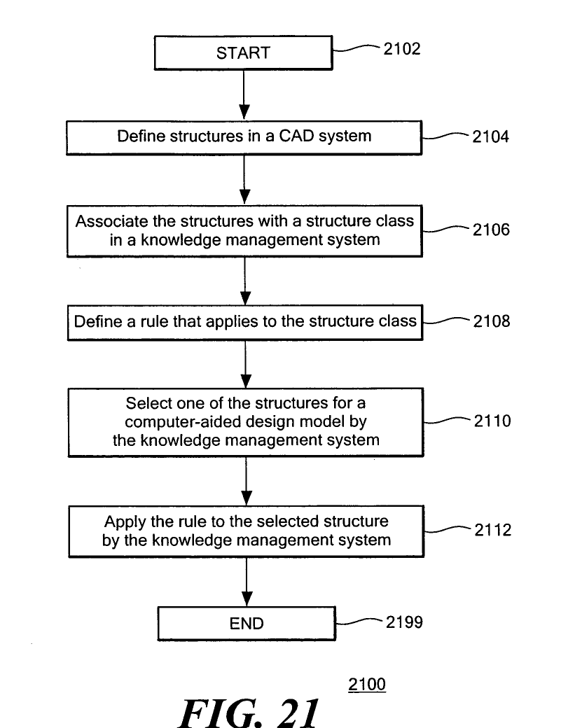

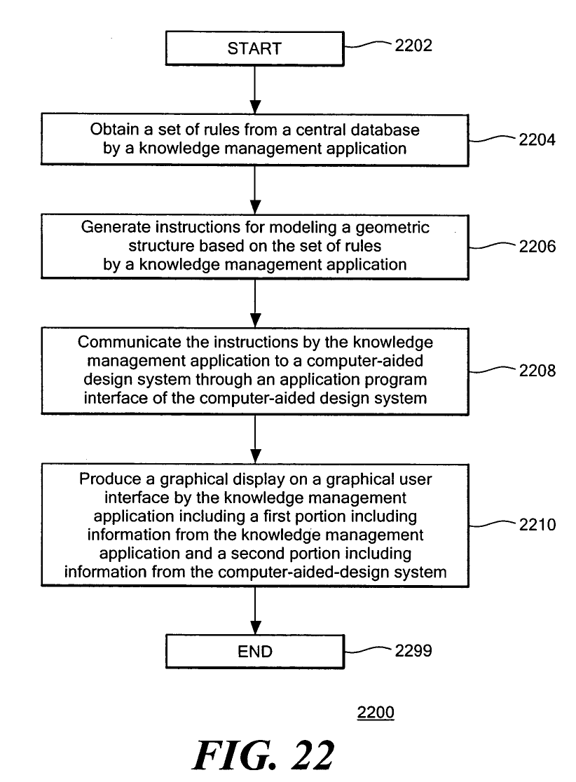

FIG. 22 is a logic flow diagram showing exemplary logic 2200 for the knowledge management application in accordance with an embodiment of the present invention. Starting in block 2202, the logic obtains a set of rules from a central database, in block 2204. The logic generates instructions for modeling a geometric structure based on the set of rules, in block 2206. The logic communicates the instructions to a computer-aided design system, in block 2208, typically through an application program interface of the computer-aided design system. The logic may produce a graphical display on a graphical user interface including a first portion including information from the knowledge management application and a second portion including information from the computer-aided design system, in block 2210. The logic ends in block 2299.

In certain embodiments of the present invention, the knowledge management system includes integrated support for one or more third-party product document management (PDM) systems, such as the SmarTeam(™) PDM system and the Matrix(™) PDM system. The knowledge management system uses documents in a variety of manners. The primary usage of documents stems from the need to demand CAD files (e.g., SolidWorks (SW) documents) and schematic files (e.g., Visio documents) during runtime. The knowledge management system typically also uses documents for access to part family image files and related office documents.

Thus, the computer-aided modeling system preferably includes a document access (DA) manager for managing documents. In an exemplary embodiment of the present invention, the DA is typically implemented as a dynamic link library (DLL) that is used by the knowledge management system (i.e., Rulestream) to manage documents. The DA DLL is also available to be used by other applications so that documents will be accessed and managed in a uniform manner. Furthermore, a “custom.bas” file can be used to create custom functions by which a user (with knowledge) can access the DA. For convenience, the DA may be referred to hereinafter as the Rulestream Document Manager or rsDocMgr.

In an exemplary embodiment of the present invention, the DA manages documents from three (3) separate and unique file repositories, namely a shared file system (fileshare), a SmarTeam PDM system, and a Matrix PLM system. Each of the repositories represents its own benefits and challenges. As much as possible, the differences are transparent to a user of DA.

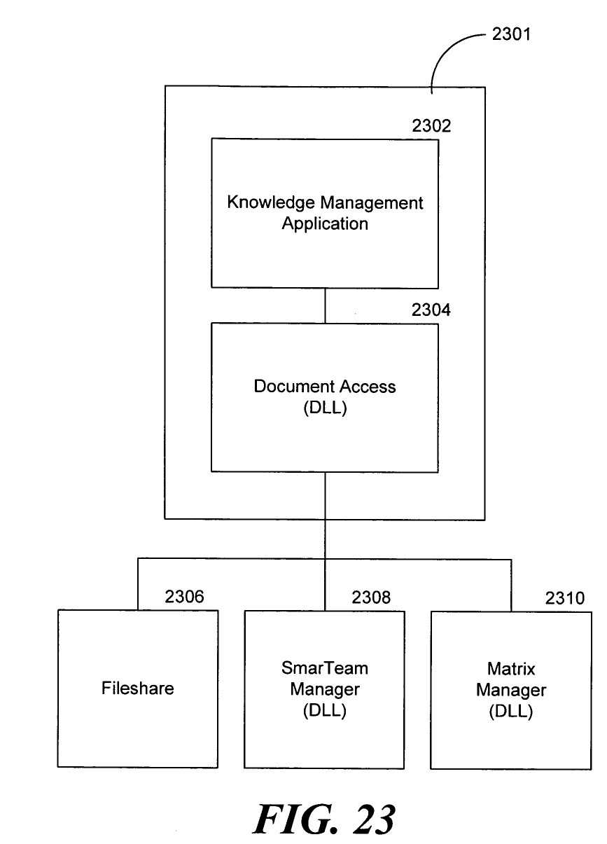

FIG. 23 shows an exemplary computer-aided modeling system in accordance with an embodiment of the present invention. Among other things, the computer-aided modeling system includes a knowledge management system 2301 coupled to a fileshare 2306, to a SmarTeam PDM system 2308 via a SmarTeam Manager DLL, and to a Matrix PLM system 2310 via a Matrix Manager DLL. Among other things, the knowledge management system 2301 includes a knowledge management application 2302 and a Document Access (DA) DLL 2304 (referred to hereinafter simply as the “DA”). The knowledge management application 2302 makes calls to the DA 2304 to access and manage documents. The DA 2304 in turn makes calls to the fileshare 2306, the SmarTeam system 2308, or the Matrix system 2310 as appropriate for a particular modeling session. The document access method is typically configured at a Rule Database level using various configurator tools, meaning all users that create or use rules stored in a specific rules database will use the same document access method. This configured method, however, can be overridden manually at the user level to access documents via the file share.

Knowledge management documents are typically stored hierarchically, with different objects used to for different types of documents. Each object is associated with various attributes. Attributes from a higher level object generally apply to all subordinate objects through inheritance.

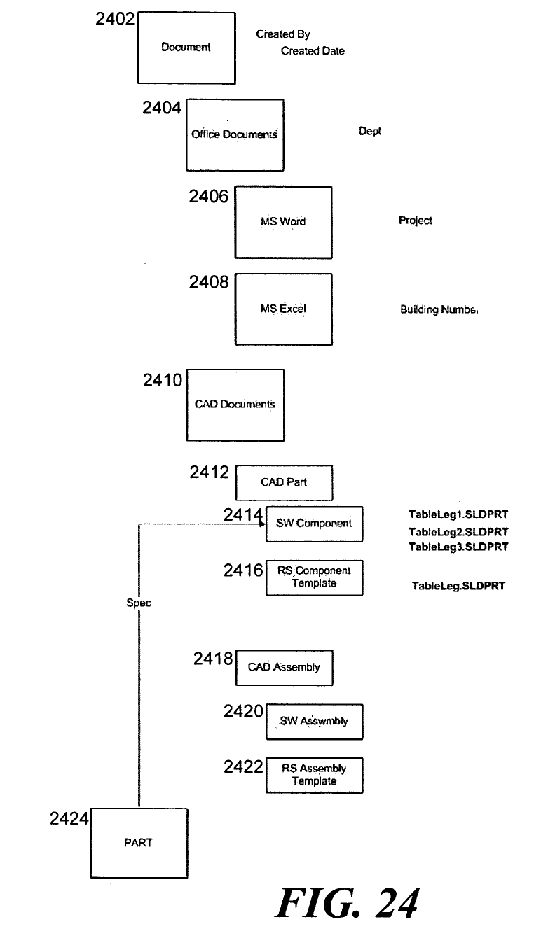

An exemplary hierarchy is shown in FIG. 24. In this example, the highest level object is the Document object 2402, which includes attributes, such as “created by” and “created date,” which apply to all subordinate objects through inheritance. The next level objects include Office Documents 2404 and CAD Documents 2410. Under Office Documents 2404, there are objects for MS Word documents 2406 and MS Excel documents 2408. Under CAD Documents 2410, there are objects for CAD Part documents 2412 and CAD Assembly documents 2418. Under CAD Part 2412, there are objects for SW Component documents 2414 and Rulestream (RS) Component Template documents 2416 (described below). Under CAD Assembly 2418, there are objects for SW Assembly documents 2420 and RS Assembly Template documents 2422 (described below). The SW Component object 2414 is used to specify a specific part 2424 for a model.

When using the fileshare 2306 for document management, knowledge management documents are typically kept in a master document folder. In this way, the knowledge management documents are kept in a known location. When the knowledge management application 2302 requests access to a document, the DA 2304 goes to the master document folder and returns True if the document is found and False if the document is not found. The knowledge management application 2302 can also save documents to the master document folder and create and save templates to the master document folder. A release folder is typically used to store documents related to a particular release of a model. The release folder is typically in a predefined directory. The knowledge management application 2302 typically includes a “release model” menu that, when selected, causes the knowledge management application 2302 to run through an entire model to identify documents that are being used for the model, make calls to the DA 2304 to collect the documents, and copy the documents in the release folder as a sort of “snapshot” of the documents. A working directory is used to store any documents that are modified by rule changes at run time.

When using a PDM system for document management, knowledge management documents must similarly be maintained in the PDM system in a manner that is known to the DA 2304. Thus, in an exemplary embodiment of the present invention, knowledge management documents are maintained in the PDM system under a predetermined PDM classification. Specifically, the PDM system is required to have objects with predetermined names and relationships so that the DA 2304 can access and manage the documents using those objects. Generally speaking, at every level of the document hierarchy where a CAD document will be stored, there needs to be an object for corresponding RS templates. Thus, with reference again to FIG. 24, there is a RS Component Template object 2416 at the level of the hierarchy including the SW Component object 2414, and there is a RS Assembly Template object 2422 at the level of the hierarchy including the SW Assembly object 2420.

In an exemplary embodiment of the present invention, the DA 2304 includes three core objects, namely a DocumentAccess object, a Document object, and a Documents object. The DocumentAccess object functions as the cornerstone of document management, and is the primary class with which a user interacts to demand, save, update, and reference documents. The Document object functions as an abstract representation of a physical file within the knowledge management framework, and can be created and can exist without an actual reference to a file object. The Documents object operates as a collection of document objects, and also contains several methods for population of the collection and the creation of a hierarchical representation of the documents in the collection. It should be noted that, while the collection preferably exists as a flat structure of document objects, each object can contain (via its parents and children properties) references to other objects in the collection to define a hierarchical structure.

The DocumentAccess object preferably operates on a success/failure basis. All major methods return a Boolean (True/False) value. If the returned value is True, the method call was successful; if the returned value is False, the “Errors” property (a collection of error objects) of the object should be checked for specific failure reasons.

In accordance with an embodiment of the present invention, the following rules must be adhered to when using the DocumentAccess object. First, upon creation of the object, an “Initialize” method must be called and return successfully—if it fails, no other method calls will be successful, and an error collection should be checked to ascertain why the object failed to be created. Second, prior to destroying an instance of a DocumentAccess object, a “deconstruct” method must be called in order to ensure that the object is completely and successfully removed from memory. The above concepts are demonstrated in the following pseudocode to create a new DocumentAccess object called oDocAccess:

If oDocAccess.Initialize(strAppPath, strFullIniPath, _ strProfileName)
then

Do Stuff

Else

MsgBox oDocAccess.Errors(1).Description

End If
oDocAccess.Deconstruct
Set oDocAccess = Nothing

Methods used to return document objects (e.g., GetMasterDocument, GetDocument, GetDocumentByID, GetReleaseDocument) will populate a “CurrentDocument” property of the DocumentAccess object with a reference to a valid document object upon success. Upon failure, this property will be set to Nothing. Likewise, a method used to save documents (e.g., SaveDocument) acts upon the document referenced in the “CurrentDocument” property. These concepts are demonstrated in the following pseudocode:

If oDocAccess.GetMasterDocument(“File.txt”) then

If not oDocAccess.SaveDocument(“”,enuWorkingFolder) then

MsgBox oDocAccess.Errors(1).Description

Else

‘ Do Stuff

End If
Else

MsgBox oDocAccess.Errors(1).Description

End If

Methods used to return Scripting.Folder objects (e.g., GetFolder, GetMasterDocumentsFolder, GetReleaseFolder) will populate a “CurrentFolder” of the DocumentAccess object with a reference to a valid Folder object upon success. Upon failure, this property will be set to Nothing.

Various method calls and properties of the DocumentAccess object for an exemplary embodiment of the present invention are described in the Appendix below entitled “Project rsDocMgr,” which is hereby incorporated herein by reference in its entirety.

In order for the knowledge management system to integrate with the PDM system, certain constraints are typically placed on the PDM implementation. The constraints may be different for different PDM systems. For example, as described above, the SmarTeam implementation is required to have certain Rulestream objects in place for use by the Rulestream knowledge management system. Also, certain Rulestream-specific attributes are typically added (e.g., RS_MODEL_ID attribute added to documents general links, RS_STANDARD attribute added to compositional links), and a sequence generator is added for generating unique model identifiers.

During modeling, models are preferably checked into and out of the PDM system when a line item is checked in and out of the Rulestream knowledge management system, although CAD objects could alternatively be created in the PDM system only when a model is released in Rulestream. PDM system objects that are associated with a model are preferably not “released” in the PDM system when a model is released in Rulestream, but instead Rulestream preferably performs a check-in (put/unlock) or check-out (get/lock) within the PDM system via the DA as appropriate when the user checks in or checks out a document in Rulestream (among other things, this allows the user to determine releases for PDM documents rather than Rulestream). When the release function is selected in RuleStream, the check-in functionality is preferably executed. Each CAD model object is typically associated with a project. Therefore, the first time a top level document (Assembly, Part, Drawing, etc. that has no parent) is checked into the PDM system, the user will typically be prompted as to where to store the document. This allows the user to select a project, subproject, or document folder within a project to which they want to associate the document object. For example, in some implementations, the user may want CAD documents stored in one sub-project and reports/outputs in another. With specific reference to Rulestream integration with SmarTeam, the Rulestream knowledge management system allows users to query SmarTeam “lookup” tables for values at runtime. This is useful for allowing a user to drive attribute values required for the creation of SmarTeam objects when the attribute only accepts values from a predefined lookup table internal to SmarTeam.

With specific reference to Rulestream integration with SmarTeam, creating the RS document class structure is done via the SmarTeam “Data Model Designer” utility. For an existing SmarTeam implementation, various modifications will have to be made to the SmarTeam database, as will be discussed below. When creating new classes, it is a general rule that class indexes are defined at the super-class level, all sub-classes of a super-class will inherit the user-defined attributes of the super-class (which is important when considering when to add a mandatory attribute to a class structure), and only leaf classes (ones with no children) can be created to represent an object in SmarTeam.

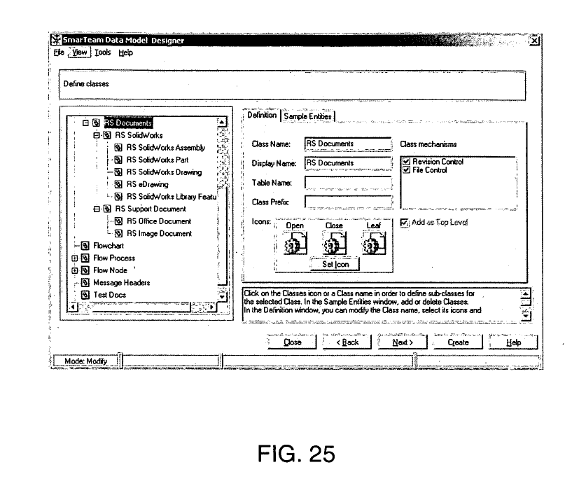

FIG. 25 is a screenshot for defining classes for RS integration with SmarTeam in accordance with an embodiment of the present invention. The classes must be created exactly as follows: the “RS Documents” class can be created off the Documents super-class. The “RS Documents” class must be set as “File Control” and “Revision Control,” which can occur through inheritance if the implementation's super-class is set for these two mechanisms or else must be specifically set. Icons should be set via the interface by clicking the “Set Icon” button and following the screens. Subclasses of the “RS Documents” class (RS SolidWorks and RS Support Document) are created by selecting the Sample Entities tab and adding the class names. Subsequent subclasses (RS SolidWorks Assembly, RS SolidWorks Part, etc.) are created as described above when the respective parent class is selected.

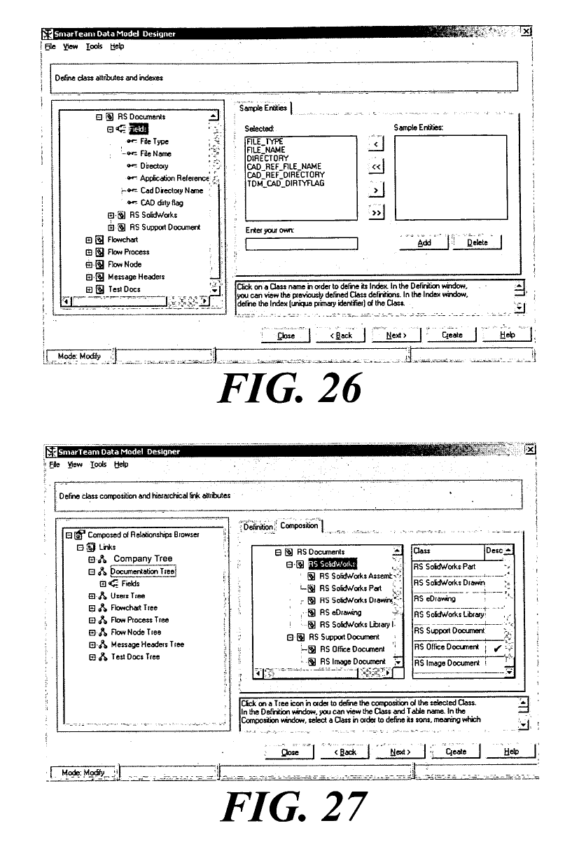

FIG. 26 is a screenshot for defining class attributes and indexes for RS integration with SmarTeam in accordance with an embodiment of the present invention. As shown in FIG. 26, no additional fields should need to be added to the newly created RS Documents classes. The attribute fields are created automatically with a “File Managed” class.

FIG. 27 is a screenshot for defining class composition and hierarchical link attributes for RS integration with SmarTeam in accordance with an embodiment of the present invention. The class composition and hierarchical link attributes are defined by selecting the “Documentation Tree” on the left, selecting the “Composition” tab on the right, and selecting the “RS SolidWorks” class. Selecting “RS Office Document” on the right side of the “Composition” tab allows an object of class type “RS Office Document” to be linked to an object of class “RS SolidWorks” or one of its child classes as a child object. The class “RS SolidWorks Assembly” should allow objects of class types “SolidWorks Assembly,” “SolidWorks Part,” “RS SolidWorks Assembly,” “RS SolidWorks Part,” and “RS SolidWorks Library Feature” to be linked as children. The class “RS SolidWorks Part” should allow objects of class type “RS SolidWorks Library Feature” to be linked as children. The class “SolidWorks Assembly” should allow objects of class types “SolidWorks Assembly,” “SolidWorks Part,” “RS SolidWorks Assembly,” “RS SolidWorks Part,” and “RS SolidWorks Library Feature” to be linked as children. The class “SolidWorks Part” should allow objects of class type “RS SolidWorks Library Feature” to be linked as children.

FIG. 28 is a screenshot for designing a profile card form for RS integration with SmarTeam in accordance with an embodiment of the present invention. Designing a Profile Card (used when a user is using the SmarTeam interface or when a SmarTeam screen is raised via a script or API call) can be problematic, particularly because each SmarTeam implementation typically has its own “look and feel” due to customization by the user. It is therefore desirable for profile cards to be developed in close cooperation with the user so that the profile cards work within the SmarTeam implementation and can be understood by the user. When changes are complete, the “Create” button can be selected to process the changes and make the necessary modifications to the SmarTeam database.

SmarTeam allows for the creation of default sequence ID values for attributes of a given class via its “Sequence Designer” utility. This is analogous to auto-incrementing columns on a database table. However, these columns can be defined as a series of characters and numbers.

For the purposes of creating objects that are of a class type under the “RS Documents” subclass, the user typically starts the Sequence Designer utility, and then, in the class browser, selects a class and expands its attributes list. The user then selects an attribute. It generally does not matter which class or attribute, since they are not going to be linked manually.

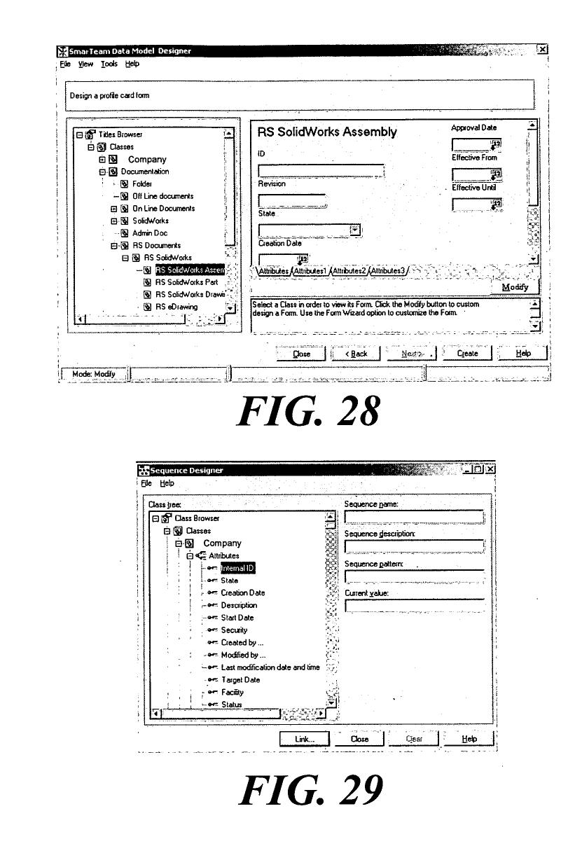

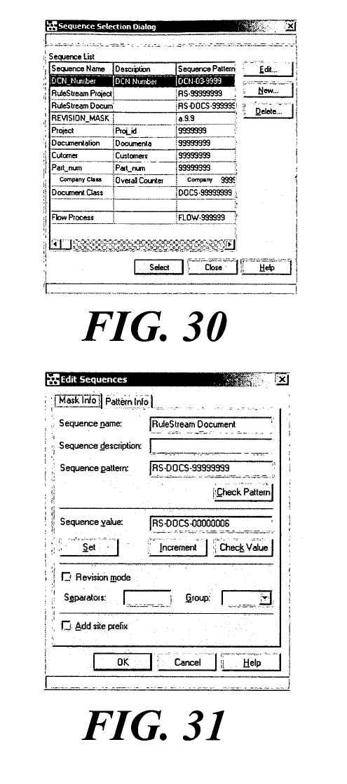

FIG. 29 is a screenshot for creating default sequences for RS integration with SmarTeam in accordance with an embodiment of the present invention. As shown in FIG. 29, the attribute “Internal ID” has been selected. From here, the user selects the “link” button, which brings up the screenshot shown in FIG. 30. The screenshot in FIG. 30 allows the user to add a new sequence, specifically by the “New” button to reach the screenshot shown in FIG. 31. From the screenshot shown in FIG. 31, the user adds information in the various fields and selects the “OK” button to add the sequence. Once the sequence has been added, the user can select the “Close” button on the preceding window. If instead the user selects the “Select” button, the sequence will be tied (incorrectly) to the wrong attribute and possibly the wrong class.

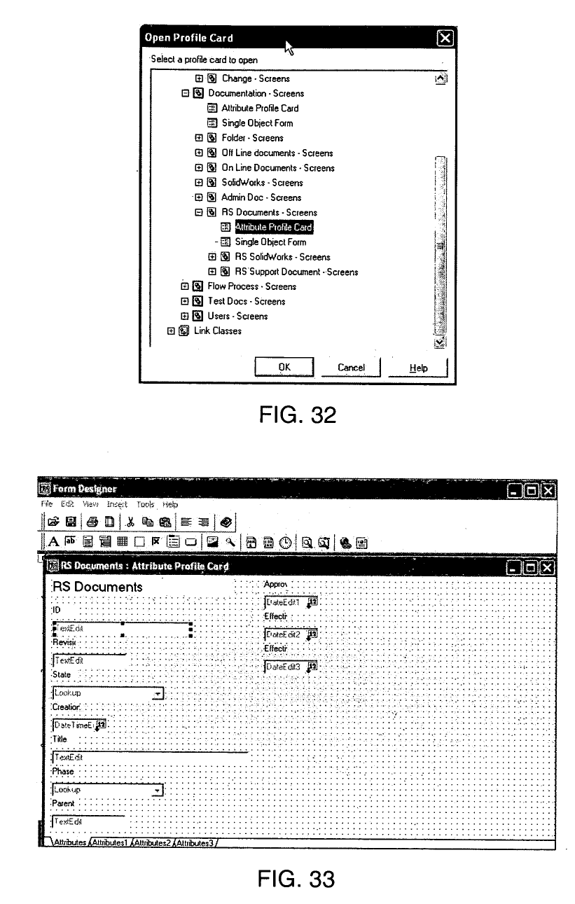

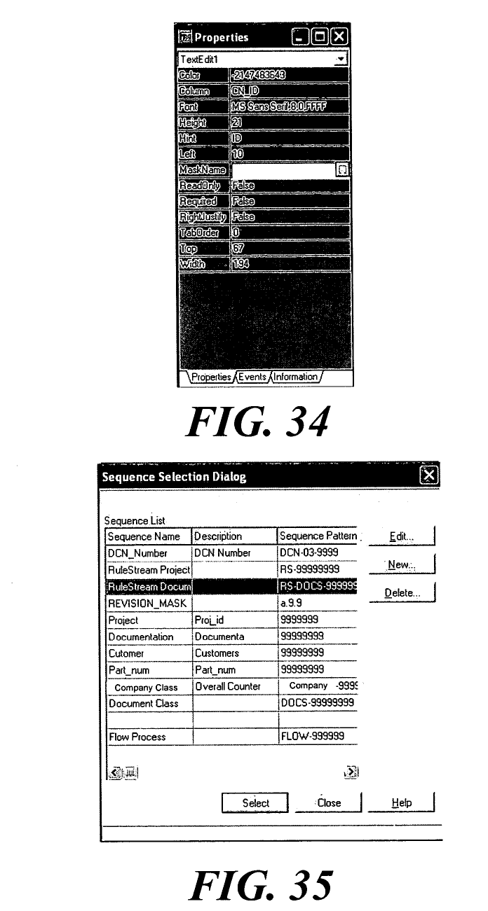

The newly created sequence must now be tied to the classes that are Rulestream specific. This process is typically done as follows. First, the user opens the SmarTeam Form Designer Application and logs in. The screenshot shown in FIG. 32 appears. Then, the user drills down and selects the “RS Documents” class and the “Attribute Profile Card,” as shown in FIG. 32. The user then selects “OK,” which brings up the screenshot shown in FIG. 33. The user then selects the field to be tied to the newly created sequence, which brings up the “Properties” window shown in FIG. 34. The user then selects the “MaskName” row in the entry screen and selects the ellipsis, which brings up the “Sequence Selection Dialog” window shown in FIG. 35. The user then selects the property sequence to be tied to the field (in this example, “Rulestream Documents”) and selects the “Select” button. The user then closes the window and selects the “Save” button on the toolbar to save the changes. These steps can be repeated for all of the Rulestream specific classes by selecting “Open” and selecting the next sub-class.

Attributes required for creating project objects may need to be added to the top-level CAD file or file that is to be saved during release that has no parents. This is typically performed automatically when the user specifies the project/object to which the documents should be attached, as described above. However, these attributes could also be created as custom properties on the file with the custom property name equaling RS_<attribute name> where <attribute name> equals exactly what it is called on the SmarTeam object. In an exemplary embodiment of the invention, these project attributes are “CN_DESCRIPTION,” “CN_ACTIVITY_CENTER *,” and “CN_FACILITY *.”

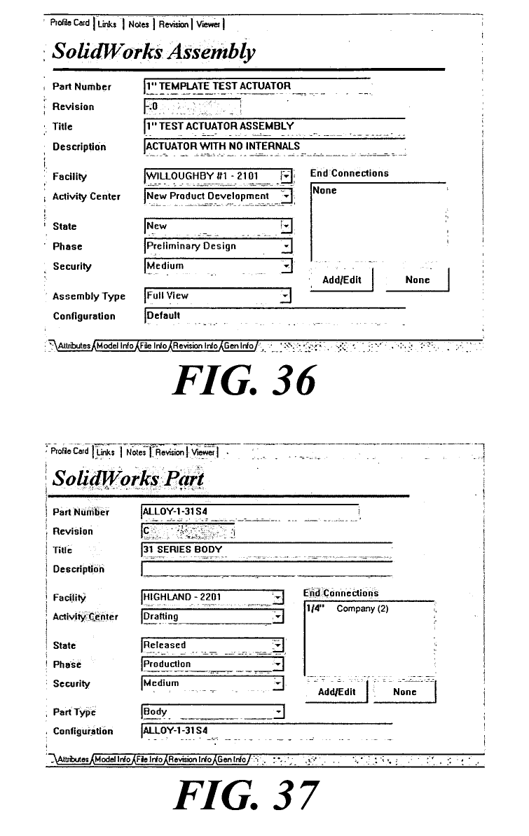

Creating SolidWorks or Document objects in a SmarTeam implementation may require certain attributes to have valid values. These attributes and values should be written to the files custom properties collection. Exemplary attributes for various SolidWorks file types are described below with reference to FIGS. 36-39, which are screenshots of optional object classes profile cards that may be created within SmarTeam to display and represent object data as data contained within SmarTeam. It should be noted that these profile cards are not required, and the knowledge management system can operate with the PDM system regardless of whether these profile cards exist or not.

As shown in FIG. 36, the following are exemplary attributes for SolidWorks Assemblies:
CN_PART_NUMBER
CN_TITLE
CN_FACILITY *
CN_ACTIVITY_CENTER *
CN_END_CONNECTION
CN_ASSEMBLY_TYPE *

As shown in FIG. 37, the following are exemplary attributes for SolidWorks Parts:
CN_PART_NUMBER
CN_TITLE
CN_FACILITY *
CN_ACTIVITY_CENTER *
CN_END_CONNECTION
CN_PART_TYPE *

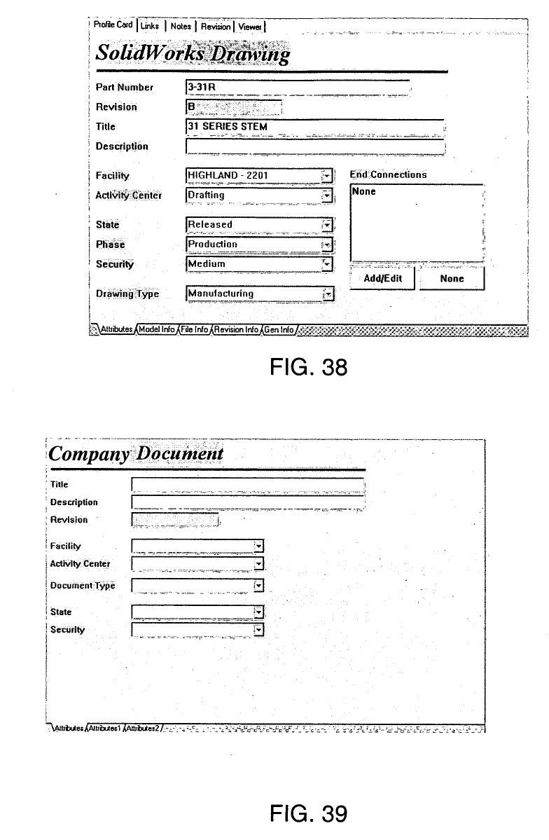

As shown in FIG. 38, the following are exemplary attributes for SolidWorks Drawings:
CN_PART_NUMBER
CN_TITLE
CN_FACILITY *
CN_ACTIVITY_CENTER *
CN_END_CONNECTION
CN_DRAWING_TYPE *

As shown in FIG. 39, the following are exemplary attributes for a specific company:
CN_TITLE
CN_FACILITY *
CN_ONLINE_DOCUMENT_TYPE *

Some of the values required for these fields come out of lookup tables inside of SmarTeam. For a production implementation, these tables/values are handled within RuleStream, for example, by copying the tables to another database to create database constraints on properties or creating Valid Values lists with the data. The attributes tied to look up tables are noted with an asterisk (*) above. It should be noted that a user of Rulestream Architect can pull valid lookup data directly from SmarTeam at runtime.

In order to allow for the creation and modification of SolidWorks CAD files for classification and usage with the Rulestream runtime environment, the computer-aided design system preferably includes a Rulestream add-in for SolidWorks. An exemplary add-in for integration with the Matrix PDM system is described below, although it should be noted that add-ins that perform the same or similar functions can be created for integration with SmarTeam and other PDM systems.

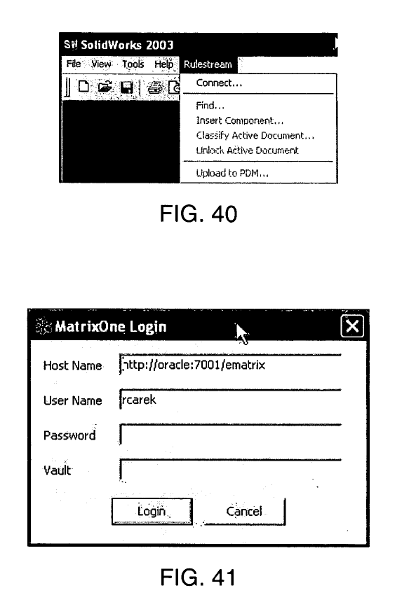

As shown in FIG. 40, the add-in creates a Rulestream menu in SolidWorks. From the Rulestream menu, the user can select “Connect” to connect to the PDM system, “Find” to locate and open an existing document in the PDM system, “Insert Component” to locate an existing document in the PDM system and insert it into an open assembly, “Classify Active Document” to classify an active document for part number research purposes, “Unlock Active Document” to remove a lock on document objects in the PDM system and ignore any modifications that may occur, and “Upload to PDM” to insert the document(s) into the PDM system for access usage within the Rulestream knowledge management system. It should be noted that template files that are created in the SolidWorks design environment must adhere to the definition requirements set forth by Rulestream for usage at runtime.

The “Connect” menu option connects the user to the PDM system. When the “Connect” menu option is selected, the user is presented with a login screen as shown in FIG. 41. This screen requires a number of pieces of information in order for the user to connect successfully, specifically a host name, a user name, a password, and optionally a vault. The host name is the name of the server on which the PDM system (in this example, Matrix) is running. If the RMI server is running in a separate process from the web server, this will typically be the computer name. If the RMI server is running in RIP Mode (within the same process as the web application) the host name will typically be the PDM web application URL (as shown). The user name is the login identifier for the PDM system. The password is the user password for the PDM system. The vault specifies the data vault to which the user wants to connect. This field is optional and can be disabled via an INI setting. If it is left blank, a successful login will place the user in a default vault (as set by the PDM administrator). Upon a successful login, the add-in stores the Host, User Name, and Vault (if specified) in an INI file and pre-populates the fields for subsequent logins.

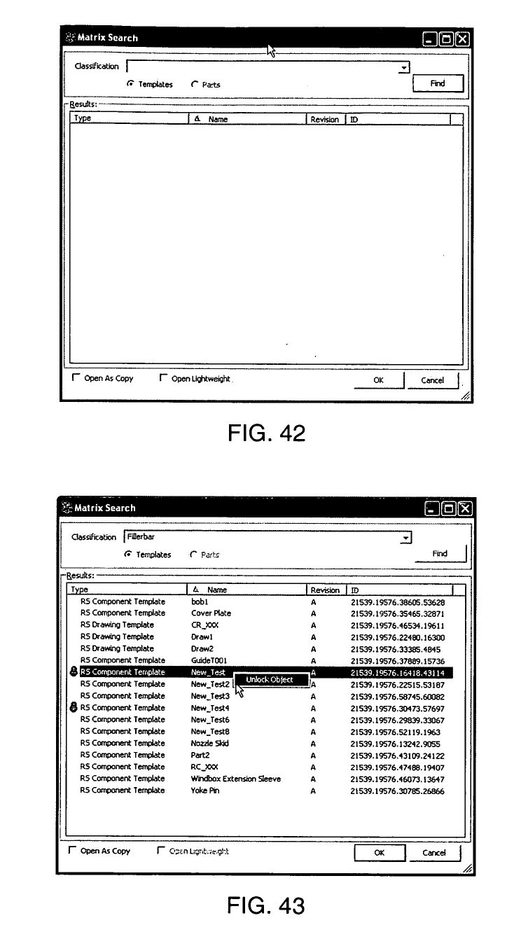

The behaviors of the “Find” menu option and the “Insert Component” menu option are essentially the same, although the “Find” menu opens the selected document in its own SolidWorks window, while the “Insert Component” menu option inserts the selected document into an open assembly. The “Insert Component” menu option will generally only be enabled when the active SolidWorks window contains a SolidWorks assembly. When the “Find” or “Insert Component” menu options are selected, the user is presented with a search screen, as shown in FIG. 42. The search screen includes a “Classification” drop down box that allows the user to select which classification to search, “Templates/Parts” radio buttons that allow the user to select whether to search for Templates or existing Part instances of a selected classification, a “Find” button that allows the user to execute the search, a “Results” window in which is listed all PDM objects that are found for the given search, an “Open As Copy” checkbox that allows the user to control whether the selected object will be checked out and locked for modification or whether the selected object will be checked out and flagged as a new object (which allows the user to create new templates based on the geometry of existing templates), an “Open Lightweight” checkbox that is only enabled when the user has selected an assembly from the results list and allows a user to insert and mate an existing assembly into a template assembly without demanding and returning all the supporting files, an “OK” button that allows the user to check out the selected document and open it in the SolidWorks design environment, and a “Cancel” button that allows the user to cancel the search.

When the “Find” button is pressed and there are document objects that match the search criteria, a screen such as the one shown in FIG. 43 will be displayed. Any objects with a green lock icon are objects that the current user already retains a lock on. Any object with a red lock icon displays an object that is currently locked by a different user. By “right-clicking” on an object that is locked by the current user, the user will be presented with a pop-up menu to unlock the object. If the object is unlocked and its file is currently open in the SolidWorks session, the “files modifiable” flag will be set to FALSE and any changes will be ignored.

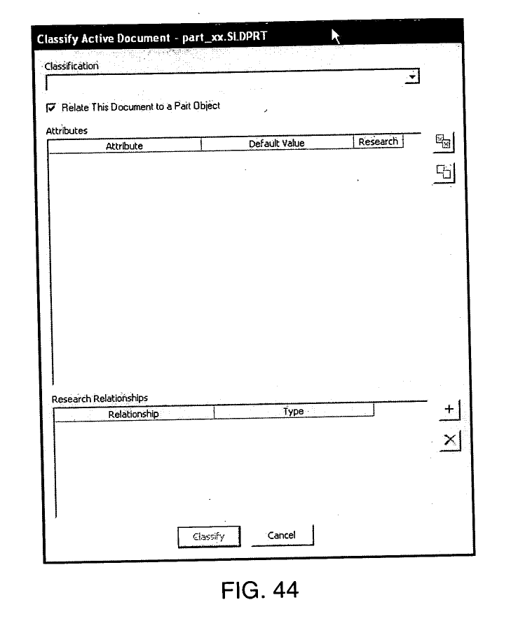

When the “Classify Active Document” menu option is selected, the user is presented with a classification window, as shown in FIG. 44. This window allows the user to define what the template document will represent (Part Classification), whether or not the template will ultimately attach to a “PART” object in PDM, and, if so, what attributes and relationships the Part will be used to research whether an existing Part of this documents parametric definition exists or a new “PART” object should be created. This classification only applies to the top level part in the active window. Therefore, if a user has an assembly open, the “Classify Active Document” functionality only applies to the assembly. To classify the assembly's constituent parts, the parts must either be open into separate windows or done when the documents are set to upload to PDM (described below in the “Upload to PDM” section).

The classification window includes a “Classification” drop down box that allows the user to select the classification to which the template applies, a “Relate This Document to a Part Object” checkbox that flags whether the document will ultimately represent a specification of a “PART” object in PDM (sketches and Library Features are examples of document types that would not end up as a specification of a document), an “Attributes” window in which is listed all potentially researchable attributes for a selected classification so that the user can define/select a default value and set whether the attribute will be used during the part number research, “Select/Unselect All” buttons that allow the user to select or unselect attributes, a “Research Relationships” window that allows the user to select a Relationship/Type combination used during research (the user would populate the value of these custom properties with a pipe “|” delimited list of objects that are of the “type” selected and related to a “Part” object of the classification type selected on the relationship selected), “Add/Remove” buttons that allow the user to add and remove researchable relationship/type combinations, a “Classify” button that allows the user to create the custom properties on the active document that represent the researchable fields, and a “Cancel” button that allows the user to cancel the classification.

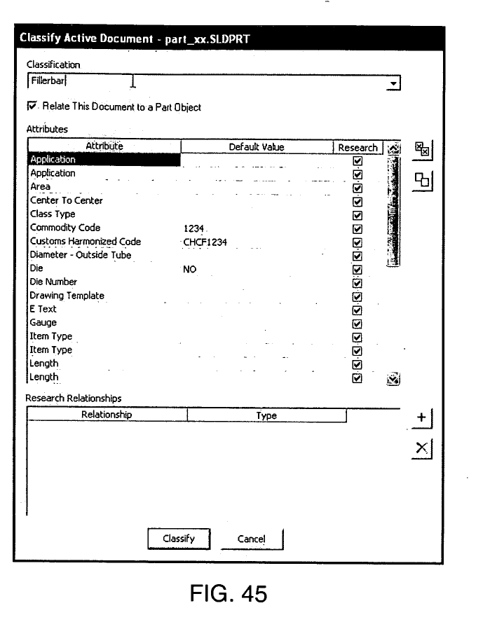

When a Classification is selected, a window such as the window shown in FIG. 45 is displayed. All attributes attached to the classification will be listed. Any default values will be populated and, by default, all attributes will be selected for research.

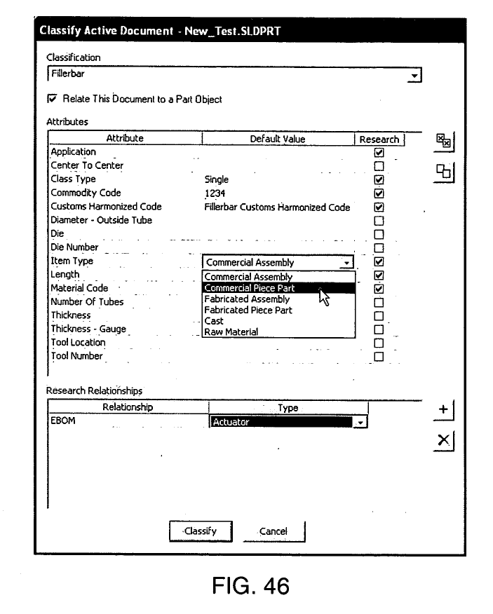

Some attributes are defined with a predefined list of valid values. If this is the case and the user chooses, they can select from the drop-down and set a default value for one of the researchable properties. This list of valid values will be available when the user enters the attributes “Default Value” field as shown in FIG. 46. When a user adds a researchable “Relationship/Type,” the “Relationship” field will show a dropdown of all valid relationships to the classification type selected. When a relationship is selected, the “Type” field will have dropdown containing only valid object types that can be related to the classification type on the selected relationship.

When the “Unlock Active Document” menu option is selected, the active document will be unlocked in PDM and the working file will be flagged as Modifiable=False. Any changes that are made to this document will be ignored and not saved to PDM. This is useful if a user wanted a copy of the document to include in a template assembly, but accidentally checked it out for modification.

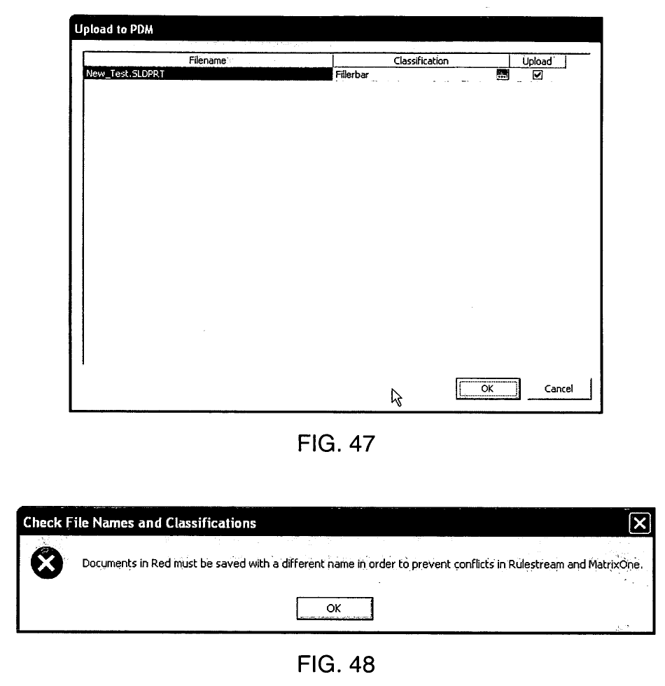

When the “Upload to PDM” menu option is selected, the user is presented with an upload window as shown in FIG. 47. This window shows the user all the documents contained in the active window, and also allows the user to define what the template document will represent (Part Classification) and whether the document contained in the SolidWorks session will updated or inserted into PDM. The upload window includes a “Files List” window that displays what files are contained in the SolidWorks active window along with the file classification and whether the document will be uploaded to PDM system, an “OK” button that allows the user to upload the documents to PDM as templates, and a “Cancel” button that allows the user to cancel the upload.

By clicking the ellipsis button in the “Classification” field, the user will access the “Classify Active Document” window for the document listed in that row. This allows the user to handle classification for an assembly template without opening each document into separate SolidWorks windows.

The upload window runs a number of validations prior to uploading the documents. The two primary checks are as follows. First, the upload determines if all documents have been classified. Second, each template must have a unique name in the PDM system. This unique name is based on the file name that the template has. If a user is attempting to upload a new template (not a modification) that has the same name as an existing template, the user will be presented with an error message such as the error message shown in FIG. 48. The user must rename this template prior to uploading the documents to PDM.

During modeling, instances of SolidWorks entities (e.g., parts and assemblies) are created from Rulestream templates. The user may want these instances mapped to individual part numbers, for example, for manufacturing a product. The user may therefore maintain part number documents in the PDM system. In order to map instances to part numbers, the Rulestream knowledge management system searches the PDM system for existing part numbers associated with each instance. If an existing part number is found for a particular instance, then the existing part number is used. If no existing part number is found for a particular instance, then a new part number is created, and the new part number is used.

This matching of instances to part numbers can be done on user-defined attributes. Specifically, a classification is typically defined for each part. There are usually many possible attributes for each classification, all of which are typically defined by the user. The Rulestream knowledge management application allows the user to “research” on different attributes so as to select what criteria are used to determine if there is an existing part for a particular component. A “match” is determined according to matches on the selected attributes only. Thus, even if other attributes are the same, a match will not occur if the selected attributes are different. The Rulestream knowledge management application also allows the user to research based on template (i.e., match only if parts created with same template) and also to research based on object relationships (i.e., match only if part has predetermined object relationships). For an example of this latter type of research, certain users require different levels of testing for a particular part, so even if two parts are parametrically identical, they may be treated differently if one has met one level of testing and another has met another level of testing. The Rulestream knowledge management application also created custom metadata properties for files, and the user can research on the metadata.

Certain aspects of the present invention can be demonstrated with reference to an example for modeling a table. For this example, the table is presumed to have four identical legs and a top. The Rulestream knowledge management system maintains a template for a table leg and a template for a table top in the PDM system, both of which are stored as template objects. When a model is being built, say, in SolidWorks, actual instances of the four table legs and the table top are created from the templates. Each of the four table leg instances is assigned a unique name, even though they are identical. The user may have part number for various types of table legs and table tops stored in the PDM system. The part number feature of the knowledge management system searches the PDM system for part numbers associated with the four table leg instances and the table top instance. If an existing part number is found for the particular type of table leg in the model, then the four table leg instances are mapped to that part number, with four units of that part number needed for the model. If there is no existing part number for the particular type of table leg in the model, then a new part number is created, and the four table leg instances are mapped to the new part number, with four units of the new part number needed for the model.

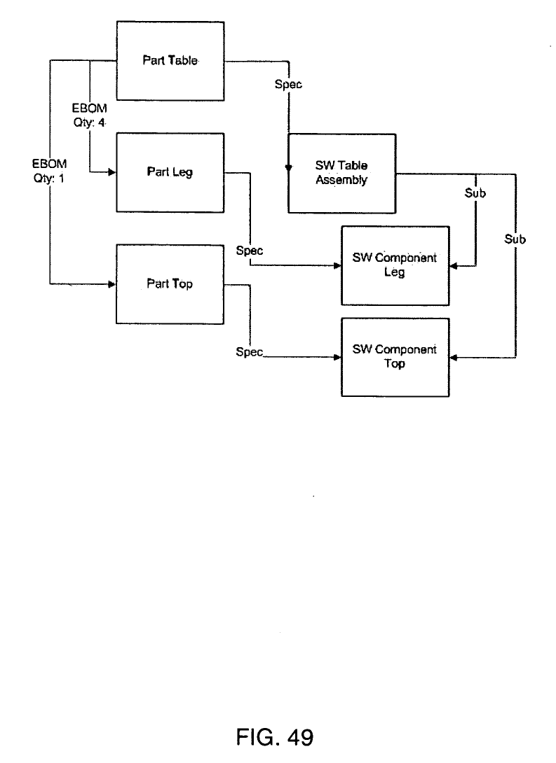

In order to perform the described modeling and part numbering functions, the Rulestream knowledge management system keeps track of relationships between SolidWorks documents, Rulestream templates, and part number documents. FIG. 49 shows the relationships between various documents in accordance with an embodiment of the present invention. SolidWorks leg component 4910 and top component 4912 have subcomponent relationships to the SolidWorks table assembly 4908. Instances of the table legs and table top are built from Rulestream templates. The user maintains a part number document for table tops (4906), a part number document for table legs (4904), and a part number document for who table assemblies (4902). There is a specification relationship between the part number documents 4902, 4904, 4906 and the respective SolidWorks documents 4908, 4910, 4912. There is also an EBOM (engineering bill of materials) relationship between the part number documents, which is typically not managed by the Rulestream knowledge management system.

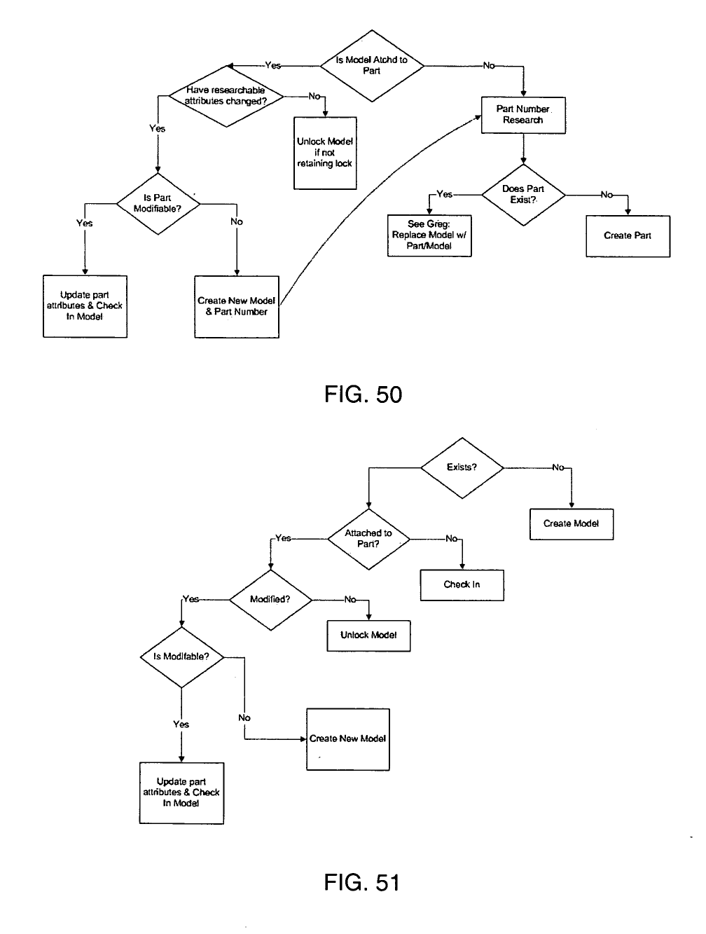

FIG. 50 is a logic flow diagram showing exemplary part numbering logic in accordance with an embodiment of the present invention. In order to obtain a part number for a particular part, the logic first determines whether there is a model attached to the part, in block 5002. If no model is attached to the part (NO in block 5002), then part number research is performed, in block 5014, and a determination is made as to whether or not the part exists, in block 5016. If the part exists (YES in block 5016), then the logic replaces the model with the part/model, in block 5018. If the part does not exist (NO in block 5016), then the part is created, in block 5020. If a model is attached to the part (YES in block 5002), then researchable attributes are checked, in block 5004, to determine whether or not the researchable attributes have changed. If the researchable attributes have not changed (NO in block 5004), then the logic unlocks the model (assuming there is no retaining lock on the model), in block 5006. If the researchable attributes have changed (YES in block 5004), then the logic determines whether or not the part is modifiable (based on settings associated with the part object), in block 5008. If the part is modifiable (YES in block 5008), then the logic updates the part attributes and checks in the model, in block 5010. If the part is not modifiable (NO in block 5008), then the logic creates a new model and part number, in block 5012), and proceeds to block 5014 as described above.

FIG. 51 is a logic flow diagram showing exemplary check-in logic in accordance with an embodiment of the present invention. In order to check in a model, a determination if first made as to whether or not the model exists, in block 5102. If the model does not exist (NO in block 5102), then the model is created, in block 5118. If the model exists (YES in block 5102), then the logic determines whether or not the model is attached to a part, in block 5104. If the model is not attached to the part (NO in block 5104), then the part is checked in, in block 5106. If the model is attached to the part (YES in block 5104), then the logic determines whether or not the part has been modified, in block 5108. If the part has not been modified (NO in block 5108), then the logic unlocks the model, in block 5110. If the part has been modified (YES in block 5108), then the logic determines whether or not the part is allowed to be modified, in block 5112. If the part is not modifiable (NO in block 5112), then the logic creates a new model with the part, in block 5116. If the part is modifiable (YES in block 5112), then the logic updates the part attributes and checks in the model, in block 5114.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the knowledge management system applications are implemented as a set of computer program instructions that are executed by a computer under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

### Appendix—Project rsDocMgr

Filename: rsDocMgr.vbp
Type: ActiveX Dll

BuildFilename: rsDocMgr55.dll

References:

| Name | Filename | Description | Type | Version |
|---|---|---|---|---|
| VBA | msvbvm60.dll | Visual Basic For Applications | TypeLib | 6.0 |
| VBRUN | msvbvm60.dll\3 | Visual Basic runtime objects | TypeLib | 6.0 |
| | | and procedures | | |
| VB | vb6.olb | Visual Basic objects and | TypeLib | 6.0 |
| | | procedures | | |
| stdole | stdole2.tlb | OLE Automation | TypeLib | 2.0 |
| Scripting | scrrun.dll | Microsoft Scripting Runtime | TypeLib | 1.0 |
| DSOleFile | dsofile.dll | DS: OLE Document Properties | TypeLib | 1.3 |
| | | 1.4 Object Library | | |
| MSComctlLib | mscomctl.ocx | Microsoft Windows Common | TypeLib | 2.0 |
| | | Controls 6.0 (SP6) | | |

Files:

| Name | Filename | Type |
|---|---|---|
| CustomProperties | CustomProperties.cls | Class |
| CustomProperty | CustomProperty.cls | Class |
| Document | Document.cls | Class |
| DocumentAccess | DocumentAccess.cls | Class |
| Documents | Documents.cls | Class |
| Error | clsError.cls | Class |
| Errors | clsErrors.cls | Class |
| FileSystemAccess | FileSystemAccess.cls | Class |
| LibraryFeature | LibraryFeature.cls | Class |
| LibraryFeatures | LibraryFeatures.cls | Class |
| Relation | Relation.cls | Class |
| Relations | Relations.cls | Class |
| modConstants | modConstants.bas | Module |
| modDocProps | modDocProps.bas | Module |
| modDocuments | modDocuments.bas | Module |
| modErrorHandling | modErrorHandling.bas | Module |
| frmBrowsePrompt | frmBrowsePrompt.frm | Form |

Class CustomProperties (CustomProperties.cls)
Comment:
Module: CustomProperties
DateTime: Jan. 13, 2004 09:18
Author: rcarek
Purpose: All custom properties on the file referenced in the “File” property of the document object are exposed via the “CustomProperties” property. The collection of “CustomProperty” objects is populated when the “File” property of a document object is set to a reference of a valid file object .
Count of declaration lines: 13
Count of lines: 105

Properties:

| Name | Value |
|---|---|
| DataBindingBehavior | 0 |
| DataSourceBehavior | 0 |
| Instancing | 2 |
| MTSTransactionMode | 0 |
| Name | CustomProperties |
| Persistable | 0 |

Procedures:

| Name | Scope | Type |
|---|---|---|
| Clear | Friend | Subroutine |
| Class_Initialize | Private | Subroutine |
| Class_Terminate | Private | Subroutine |
| Add | Public | Function |
| Count | Public | Property Get |
| Item | Public | Property Get |
| NewEnum | Public | Property Get |
| Remove | Public | Subroutine |

Procedure Clear
Type: Subroutine
Scope: Friend
Count of lines: 4
Declaration:
Friend Sub Clear( )
Parameters: None
Comment: None

Procedure Class_Initialize
Type: Subroutine
Scope: Private
Count of lines: 5
Declaration:
Private Sub Class_Initialize( )
Parameters: None
Comment:
creates the collection when this class is created

Procedure Class_Terminate
Type: Subroutine
Scope: Private
Count of lines: 5
Declaration:
Private Sub Class_Terminate( )
Parameters: None
Comment:
destroys collection when this class is terminated

Procedure Add
Type: Function
Scope: Public
Count of lines: 43
Declaration:
Public Function Add(PropertyName As String, PropertyValue As Variant, Optional sKey As String) As CustomProperty

Parameters:

| Name | Type | ByVal/ByRef | Optional (Default Value) |
|---|---|---|---|
| PropertyName | String | ByRef | No |
| PropertyValue | Variant | ByRef | No |
| sKey | String | ByRef | Yes ( ) |

Comment:
This method adds a “CustomProperty” object to the “CustomProperties” collection.
If a “CustomProperty” object with the same key exists in the collection when
Add is invoked, the exists object is replaced with the new instance.
Note: If key is left blank (empty string), the “PropertyName” parameter is used as the key in the collection.

Procedure Count
Type: Property Get
Scope: Public
Count of lines: 10
Declaration:
Public Property Get Count( ) As Long
Parameters: None
Comment:
The Count property is used when retrieving the number of elements in the collection.
Syntax: Debug.Print x.Count

Procedure Item
Type: Property Get
Scope: Public
Count of lines: 9
Declaration:
Public Property Get Item(vntIndexKey As Variant) As CustomProperty

Parameters:

| Name | Type | ByVal/ByRef | Optional (Default Value) |
|---|---|---|---|
| vntIndexKey | Variant | ByRef | No |

Comment:
The Item property is used when referencing an element in the collection vntIndexKey contains either the Index or Key to the collection, this is why it is declared as a Variant
Syntax: Set foo=x.Item(xyz) or Set foo=x.Item(5)

Procedure NewEnum
Type: Property Get
Scope: Public
Count of lines: 7
Declaration:
Public Property Get NewEnum( ) As IUnknown
Parameters: None
Comment:
The NewEnum property allows you to enumerate this collection with the For . . . Each syntax

Procedure Remove
Type: Subroutine
Scope: Public
Count of lines: 9
Declaration:
Public Sub Remove(vntIndexKey As Variant)

Parameters:

| Name | Type | ByVal/ByRef | Optional (Default Value) |
|---|---|---|---|
| vntIndexKey | Variant | ByRef | No |

Comment:
The Remove method is used when removing an element from the collection vntIndexKey contains either the Index or Key, which is why it is declared as a Variant.
Syntax: x.Remove(xyz)

Class CustomProperty (CustomProperty.cls)
Comment:
Module: CustomProperty
DateTime: Jan. 13, 2004 08:48
Author: rcarek
Purpose: The CustomProperty class object exists as a member of
CustomProperties
collection object. The custom properties are exposed as a property of the document object.
CustomProperty objects are read from the custom properties that exist on the file that is referenced in the “File” property of the document object.
Count of declaration lines: 15
Count of lines: 57

Properties:

| Name | Value |
|---|---|
| DataBindingBehavior | 0 |
| DataSourceBehavior | 0 |
| Instancing | 2 |
| MTSTransactionMode | 0 |
| Name | CustomProperty |
| Persistable | 0 |

Procedures:

| Name | Scope | Type |
|---|---|---|
| PropertyName | Public | Property Let |
| PropertyName | Public | Property Get |
| PropertyValue | Public | Property Let |
| PropertyValue | Public | Property Set |
| PropertyValue | Public | Property Get |

Procedure PropertyName
Type: Property Let
Scope: Public
Count of lines: 8
Declaration:
Public Property Let PropertyName(ByVal vData As String)

Parameters:

| Name | Type | ByVal/ByRef | Optional (Default Value) |
|---|---|---|---|
| vData | String | ByVal | No |

Comment:
This property represents the name of a custom property that exists on the file that is referenced in the “File” property of a document object.

Procedure PropertyName
Type: Property Get
Scope: Public
Count of lines: 6
Declaration:
Public Property Get PropertyName( ) As String
Parameters: None
Comment:
used when retrieving value of a property, on the right side of an assignment. Syntax: Debug.Print X.PropertyName

Procedure PropertyValue
Type: Property Let
Scope: Public
Count of lines: 9
Declaration:
Public Property Let PropertyValue(ByVal vData As Variant)

Parameters:

| Name | Type | ByVal/ByRef | Optional (Default Value) |
|---|---|---|---|
| vData | Variant | ByVal | No |

Comment:
This property represents the value of a custom property that exists on the file that is referenced in the “File” property of a document object.

Procedure PropertyValue
Type: Property Set
Scope: Public
Count of lines: 6
Declaration:
Public Property Set PropertyValue(ByVal vData As Variant)

Parameters:

| Name | Type | ByVal/ByRef | Optional (Default Value) |
|---|---|---|---|
| vData | Variant | ByVal | No |

Comment:
used when assigning an Object to the property, on the left side of a Set statement.
Syntax: Set x.PropertyValue=Form1

Procedure PropertyValue
Type: Property Get
Scope: Public
Count of lines: 10
Declaration:
Public Property Get PropertyValue( ) As Variant
Parameters: None
Comment:
used when retrieving value of a property, on the right side of an assignment.
Syntax: Debug.Print X.PropertyValue

Class Document (Document.cls)
Comment:
Module: Document
DateTime: Jan. 13, 2004 10:41
Author: rcarek
Purpose: The document object is used to abstract a reference to a file used within the context of Rulestream. Beyond exposing the physical file object, the document object exposes as properties several pieces of metadata written to the documents “File” as custom properties.
Some of this metadata is exposed via explicit properties on the document object. These properties use “reserved” custom property names on the file to hold this information. Any metadata not explicitly reserved by Rulestream ends up in the “CustomProperties” collection of “CustomProperty” objects that represent the custom property name/value pairs that exist on the file object.
Count of declaration lines: 58
Count of lines: 990

Properties:

| Name | Value |
|---|---|
| DataBindingBehavior | 0 |
| DataSourceBehavior | 0 |
| Instancing | 5 |
| MTSTransactionMode | 0 |
| Name | Document |
| Persistable | 0 |

Procedures:

| Name | Scope | Type |
|---|---|---|
| Class_Initialize | Private | Subroutine |
| Class_Terminate | Private | Subroutine |
| LoadCustomProperties | Private | Subroutine |
| AddCustomProperty | Public | Function |
| BaseDate | Public | Property Get |
| BaseDate | Public | Property Let |
| Children | Public | Property Set |
| Children | Public | Property Get |
| CustomProperties | Public | Property Set |
| CustomProperties | Public | Property Get |
| Deleted | Public | Property Let |
| Deleted | Public | Property Get |
| File | Public | Property Set |
| File | Public | Property Get |
| FileName | Public | Property Let |
| FileName | Public | Property Get |
| FileType | Public | Property Let |
| FileType | Public | Property Get |
| FromTemplate | Public | Property Get |
| FromTemplate | Public | Property Let |
| HasEmbeddedPart | Public | Property Get |
| HasEmbeddedPart | Public | Property Let |
| HasProjectInfo | Public | Property Get |
| HasProjectInfo | Public | Property Let |
| IsEmbeddedPart | Public | Property Get |
| IsEmbeddedPart | Public | Property Let |
| LibraryFeatures | Public | Property Get |
| ModelID | Public | Property Get |
| ModelID | Public | Property Let |
| ObjectID | Public | Property Let |
| ObjectID | Public | Property Get |
| Parents | Public | Property Set |
| Parents | Public | Property Get |
| PartFamily | Public | Property Get |
| PartFamily | Public | Property Let |
| PartFamilyID | Public | Property Get |
| PartFamilyID | Public | Property Let |
| PartNumber | Public | Property Let |
| PartNumber | Public | Property Get |
| PartNumberFileName | Public | Property Let |
| PartNumberFileName | Public | Property Get |
| PDMClass | Public | Property Get |
| PDMClass | Public | Property Let |
| PDMExists | Public | Property Get |
| PDMExists | Public | Property Let |
| PDMModifiable | Public | Property Get |
| PDMModifiable | Public | Property Let |
| PDMObject | Public | Property Set |
| PDMObject | Public | Property Get |
| PDMObjectID | Public | Property Get |
| PDMObjectID | Public | Property Let |
| PDMPartObjectID | Public | Property Get |
| PDMPartObjectID | Public | Property Let |
| PDMRevision | Public | Property Get |
| PDMRevision | Public | Property Let |
| PDMTemplateID | Public | Property Get |
| PDMTemplateID | Public | Property Let |
| PDMType | Public | Property Get |
| PDMType | Public | Property Let |
| ReferencePart | Public | Property Get |
| ReferencePart | Public | Property Let |
| RelateToPart | Public | Property Get |
| RelateToPart | Public | Property Let |
| SourceOptimalPartFile | Public | Property Let |
| SourceOptimalPartFile | Public | Property Get |
| StandardPart | Public | Property Let |
| StandardPart | Public | Property Get |
| TemplateFileName | Public | Property Get |
| TemplateFileName | Public | Property Let |
| UpdatedCustomProperties | Public | Property Get |

Procedure Class_Initialize
Type: Subroutine
Scope: Private
Count of lines: 7
Declaration:
Private Sub Class_Initialize( )
Parameters: None
Comment: None

Procedure Class_Terminate
Type: Subroutine
Scope: Private
Count of lines: 15
Declaration:
Private Sub Class_Terminate( )
Parameters: None
Comment:
Private subroutine

Procedure LoadCustomProperties
Type: Subroutine
Scope: Private
Count of lines: 159
Declaration:
Private Sub LoadCustomProperties( )
Parameters: None
Comment:
Private function
This is called internally to load custom properties from the file into the document object. This method is called when the file property of the document
is set to a valid file object.

Procedure AddCustomProperty
Type: Function
Scope: Public
Count of lines: 17
Declaration:
Public Function AddCustomProperty(ByVal strPropertyName As String, ByVal strPropertyValue As String) As Boolean

Parameters:

| Name | Type | ByVal/ByRef | Optional (Default Value) |
|---|---|---|---|
| strPropertyName | String | ByVal | No |
| strPropertyValue | String | ByVal | No |

Comment:
This public method allows a user to write a custom property to a file and add it to the custom properties
collection.
Reserved custom properties should not be referenced for updates via this API call.

Procedure BaseDate
Type: Property Get
Scope: Public
Count of lines: 12
Declaration:
Public Property Get BaseDate( ) As String
Parameters: None
Comment:
The “BaseDate” property exposes the date the file referenced was updated prior to being absorbed by Rulestream.
This property gets its initial value from the “RSBaseDate” custom property written to the file. This allows the user to compare the “BaseDate” property to the “Date Modified” on the file to determine if the file as benn updated/saved since the file was pulled from PDM/PLM.

Procedure BaseDate
Type: Property Let
Scope: Public
Count of lines: 6
Declaration:
Public Property Let BaseDate(ByVal strBaseDate As String)

Parameters:

| Name | Type | ByVal/ByRef | Optional (Default Value) |
|---|---|---|---|
| strBaseDate | String | ByVal | No |

Comment: None

Procedure Children
Type: Property Set
Scope: Public
Count of lines: 16
Declaration:
Public Property Set Children(ByVal vData As Relations)

Parameters:

| Name | Type | ByVal/ByRef | Optional (Default Value) |
|---|---|---|---|
| vData | Relations | ByVal | No |

Comment:
This property represents a collection of relation objects (keys to other document objects in the documents collection) exist as children to the document object in a hierarchial structure.
This allows for the collection of documents to exist as a flat structure with parent/child pointers to other documents.

Procedure Children
Type: Property Get
Scope: Public
Count of lines: 13
Declaration: Public Property Get Children( ) As Relations
Parameters: None
Comment: None

Procedure CustomProperties
Type: Property Set
Scope: Public
Count of lines: 17
Declaration:
Public Property Set CustomProperties(ByVal vData As CustomProperties)

Parameters:

| Name | Type | ByVal/ByRef | Optional (Default Value) |
|---|---|---|---|
| vData | CustomProperties | ByVal | No |

Comment:
This property represents a collection of custom properties (as name/value pair objects) that exist on the documents file object. This collection only contains those custom properties that are not reserved and used specifically by Rulestream.
This property is initially set when the documents “File” property is set to a valid file reference.

Procedure CustomProperties
Type: Property Get
Scope: Public
Count of lines: 13
Declaration:
Public Property Get CustomProperties( ) As CustomProperties
Parameters: None
Comment: None

Procedure Deleted
Type: Property Let
Scope: Public
Count of lines: 11
Declaration:
Public Property Let Deleted(ByVal vData As Boolean)

Parameters:

| Name | Type | ByVal/ByRef | Optional (Default Value) |
|---|---|---|---|
| vData | Boolean | ByVal | No |

Comment:
Procedure Deleted
Type: Property Get
Scope: Public
Count of lines: 9
Declaration:
Public Property Get Deleted( ) As Boolean
Parameters: None
Comment: None

Procedure File
Type: Property Set
Scope: Public
Count of lines: 26
Declaration:
Public Property Set File(ByVal vData As Scripting.File)

Parameters:

| Name | Type | ByVal/ByRef | Optional (Default Value) |
|---|---|---|---|
| vData | Scripting.File | ByVal | No |

Comment:
This property exposes the file that the document object represents. Setting this property to a valid file object will pre-load many of the document object properties with values based on the files custom property meta data.

Procedure File
Type: Property Get
Scope: Public
Count of lines: 11
Declaration:
Public Property Get File( ) As Scripting.File
Parameters: None
Comment: None

Procedure FileName
Type: Property Let
Scope: Public
Count of lines: 15
Declaration:
Public Property Let FileName(ByVal vData As String)

Parameters:

| Name | Type | ByVal/ByRef | Optional (Default Value) |
|---|---|---|---|
| vData | String | ByVal | No |

Comment:
This property represents the file name of the file represented in the “File” property.
This property is initially set when the documents “File” property is set to a valid file reference.

Procedure FileName
Type: Property Get
Scope: Public
Count of lines: 11
Declaration:
Public Property Get FileName( ) As String
Parameters: None
Comment: None

Procedure FileType
Type: Property Let
Scope: Public
Count of lines: 17
Declaration:
Public Property Let FileType(ByVal vData As String)

Parameters:

| Name | Type | ByVal/ByRef | Optional (Default Value) |
|---|---|---|---|
| vData | String | ByVal | No |

Comment:
This property exposes the documents file extension
This property is initially set when the documents “File” property is set to a valid file reference.
I.E. For a document with a file of type SolidWorks part file, named “Part.SLDPRT” this property would be “SLDPRT”

Procedure FileType
Type: Property Get
Scope: Public
Count of lines: 11
Declaration:
Public Property Get FileType( ) As String
Parameters: None
Comment: None

Procedure FromTemplate
Type: Property Get
Scope: Public
Count of lines: 20
Declaration:
Public Property Get FromTemplate( ) As Boolean
Parameters: None
Comment:
The “FromTemplate” property states whether the file has been broken from the original template or not.
This property is initially set to True when a template is demanded via the “GetMasterDocument” method of the DocumentAccess class.
This property gets its initial value from the “RSFromTemplate” custom property written to the file.
This custom property is created and set by Rulestream during runtime.
Note:
Any custom implementation of “GetMasterDocument” must create the custom property “RSFromTemplate” with a value=“TRUE” initially.
This property will change based on actions within the run-time environment. Should the rules change this template (via inserting a library feature or punching a hole in the geometry, etc.) The SolidWorks Manager will change the value of the custom property “RSFromTemplate” on the file to False.

Procedure FromTemplate
Type: Property Let
Scope: Public
Count of lines: 6
Declaration:
Public Property Let FromTemplate(ByVal blnFromTemplate As Boolean)

Parameters:

| Name | Type | ByVal/ByRef | Optional (Default Value) |
|---|---|---|---|
| blnFromTemplate | Boolean | ByVal | No |

Comment: None

Procedure HasEmbeddedPart
Type: Property Get
Scope: Public
Count of lines: 11
Declaration:
Public Property Get HasEmbeddedPart( ) As Boolean
Parameters: None
Comment:
This property represents whether the current document is the parent of an embedded part (a SolidWorks part file who is the parent of a SolidWorks Part file).
This property is set internally and should not be relied upon via external calls for valid information.

Procedure HasEmbeddedPart
Type: Property Let
Scope: Public
Count of lines: 6
Declaration:
Public Property Let HasEmbeddedPart(ByVal blnHasEmbeddedPart As Boolean)

Parameters:

| | | | Optional |
|---|---|---|---|
| Name | Type | ByVal/ByRef | (Default Value) |
| blnHasEmbeddedPart | Boolean | ByVal | No |

Comment: None

Procedure HasProjectInfo
Type: Property Get
Scope: Public
Count of lines: 13
Declaration:
Public Property Get HasProjectInfo( ) As Boolean
Parameters: None
Comment:
The HasProjectInfo property states whether there is data in the custom properties collection that contains “Project Info”.
“Project Info” shoul be defined as information pertaining to where an object should be inserted into a PDM/PLM system. In the case of SmarTeam, this would be the project/folder/etc. that the top level document is linked to.
This property gets set to True if a custom property written to the file begins with “RS_”.
This custom property is created and set by Rulestream during runtime.

Procedure HasProjectInfo
Type: Property Let
Scope: Public
Count of lines: 3
Declaration:
Public Property Let HasProjectInfo(ByVal newValue As Boolean)

Parameters:

| Name | Type | ByVal/ByRef | Optional (Default Value) |
|---|---|---|---|
| newValue | Boolean | ByVal | No |

Comment: None

Procedure IsEmbeddedPart
Type: Property Get
Scope: Public
Count of lines: 10
Declaration:
Public Property Get IsEmbeddedPart( ) As Boolean
Parameters: None
Comment:
This property represents whether the current document represents an embedded part (a SolidWorks part file who's parent is a SolidWorks Part file, not Assembly file).
This property is set internally and should not be relied upon via external calls for valid information.

Procedure IsEmbeddedPart
Type: Property Let
Scope: Public
Count of lines: 6
Declaration:
Public Property Let IsEmbeddedPart(ByVal blnEmbeddedPart As Boolean)

Parameters:

| Name | Type | ByVal/ByRef | Optional (Default Value) |
|---|---|---|---|
| blnEmbeddedPart | Boolean | ByVal | No |

Comment: None
Procedure LibraryFeatures
Type: Property Get
Scope: Public
Count of lines: 19
Declaration:
Public Property Get LibraryFeatures( ) As LibraryFeatures
Parameters: None
Comment:
This property represents a collection of library feature objects that have been absorbed into the document objects file.
This property is initially set when the documents “File” property is set to a valid file reference.
During runtime, when a Solidworks Library Feature is inserted into a part instance, a custom property is written to the SolidWorks Part file. When a library feature is removed from a SolidWorks part file, the corresponding custom property is deleted from the file.
This custom property always begins with “RSLibFeature” and has a value of the file name of the library feature file. When the “File” property is set on the document object, each of these custom properties is translated into a LibraryFeature object and inserted into the collection.

Procedure ModelID
Type: Property Get
Scope: Public
Count of lines: 19
Declaration:
Public Property Get ModelID( ) As String
Parameters: None
Comment:
The “ModelID” property exposes the globally unique model id used to retrieve this document
This property gets its initial value from the “RSModelID” custom property written to the file.
This property is receives its value in different manners depending on the File Access Method.

For “FileSystem” file access method, Rulestream assigns this value at runtime.

For “Matrix” file access method, this ID is assigned via an object generator and becomes the name of the object when the instance is created i.e. If the ID assigned is A-001, then when an object of type “Component” is created, it's name will be A-001
For “SmarTeam” file access method, this ID is assigned via a sequence generator and populates an attribute “RS_MODEL_ID” on a link between the RS Template object and the object instance created of the template
Note:
Any custom implementation of “GetMasterDocument” must create the custom property “RSModelID”.

Procedure ModelID
Type: Property Let
Scope: Public
Count of lines: 6
Declaration:
Public Property Let ModelID(ByVal sstrModelID As String)

Parameters:

| Name | Type | ByVal/ByRef | Optional (Default Value) |
|---|---|---|---|
| sstrModelID | String | ByVal | No |

Comment: None

Procedure ObjectID
Type: Property Let
Scope: Public
Count of lines: 16
Declaration:
Public Property Let ObjectID(ByVal vData As String)

Parameters:

| Name | Type | ByVal/ByRef | Optional (Default Value) |
|---|---|---|---|
| vData | String | ByVal | No |

Comment:
This property exposes the Rulestream internal object id that the document represents.
This property is initially set when the documents “File” property is set to a valid file reference.
This property gets its initial value from the “RSObjID” custom property written to the file.

Procedure ObjectID
Type: Property Get
Scope: Public
Count of lines: 11
Declaration:
Public Property Get ObjectID( ) As String
Parameters: None
Comment: None

Procedure Parents
Type: Property Set
Scope: Public
Count of lines: 17
Declaration:
Public Property Set Parents(ByVal vData As Relations)

Parameters:

| Name | Type | ByVal/ByRef | Optional (Default Value) |
|---|---|---|---|
| vData | Relations | ByVal | No |

Comment:
This property represents a collection of relation objects (keys to other document objects in the documents collection) exist as parents to the document object in a hierarchial structure.
This allows for the collection of documents to exist as a flat structure with parent/child pointers to other documents.

Procedure Parents
Type: Property Get
Scope: Public
Count of lines: 12
Declaration:
Public Property Get Parents( ) As Relations
Parameters: None
Comment: None

Procedure Part Family
Type: Property Get
Scope: Public
Count of lines: 9
Declaration:
Public Property Get Part Family( ) As String
Parameters: None
Comment:
The Part Family property exposes the name of the Rulestream Part Family that the document objects file represents.
This property gets its initial value from the “RSPartFamily” custom property written to the file.
This custom property is created and set by Rulestream during runtime.

Procedure Part Family
Type: Property Let
Scope: Public
Count of lines: 4
Declaration:
Public Property Let Part Family(ByVal newValue As String)

Parameters:

| Name | Type | ByVal/ByRef | Optional (Default Value) |
|---|---|---|---|
| newValue | String | ByVal | No |

Comment: None

Procedure Part FamilyID
Type: Property Get
Scope: Public
Count of lines: 9
Declaration:
Public Property Get Part FamilyID( ) As Long
Parameters: None
Comment:
The Part FamilyID property exposes the name of the Rulestream Part Family ID (internal number) that the document objects file represents.
This property gets its initial value from the “RSPartFamilyID” custom property written to the file.
This custom property is created and set by Rulestream during runtime.

Procedure Part FamilyID
Type: Property Let
Scope: Public
Count of lines: 4
Declaration:
Public Property Let Part FamilyID(ByVal newValue As Long)

Parameters:

| Name | Type | ByVal/ByRef | Optional (Default Value) |
|---|---|---|---|
| newValue | Long | ByVal | No |

Comment: None

Procedure Part Number
Type: Property Let
Scope: Public
Count of lines: 16
Declaration:
Public Property Let Part Number(ByVal vData As String)

Parameters:

| Name | Type | ByVal/ByRef | Optional (Default Value) |
|---|---|---|---|
| vData | String | ByVal | No |

Comment:
This property exposes the PDM Part Number the document is related to.
This property is initially set when the documents “File” property is set to a valid file reference.
This property gets its initial value from the “RSPartNumber” custom property written to the file.

Procedure Part Number
Type: Property Get
Scope: Public
Count of lines: 11
Declaration:
Public Property Get Part Number( ) As String
Parameters: None
Comment: None

Procedure Part NumberFileName
Type: Property Let
Scope: Public
Count of lines: 12
Declaration:
Public Property Let Part NumberFileName(ByVal vData As String)

Parameters:

| Name | Type | ByVal/ByRef | Optional (Default Value) |
|---|---|---|---|
| vData | String | ByVal | No |

Comment:

Procedure Part NumberFileName
Type: Property Get
Scope: Public
Count of lines: 11
Declaration:
Public Property Get Part NumberFileName( ) As String
Parameters: None
Comment: None

Procedure PDMClass
Type: Property Get
Scope: Public
Count of lines: 14
Declaration:
Public Property Get PDMClass( ) As String
Parameters: None
Comment:
This property exposes the name of the “Part” type this document is to represent in PLM.
This property is initially set when the documents “File” property is set to a valid file reference.
This property gets its initial value from the “RSPDMClass” custom property written to the file.
The custom property is written via the rsSWPDM SolidWorks add-in used for classifying template documents.
This property is only valid via the Matrix integration.

Procedure PDMClass
Type: Property Let
Scope: Public
Count of lines: 6
Declaration:
Public Property Let PDMClass(ByVal strPDMClass As String)

Parameters:

| Name | Type | ByVal/ByRef | Optional (Default Value) |
|---|---|---|---|
| strPDMClass | String | ByVal | No |

Comment: None

Procedure PDMExists
Type: Property Get
Scope: Public
Count of lines: 19
Declaration:
Public Property Get PDMExists( ) As Boolean
Parameters: None
Comment:
The PDMExists property states whether the file has been associated with an object in the PDM/PLM system.
This property is initially set to FALSE when a template is demanded via the “GetMasterDocument” method of the DocumentAccess class.
This property gets its initial value from the “RSPDMExists” custom property written to the file.
This custom property is created and set by Rulestream during runtime.
Note:
Any custom implementation of “GetMasterDocument” must create the custom property “RSPDMExists” with a value=“FALSE” initially.
Any custom implementation of “GetDocumentByID” must create the custom property “RSPDMExists” with a value=“TRUE”.
This property will always return False if the file access method is “File System”

Procedure PDMExists
Type: Property Let
Scope: Public
Count of lines: 6
Declaration:
Public Property Let PDMExists(ByVal blnValue As Boolean)

Parameters:

| Name | Type | ByVal/ByRef | Optional (Default Value) |
|---|---|---|---|
| blnValue | Boolean | ByVal | No |

Comment: None

Procedure PDMModifiable
Type: Property Get
Scope: Public
Count of lines: 19
Declaration:
Public Property Get PDMModifiable( ) As Boolean
Parameters: None
Comment:
The PDMModifiable property states whether the file has been successfully locked for modification from a PDM/PLM system.
This property is initially set to True when a template is demanded via the “GetMasterDocument” method of the DocumentAccess class.
This property gets its initial value from the “RSPDMModifiable” custom property written to the file.
This custom property is created and set by Rulestream during runtime.
Note:
Any custom implementation of “GetMasterDocument” must create the custom property “RSPDMModifiable” with a value=“TRUE” initially.
Any custom implementation of “GetDocumentByID” must create the custom property “RSPDMModifiable” with a value of “TRUE” or “FALSE” depending on whether the document could be locked for modification successfully.
This property will always return True if the file access method is “File System”

Procedure PDMModifiable
Type: Property Let
Scope: Public
Count of lines: 6
Declaration:
Public Property Let PDMModifiable(ByVal blnValue As Boolean)

Parameters:

| Name | Type | ByVal/ByRef | Optional (Default Value) |
|---|---|---|---|
| blnValue | Boolean | ByVal | No |

Comment: None

Procedure PDMObject
Type: Property Set
Scope: Public
Count of lines: 6
Declaration:
Public Property Set PDMObject(ByVal newObject As Object)

Parameters:

| Name | Type | ByVal/ByRef | Optional (Default Value) |
|---|---|---|---|
| newObject | Object | ByVal | No |

Comment:
This property can be used to store an instance of a COM compatible object that from a PDM system that the document object represents.

Procedure PDMObject
Type: Property Get
Scope: Public
Count of lines: 4
Declaration:
Public Property Get PDMObject( ) As Object
Parameters: None
Comment: None

Procedure PDMObjectID
Type: Property Get
Scope: Public
Count of lines: 9
Declaration:
Public Property Get PDMObjectID( ) As String
Parameters: None
Comment:
The PDMObjectID property exposes the unique ID for the PDM object to which the file is attached.
In Matrix, this would be equal to some number in the format of
This property gets its initial value from the “RSPDM_ID” custom property written to the file.
This custom property is created and set by Rulestream during runtime.

Procedure PDMObjectID
Type: Property Let
Scope: Public
Count of lines: 4
Declaration:
Public Property Let PDMObjectID(ByVal newValue As String)

Parameters:

| Name | Type | ByVal/ByRef | Optional (Default Value) |
|---|---|---|---|
| newValue | String | ByVal | No |

Comment: None

Procedure PDMPartObjectID
Type: Property Get
Scope: Public
Count of lines: 11
Declaration:
Public Property Get PDMPartObjectID( ) As String
Parameters: None
Comment:
This property represents the unique object id of the Part obejct this document is related to.
This property is initially set when the documents “File” property is set to a valid file reference.
This property gets its initial value from the “RSPartObjectID” custom property written to the file.

Procedure PDMPartObjectID
Type: Property Let
Scope: Public
Count of lines: 6
Declaration:
Public Property Let PDMPartObjectID(ByVal sPDMPartObjectID As String)

Parameters:

| Name | Type | ByVal/ByRef | Optional (Default Value) |
|---|---|---|---|
| sPDMPartObjectID | String | ByVal | No |

Comment: None

Procedure PDMRevision
Type: Property Get
Scope: Public
Count of lines: 9
Declaration:
Public Property Get PDMRevision( ) As String
Parameters: None
Comment:
The PDMRevision property exposes the current revision of the PDM object that the file was checked out of.
In Matrix, this would be equal to some number in the format of 1111.1111.1111.1111
This property gets its initial value from the “RSPDM_ID” custom property written to the file.
This custom property is created and set by Rulestream during runtime.

Procedure PDMRevision
Type: Property Let
Scope: Public
Count of lines: 4
Declaration:
Public Property Let PDMRevision(ByVal newValue As String)

Parameters:

| Name | Type | ByVal/ByRef | Optional (Default Value) |
|---|---|---|---|
| newValue | String | ByVal | No |

Comment: None

Procedure PDMTemplateID
Type: Property Get
Scope: Public
Count of lines: 13
Declaration:
Public Property Get PDMTemplateID( ) As String
Parameters: None
Comment:
This property represents the PDM Model ID of the template object from which this instance was created.
This property initially gets populated when the “File” property is set and the custom properties are read. This document property is related to the custom property on the file called: RSTemplateID

Procedure PDMTemplateID
Type: Property Let
Scope: Public
Count of lines: 6
Declaration:
Public Property Let PDMTemplateID(ByVal strPDMTemplateID As String)

Parameters:

| Name | Type | ByVal/ByRef | Optional (Default Value) |
|---|---|---|---|
| strPDMTemplateID | String | ByVal | No |

Comment: None

Procedure PDMType
Type: Property Get
Scope: Public
Count of lines: 20
Declaration:
Public Property Get PDMType( ) As String
Parameters: None
Comment:
The “PDMType” property exposes the “type” of object created.
This property gets its initial value from the “RSPDMType” custom property written to the file. This properties value will be “ ” until the template object is saved for the first time in the PDM/PLM system.
For “FileSystem” file access method, this value is “ ” as the property is not referenced.
For “Matrix” and “SmarTeam” file access method, the value is the class type i.e. If the ID assigned is A-001, then when an object of type “Component” is created, it's name will be A-001
For “SmarTeam” file access method, this ID is assigned via a sequence generator and populates an attribute “RS_MODEL_ID” on a link between the RS Template object and the object instance created of the template
Note:
Any custom implementation of “GetDocumentByID” must create the custom property “RSPDMType” and populate it with the class type of the object.

Procedure PDMType
Type: Property Let
Scope: Public
Count of lines: 6
Declaration:
Public Property Let PDMType(ByVal strPDMType As String)

Parameters:

| Name | Type | ByVal/ByRef | Optional (Default Value) |
|---|---|---|---|
| strPDMType | String | ByVal | No |

Comment: None

Procedure ReferencePart
Type: Property Get
Scope: Public
Count of lines: 13
Declaration:
Public Property Get ReferencePart( ) As Boolean
Parameters: None
Comment:
This property represents whether the file associated is being used in the model as reference.
This means that the file is not part of the model, simply used for mating/sizing/testing purposes.
This property is initially set when the documents “File” property is set to a valid file reference.
This property gets its initial value from the “RSReference” custom property written to the file.

Procedure ReferencePart
Type: Property Let
Scope: Public
Count of lines: 6
Declaration:
Public Property Let ReferencePart(ByVal blnReferencePart As Boolean)

Parameters:

| Name | Type | ByVal/ByRef | Optional (Default Value) |
|---|---|---|---|
| blnReferencePart | Boolean | ByVal | No |

Comment: None

Procedure RelateToPart
Type: Property Get
Scope: Public
Count of lines: 14
Declaration:
Public Property Get RelateToPart( ) As Boolean
Parameters: None
Comment:
This property determines whether the template document shoul dever be related to a Part object in PLM.
This property is initially set when the documents “File” property is set to a valid file reference.
This property gets its initial value from the “RSPDMRelateToPart” custom property written to the file.
The custom property is written via the rsSWPDM SolidWorks add-in used for classifying template documents.
This property is only valid via the Matrix integration.

Procedure RelateToPart
Type: Property Let
Scope: Public
Count of lines: 6
Declaration:
Public Property Let RelateToPart(ByVal blnRelateToPart As Boolean)

Parameters:

| Name | Type | ByVal/ByRef | Optional (Default Value) |
|---|---|---|---|
| blnRelateToPart | Boolean | ByVal | No |

Comment: None

Procedure SourceOptimalPartFile
Type: Property Let
Scope: Public
Count of lines: 17
Declaration:
Public Property Let SourceOptimalPartFile(ByVal vData As String)

Parameters:

| Name | Type | ByVal/ByRef | Optional (Default Value) |
|---|---|---|---|
| vData | String | ByVal | No |

Comment:
This property exposes the original template file name the document (CAD File) was derived from.
This property is initially set when the documents “File” property is set to a valid file reference.
This property gets its initial value from the “RSSourceOPF” custom property written to the file.

Procedure SourceOptimalPartFile
Type: Property Get
Scope: Public
Count of lines: 11
Declaration:
Public Property Get SourceOptimalPartFile( ) As String
Parameters: None
Comment: None

Procedure StandardPart
Type: Property Let
Scope: Public
Count of lines: 15
Declaration:
Public Property Let StandardPart(ByVal vData As Boolean)

Parameters:

| Name | Type | ByVal/ByRef | Optional (Default Value) |
|---|---|---|---|
| vData | Boolean | ByVal | No |

Comment:
This property shows whether or not the document represents a standard part (non-driveable)
This property is initially set when the documents “File” property is set to a valid file reference.
This property gets its initial value from the “RSStandard” custom property written to the file.

Procedure StandardPart
Type: Property Get
Scope: Public
Count of lines: 11
Declaration:
Public Property Get StandardPart( ) As Boolean
Parameters: None
Comment: None

Procedure TemplateFileName
Type: Property Get
Scope: Public
Count of lines: 12
Declaration:
Public Property Get TemplateFileName( ) As String
Parameters: None
Comment:
This property exposes the original template file name the document (CAD File) was derived from.
This property is initially set when the documents “File” property is set to a valid file reference.
This property gets its initial value from the “RSTemplateName” custom property written to the file.

Procedure TemplateFileName
Type: Property Let
Scope: Public
Count of lines: 6
Declaration:
Public Property Let TemplateFileName(ByVal sTemplateFileName As String)

Parameters:

| Name | Type | ByVal/ByRef | Optional (Default Value) |
|---|---|---|---|
| sTemplateFileName | String | ByVal | No |

Comment: None

Procedure UpdatedCustomProperties
Type: Property Get
Scope: Public
Count of lines: 16
Declaration:
Public Property Get UpdatedCustomProperties( ) As CustomProperties
Parameters: None
Comment:
This property represents a collection of custom properties (as name/value pair objects) that must be updated on the documents file object.
During runtime, if SolidWorks has an open handle on the document objects file, DocumentAccess can not update values on custom properties that may need to be updated. So, a custom property object is added to this collection. Rulestream runtime then loops through these custom properties at specific coded points and uses the SW API to update the custom property values on the file object.

Class DocumentAccess (DocumentAccess.cls)
Comment: None
Count of declaration lines: 51
Count of lines: 1771

Properties:

| Name | Value |
|---|---|
| DataBindingBehavior | 0 |
| DataSourceBehavior | 0 |
| Instancing | 5 |
| MTSTransactionMode | 0 |
| Name | DocumentAccess |
| Persistable | 0 |

Procedures:

| Name | Scope | Type |
|---|---|---|
| CurrentFolder | Friend | Property Set |
| Class_Initialize | Private | Subroutine |
| Class_Terminate | Private | Subroutine |
| GetFolderName | Private | Function |
| IsClassInitialized | Private | Function |
| AccessMethod | Public | Property Get |
| ApplicationFolder | Public | Property Get |
| BrowseForDocument | Public | Function |
| BrowseForDocumentWithPrompt | Public | Function |
| BrowseForPDMProject | Public | Function |
| CheckInDocuments | Public | Function |
| CopyDocumentTypesLocally | Public | Function |
| CreatePDMStructure | Public | Function |
| CurrentDocument | Public | Property Get |
| CurrentDocument | Public | Property Set |
| CurrentFolder | Public | Property Get |
| CustomAppsFolder | Public | Property Get |
| Deconstruct | Public | Subroutine |
| DeleteDocument | Public | Function |
| DeleteDocumentByName | Public | Function |
| DeleteDocumentFromPath | Public | Function |
| DeleteMasterDocument | Public | Function |
| DocumentExists | Public | Function |
| Documents | Public | Property Get |
| Errors | Public | Property Get |
| ExecutePassThruMQL | Public | Function |
| GetDocument | Public | Function |
| GetDocumentByID | Public | Function |
| GetFolder | Public | Function |
| GetMasterDocument | Public | Function |
| GetMasterDocumentFolder | Public | Function |
| GetReleaseDocument | Public | Function |
| GetReleaseFolder | Public | Function |
| Initialize | Public | Function |
| InitializeModel | Public | Function |
| InstallFolder | Public | Property Get |
| IsDocumentCheckedOut | Public | Function |
| LocalDocumentsFolder | Public | Property Get |
| LogFolder | Public | Property Get |
| MasterDocumentsFolder | Public | Property Get |
| MasterDocumentsFolder | Public | Property Let |
| MasterFolderObject | Public | Property Get |
| mxGetPartByPartNumber | Public | Function |
| PartNumberResearch | Public | Property Let |
| PDMDocumentClasses | Public | Property Get |
| PDMDocumentsFolder | Public | Property Get |
| PDMFileTypes | Public | Property Get |
| PDMReleasesProject | Public | Property Get |
| PDMRequiredFields | Public | Property Get |
| PDMRootProject | Public | Property Get |
| PNResearch | Public | Function |
| ProfileName | Public | Property Get |
| ReleaseFolderObject | Public | Property Get |
| ReleaseID | Public | Property Get |
| ReleaseID | Public | Property Let |
| ReleasesFolder | Public | Property Get |
| ReleasesFolder | Public | Property Let |
| ReturnDataFromPDMLookup | Public | Function |
| ReturnPDMLookupTables | Public | Function |
| RulestreamLineItem | Public | Property Get |
| RulestreamLineItem | Public | Property Let |
| RulestreamProject | Public | Property Get |
| RulestreamProject | Public | Property Let |
| SaveAllDocumentsFromPath | Public | Function |
| SaveDocument | Public | Function |
| SaveDocumentFromPath | Public | Function |
| SaveDocuments | Public | Function |
| SaveMasterDocument | Public | Function |
| SaveMasterDocuments | Public | Function |
| SaveReleaseDocument | Public | Function |
| SaveReleaseDocuments | Public | Function |
| TemporaryFolder | Public | Property Get |
| TerminateModel | Public | Subroutine |
| WorkingFolder | Public | Property Get |

Procedure CurrentFolder
Type: Property Set
Scope: Friend
Count of lines: 4
Declaration:
Friend Property Set CurrentFolder(ByVal newValue As Scripting.Folder)

Parameters:

| Name | Type | ByVal/ByRef | Optional (Default Value) |
|---|---|---|---|
| newValue | Scripting.Folder | ByVal | No |

Comment: None

Procedure Class_Initialize
Type: Subroutine
Scope: Private
Count of lines: 6
Declaration:
Private Sub Class_Initialize( )
Parameters: None
Comment: None

Procedure Class_Terminate
Type: Subroutine
Scope: Private
Count of lines: 15
Declaration:
Private Sub Class_Terminate( )
Parameters: None
Comment:
Private sub

Procedure GetFolderName
Type: Function
Scope: Private
Count of lines: 70
Declaration:
Private Function GetFolderName(ByVal enuFolderType As RuleStreamFolder) As String

Parameters:

| | | | Optional |
|---|---|---|---|
| Name | Type | ByVal/ByRef | (Default Value) |
| enuFolderType | RuleStreamFolder | ByVal | No |

Comment:
Private Function

Procedure IsClassInitialized
Type: Function
Scope: Private
Count of lines: 10
Declaration:
Private Function IsClassInitialized( ) As Boolean
Parameters: None
Comment:
Private Function
Check if I am initialized

Procedure AccessMethod
Type: Property Get
Scope: Public
Count of lines: 8
Declaration:
Public Property Get AccessMethod( ) As FileAccessMethod
Parameters: None
Comment:
This property returns the enumeration (long) respresenting which file access method is currently being employeed.

Procedure ApplicationFolder
Type: Property Get
Scope: Public
Count of lines: 6
Declaration:
Public Property Get ApplicationFolder( ) As String
Parameters: None
Comment:
The ApplicationFolder property
This property represents the installation location of the runtime executable

Procedure BrowseForDocument
Type: Function
Scope: Public
Count of lines: 25
Declaration:
Public Function BrowseForDocument(ByVal FileAccessMethod As FileAccessMethod, Optional ByVal hwndOwner As Long, Optional ByVal strFilter As String, Optional ByVal FilterIndex As Long=1) As String

Parameters:

| | | ByVal/ | Optional | |
|---|---|---|---|---|
| Name | Type | ByRef | (Default Value) | |
| FileAccessMethod | FileAccessMethod | ByVal | No | |
| hwndOwner | Long | ByVal | Yes | ( ) |
| strFilter | String | ByVal | Yes | ( ) |
| FilterIndex | Long | ByVal | Yes | (1) |

Comment: None

Procedure BrowseForDocumentWithPrompt
Type: Function
Scope: Public
Count of lines: 21
Declaration:
Public Function BrowseForDocumentWithPrompt(Optional ByVal hwndOwner As Long, Optional ByVal strFilter As String, Optional ByVal FilterIndex As Long=1) As String

Parameters:

| Name | Type | ByVal/ByRef | Optional (Default Value) |
|---|---|---|---|
| hwndOwner | Long | ByVal | Yes ( ) |
| strFilter | String | ByVal | Yes ( ) |
| FilterIndex | Long | ByVal | Yes (1) |

Comment:
xxx—this needs to change for matrix—never go to file system if using matrix

Procedure BrowseForPDMProject
Type: Function
Scope: Public
Count of lines: 17
Declaration:
Public Function BrowseForPDMProject( ) As String
Parameters: None
Comment: None

Procedure CheckInDocuments
Type: Function
Scope: Public
Count of lines: 34
Declaration:
Public Function CheckInDocuments(ByVal objDocuments As Documents, Optional ByVal blnSave As Boolean=True) As Boolean

Parameters:

| Name | Type | ByVal/ByRef | Optional (Default Value) | |
|---|---|---|---|---|
| objDocuments | Documents | ByVal | No | |
| blnSave | Boolean | ByVal | Yes | (True) |

Comment:
This function checks documents into a PDM system at the end of a Rulestream session. The documents that are checked in will be removed from the local hard drive.
This function is not supported by the “File System” file access method. It simpy returns “True”
If the function returns “False”, the errors collection should be checked.

Procedure CopyDocumentTypesLocally
Type: Function
Scope: Public
Count of lines: 21
Declaration:
Public Function CopyDocumentTypesLocally(ByVal varTypeArray As Variant) As Boolean

Parameters:

| Name | Type | ByVal/ByRef | Optional (Default Value) |
|---|---|---|---|
| varTypeArray | Variant | ByVal | No |

Comment:
Procedure CreatePDMStructure
Type: Function
Scope: Public
Count of lines: 16
Declaration:
Public Function CreatePDMStructure(ProjectType As Integer, RootProjectID As String, ReleasesProjectID As String) As String

Parameters:

| Name | Type | ByVal/ByRef | Optional (Default Value) |
|---|---|---|---|
| ProjectType | Integer | ByRef | No |
| RootProjectID | String | ByRef | No |
| ReleasesProjectID | String | ByRef | No |

Comment: None

Procedure CurrentDocument
Type: Property Get
Scope: Public
Count of lines: 11
Declaration:
Public Property Get CurrentDocument( ) As Document
Parameters: None
Comment:
The CurrentDocument property
This property represents the most recent document demanded.
This property is generally set by all methods that demand a document. For example,
When “GetMasterDocument” is called, it returns a value of True/False. If True, the “CurrentDocument” property is set to the document demanded. If False, “CurrentDocument” property is set to Nothing.
This is the case for all methods where a document is to be returned.

Procedure CurrentDocument
Type: Property Set
Scope: Public
Count of lines: 4
Declaration:
Public Property Set CurrentDocument(ByVal newValue As Document)

Parameters:

| Name | Type | ByVal/ByRef | Optional (Default Value) |
|---|---|---|---|
| newValue | Document | ByVal | No |

Comment: None

Procedure CurrentFolder
Type: Property Get
Scope: Public
Count of lines: 5
Declaration:
Public Property Get CurrentFolder( ) As Scripting.Folder
Parameters: None
Comment:
The CurrentFolder property

Procedure CustomAppsFolder
Type: Property Get
Scope: Public
Count of lines: 6
Declaration:
Public Property Get CustomAppsFolder( ) As String
Parameters: None
Comment:
The CustomAppsFolder property
This property represents the location where all custom OCXs are installed.

Procedure Deconstruct
Type: Subroutine
Scope: Public
Count of lines: 18
Declaration:
Public Sub Deconstruct( )
Parameters: None
Comment:
Deconstruct destroys all object references in document access.
This method must be called immediately prior to setting document access=nothing.
This function should NOT be called externally during runtime by a custom function.

Procedure DeleteDocument
Type: Function
Scope: Public
Count of lines: 35
Declaration:
Public Function DeleteDocument( ) As Boolean
Parameters: None
Comment:
This method deletes the file associated with the “CurrentDocument” property and sets the “CurrentDocument” property=Nothing.
If True is returned the delete is successful.
If False is returned, the errors collection should be checked.

Procedure DeleteDocumentByName
Type: Function
Scope: Public
Count of lines: 36
Declaration:
Public Function DeleteDocumentByName(ByVal strFileName As String, ByVal enuFolderType As RuleStreamFolder) As Boolean

Parameters:

| | | | Optional |
|---|---|---|---|
| Name | Type | ByVal/ByRef | (Default Value) |
| strFileName | String | ByVal | No |
| enuFolderType | RuleStreamFolder | ByVal | No |

Comment:
Deletes a named file from the specified folder in the RulestreamFolder enumeration.
Given the limited number of file folders Rulestream needs to interact with, this helps limit the possibility of removing files from incorrect folders.

Procedure DeleteDocumentFromPath
Type: Function
Scope: Public
Count of lines: 37
Declaration:
Public Function DeleteDocumentFromPath(ByVal strFileName As String, Optional ByVal enuFolderType As RuleStreamFolder=enuWorkingFolder) As Boolean

Parameters:

| | | ByVal/ | Optional |
|---|---|---|---|
| Name | Type | ByRef | (Default Value) |
| strFileName | String | ByVal | No |
| enuFolderType | RuleStreamFolder | ByVal | Yes (enuWorkingFolder) |

Comment:
This method deletes the file with the name passed in the folder specified by the enumeration.
This method does NOT effect the “CurrentDocument” property
If True is returned the delete is successful.
If False is returned, the errors collection should be checked.

Procedure DeleteMasterDocument
Type: Function
Scope: Public
Count of lines: 10
Declaration:
Public Function DeleteMasterDocument(ByVal strFileName As String) As Boolean

Parameters:

| Name | Type | ByVal/ByRef | Optional (Default Value) |
|---|---|---|---|
| strFileName | String | ByVal | No |

Comment:
This method removes a file to the master documents file store
This interface is currently NOT implemented.

Procedure DocumentExists
Type: Function
Scope: Public
Count of lines: 68
Declaration:
Public Function DocumentExists(ByVal strFileName As String, ByVal enuFolderType As RuleStreamFolder) As Boolean

Parameters:

| | | | Optional |
|---|---|---|---|
| Name | Type | ByVal/ByRef | (Default Value) |
| strFileName | String | ByVal | No |
| enuFolderType | RuleStreamFolder | ByVal | No |

Comment:

This method checks for the existence of a file in the selected folder enumeration.

Returns True if file exists, False if file does not exist or an error occurred.

If False is returned, the errors collection should be checked.

Procedure Documents
Type: Property Get
Scope: Public
Count of lines: 6
Declaration:
Public Property Get Documents( ) As Documents
Parameters: None
Comment:
The Documents property represents a collection of documents accessed during the current session

Procedure Errors
Type: Property Get
Scope: Public
Count of lines: 7
Declaration:
Public Property Get Errors( ) As Errors
Parameters: None
Comment:
Exposes the errors collection.
When a function fails (returns False), the user should check the errors collection for specific failure messages.

Procedure ExecutePassThruMQL
Type: Function
Scope: Public
Count of lines: 29
Declaration:
Public Function ExecutePassThruMQL(ByVal strMQLCommand As String, strReturnData As String) As Boolean

Parameters:

| Name | Type | ByVal/ByRef | Optional (Default Value) |
|---|---|---|---|
| strMQLCommand | String | ByVal | No |
| strReturnData | String | ByRef | No |

Comment:
This method allows for the execution of a Matrix Query Language statement.
This method is only supported by the Matrix file access method.
Return data is delivered via the “strReturnData” parameter.
Returns True if successful, False if the MQL statement fails.
If False is returned, check the errors collection.

Procedure GetDocument
Type: Function
Scope: Public
Count of lines: 74
Declaration:
Public Function GetDocument(ByVal strFileName As String, Optional ByVal enuFolderType As RuleStreamFolder=enuWorkingFolder, Optional ByVal blnCheckOut=True) As Boolean

Parameters:

| | | ByVal/ | |
|---|---|---|---|
| Name | Type | ByRef | Optional (Default Value) |
| strFileName | String | ByVal | No |
| enuFolderType | RuleStreamFolder | ByVal | Yes (enuWorkingFolder) |
| blnCheckOut | | ByVal | Yes (True) |

Comment:
This method returns a pointer to specified file in the selected Rulestream Folder (based on the enumerator).
This method does not return documents from a PDM/PLM system.
If True is returned (successful), the “CurrentDocument” property will be set to valid document object with a reference to the file instance.
If False is returned, the “CurrentDocument” property will be set to Nothing and the errors collection should be checked.

Procedure GetDocumentByID
Type: Function
Scope: Public
Count of lines: 46
Declaration:
Public Function GetDocumentByID(ByVal strModelID As String, Optional ByVal blnLockObject As Boolean=True, Optional ByVal blnGetChildren=False) As Boolean

Parameters:

| Name | Type | ByVal/ByRef | Optional (Default Value) | |
|---|---|---|---|---|
| strModelID | String | ByVal | No | |
| blnLockObject | Boolean | ByVal | Yes | (True) |
| blnGetChildren | | ByVal | Yes | (False) |

Comment:
This method returns a document by demanding it via its unqiue Model ID (assigned when the template instance is demanded the first time). This method is used when demanding CAD models that have been previously saved to a PDM/PLM system.
Note: “blnLockObject” should be set to True if the user wants this CAD documents modifiable flag set to True.
“blnGetChildren” should be set to True when demanding large assemblies.
This allows the PDM/PLM system to return all related documents in one call and, therefore, maximizing efficiencies.
If True is returned (successful), the “CurrentDocument” property will be set to valid document object with a reference to the file instance.
If False is returned, the “CurrentDocument” property will be set to Nothing and the errors collection should be checked.

Procedure GetFolder
Type: Function
Scope: Public
Count of lines: 33
Declaration:
Public Function GetFolder(ByVal enuFolderType As RuleStreamFolder) As Boolean

Parameters:

| | | | Optional |
|---|---|---|---|
| Name | Type | ByVal/ByRef | (Default Value) |
| enuFolderType | RuleStreamFolder | ByVal | No |

Comment:
This method populates the “CurrentFolder” property with a “Scripting.Folder” object.
If the method fails, the “CurrentFolder” property will be set to Nothing and the errors collection should be checked.

Procedure GetMasterDocument
Type: Function
Scope: Public
Count of lines: 52
Declaration:
Public Function GetMasterDocument(ByVal strFileName As String, Optional ByVal blnCheckOut=False) As Boolean

Parameters:

| Name | Type | ByVal/ByRef | Optional (Default Value) | |
|---|---|---|---|---|
| strFileName | String | ByVal | No | |
| blnCheckOut | | ByVal | Yes | (False) |

Comment:
This method returns a file from the master documents file store for the following file access methods:
File System
SmarTeam
Matrix
“GetMasterDocument” behaves according to the file access method the application is using. This method is called when demanding an instance of a template to be used by Rulestream
Note: Check out is ignored for file system access.
If True is returned (successful), the “CurrentDocument” property will be set to valid document object with a reference to the file instance.
If False is returned, the “CurrentDocument” property will be set to Nothing and the errors collection should be checked.

Procedure GetMasterDocumentFolder
Type: Function
Scope: Public
Count of lines: 26
Declaration:
Public Function GetMasterDocumentFolder( ) As Boolean
Parameters: None
Comment:
This method populates the “CurrentFolder” property with a “Scripting.Folder” object.
If the method fails, the “CurrentFolder” property will be set to Nothing and the errors collection should be checked . . .

Procedure GetReleaseDocument
Type: Function
Scope: Public
Count of lines: 36
Declaration:
Public Function GetReleaseDocument(ByVal strFileName As String, ByVal lngReleaseID As Long, Optional ByVal blnCheckOut=False) As Boolean

Parameters:

| Name | Type | ByVal/ByRef | Optional (Default Value) | |
|---|---|---|---|---|
| strFileName | String | ByVal | No | |
| lngReleaseID | Long | ByVal | No | |
| blnCheckOut | | ByVal | Yes | (False) |

Comment:
This method returns a file from the Release Documents file FOLDER.
This method does not return a document from a PDM/PLM system. To return a specific “released” document from PDM/PLM, “GetDocumentByID” should be used

Procedure GetReleaseFolder
Type: Function
Scope: Public
Count of lines: 44
Declaration:
Public Function GetReleaseFolder(ByVal lngReleaseID As Long) As Boolean

Parameters:

| Name | Type | ByVal/ByRef | Optional (Default Value) |
|---|---|---|---|
| lngReleaseID | Long | ByVal | No |

Comment:
This method populates the “CurrentFolder” property with a “Scripting.Folder” object.
If the method fails, the “CurrentFolder” property will be set to Nothing and the errors collection should be checked . . .

Procedure Initialize
Type: Function
Scope: Public
Count of lines: 138
Declaration:
Public Function Initialize(ByVal strAppPath As String, ByVal strFullIniPath As String, ByVal strProfileName As String) As Boolean

Parameters:

| Name | Type | ByVal/ByRef | Optional (Default Value) |
|---|---|---|---|
| strAppPath | String | ByVal | No |
| strFullIniPath | String | ByVal | No |
| strProfileName | String | ByVal | No |

Comment:
This function must be called immediately after the object is created. “Initialize” sets up the object as to it's file access method and various base properties (folder locations, profile name, etc.)
If the file access method is NOT “File System”, the proper support objects will be created (SmarTeam Access, Matrix Access) “Initialize” requires the nAct.INI file to be passed.
If “Initialize” has not happened, all method calls will fail with an error in the errors collection stating that Document Access has not been initialized.
If “Initialize” returns False, check the errors collection for the failure reason.

Procedure InitializeModel
Type: Function
Scope: Public
Count of lines: 37
Declaration:
Public Function InitializeModel(ByVal strProjectID As String, ByVal lngLineItem As Long) As Boolean

Parameters:

| Name | Type | ByVal/ByRef | Optional (Default Value) |
|---|---|---|---|
| strProjectID | String | ByVal | No |
| lngLineItem | Long | ByVal | No |

Comment:
InitializeModel sets up the DocumentAccess class to begin a new session.
This method only needs to be called when the application is entering a new line item during Rulestream “runtime”.
This function performs the following tasks: Deletes all working files in the local “PDMDocumentsFolder”
Clears the various object properties
Sets the proper Project Line Item references
This function should NOT be called externally during runtime by a custom function.

Procedure InstallFolder
Type: Property Get
Scope: Public
Count of lines: 6
Declaration:
Public Property Get InstallFolder( ) As String
Parameters: None
Comment:
The InstallFolder property
This property represents the parent folder location of all local Rulestream folders

Procedure IsDocumentCheckedOut
Type: Function
Scope: Public
Count of lines: 17
Declaration:
Public Function IsDocumentCheckedOut(ByVal strFullyQualifiedFileName As String) As Boolean

Parameters:

| | | | Optional |
|---|---|---|---|
| Name | Type | ByVal/ByRef | (Default Value) |
| strFullyQualifiedFileName | String | ByVal | No |

Procedure LocalDocumentsFolder
Type: Property Get
Scope: Public
Count of lines: 7
Declaration:
Public Property Get LocalDocumentsFolder( ) As String
Parameters: None
Comment:
The LocalDocumentsFolder property
This property represents the location of template documents when a user is running
Rulestream in a disconnected mode.

Procedure LogFolder
Type: Property Get
Scope: Public
Count of lines: 6
Declaration:
Public Property Get LogFolder( ) As String
Parameters: None
Comment:
The LogFolder property
This property represents the location of log files generated by Rulestream.

Procedure MasterDocumentsFolder
Type: Property Get
Scope: Public
Count of lines: 56
Declaration:
Public Property Get MasterDocumentsFolder( ) As String
Parameters: None
Comment:
The MasterDocumentsFolder property
This property represents the location of all template documents used by Rulestream when the file access method is “File System”.
This property will return “ ” when the file access method is not “File System”.
If the file access method is “File System” and the property returns “ ”, check the errors collection.

Procedure MasterDocumentsFolder
Type: Property Let
Scope: Public
Count of lines: 28
Declaration:
Public Property Let MasterDocumentsFolder(ByVal newValue As String)

Parameters:

| Name | Type | ByVal/ByRef | Optional (Default Value) |
|---|---|---|---|
| newValue | String | ByVal | No |

Comment:
This property sets the “MasterFolder” value in the nAct.INI file for the current profile.
This property should NOT be called externally during runtime by a custom function.

Procedure MasterFolderObject
Type: Property Get
Scope: Public
Count of lines: 6
Declaration:
Public Property Get MasterFolderObject( ) As Object
Parameters: None
Comment:
The MasterFolderObject property
Procedure mxGetPartByPartNumber
Type: Function
Scope: Public
Count of lines: 18
Declaration:
Public Function mxGetPartByPartNumber(ByVal strPartNumber As String, ByRef strFileName As String) As Boolean

Parameters:

| Name | Type | ByVal/ByRef | Optional (Default Value) |
|---|---|---|---|
| strPartNumber | String | ByVal | No |
| strFileName | String | ByRef | No |

Comment:
This method allows for the return of a CAD file name based on the Part Number passed.
This method is only supported by the Matrix file access method.
The CAD file name is delivered via the “strFileName” parameter.
Returns True if successful, False if the function fails.
If False is returned, check the errors collection.

Procedure Part NumberResearch
Type: Property Let
Scope: Public
Count of lines: 6
Declaration:
Public Property Let Part NumberResearch(ByVal newValue As Boolean)

Parameters:

| Name | Type | ByVal/ByRef | Optional (Default Value) |
|---|---|---|---|
| newValue | Boolean | ByVal | No |

Comment:
The Part NumberResearch property
xxx—add comment

Procedure PDMDocumentClasses
Type: Property Get
Scope: Public
Count of lines: 4
Declaration:
Public Property Get PDMDocumentClasses( ) As Collection
Parameters: None
Comment: None

Procedure PDMDocumentsFolder
Type: Property Get
Scope: Public
Count of lines: 7
Declaration:
Public Property Get PDMDocumentsFolder( ) As String
Parameters: None
Comment:
The PDMDocumentsFolder property
This property represents the location to which all documents demanded from a PDM/PLM system are initially copied.

Procedure PDMFileTypes
Type: Property Get
Scope: Public
Count of lines: 4
Declaration:
Public Property Get PDMFileTypes( ) As Collection
Parameters: None
Comment: None

Procedure PDMReleasesProject
Type: Property Get
Scope: Public
Count of lines: 4
Declaration:
Public Property Get PDMReleasesProject( ) As String
Parameters: None
Comment: None

Procedure PDMRequiredFields
Type: Property Get
Scope: Public
Count of lines: 4
Declaration:
Public Property Get PDMRequiredFields( ) As Collection
Parameters: None
Comment: None

Procedure PDMRootProject
Type: Property Get
Scope: Public
Count of lines: 4
Declaration:
Public Property Get PDMRootProject( ) As String
Parameters: None
Comment: None

Procedure PNResearch
Type: Function
Scope: Public
Count of lines: 31
Declaration:
Public Function PNResearch(ByVal objDocuments As Documents) As Boolean

Parameters:

| Name | Type | ByVal/ByRef | Optional (Default Value) |
|---|---|---|---|
| objDocuments | Documents | ByVal | No |

Comment:
This function allows PN research for all documents in the passed documents collection.
This function is not yet implemented for any of the file access methods.
If the function returns “False”, the errors collection should be checked.

Procedure ProfileName
Type: Property Get
Scope: Public
Count of lines: 6
Declaration:
Public Property Get ProfileName( ) As String
Parameters: None
Comment:
The ProfileName property
The current user profile used to log into Rulestream

Procedure ReleaseFolderObject

Procedure ReleaseID
Type: Property Get
Scope: Public
Count of lines: 6
Declaration:
Public Property Get ReleaseID( ) As Long
Parameters: None
Comment:
The ReleaseID property
This is the current Release ID

Procedure ReleaseID
Type: Property Let
Scope: Public
Count of lines: 4
Declaration:
Public Property Let ReleaseID(ByVal newValue As Long)

Parameters:

| Name | Type | ByVal/ByRef | Optional (Default Value) |
|---|---|---|---|
| newValue | Long | ByVal | No |

Comment: None

Procedure ReleasesFolder
Type: Property Get
Scope: Public
Count of lines: 48
Declaration:
Public Property Get ReleasesFolder( ) As String
Parameters: None
Comment:
The ReleasesFolder property
This property represents the location of locally stored releases (Not PDM Store).
This is the parent folder for all Project/Line Item releases.

Procedure ReleasesFolder
Type: Property Let
Scope: Public
Count of lines: 13
Declaration:
Public Property Let ReleasesFolder(ByVal newValue As String)

Parameters:

| Name | Type | ByVal/ByRef | Optional (Default Value) |
|---|---|---|---|
| newValue | String | ByVal | No |

Comment: None

Procedure ReturnDataFromPDMLookup
Type: Function
Scope: Public
Count of lines: 11
Declaration:
Public Function ReturnDataFromPDMLookup(ByVal strTableName As String) As Dictionary

Parameters:

| Name | Type | ByVal/ByRef | Optional (Default Value) |
|---|---|---|---|
| strTableName | String | ByVal | No |

Comment:
To be implemented later to return valid values from an internal PDM lookup table

Procedure ReturnPDMLookupTables
Type: Function
Scope: Public
Count of lines: 10
Declaration:
Public Function ReturnPDMLookupTables( ) As Collection
Parameters: None
Comment:
To be implemented later to return valid values from an internal PDM lookup table

Procedure RulestreamLineItem
Type: Property Get
Scope: Public
Count of lines: 9
Declaration:
Public Property Get RulestreanLineItem( ) As Long
Parameters: None
Comment:
The RulestreamLineItem property
This is the current Rulestream Line Item.
If this property returns a value of zero (0), check the errors collection.

Procedure RulestreamLineItem
Type: Property Let
Scope: Public
Count of lines: 4
Declaration:
Public Property Let RulestreamLineItem(ByVal newValue As Long)

Parameters:

| Name | Type | ByVal/ByRef | Optional (Default Value) |
|---|---|---|---|
| newValue | Long | ByVal | No |

Comment: None

Procedure RulestreamProject
Type: Property Get
Scope: Public
Count of lines: 9
Declaration:
Public Property Get RulestreamProject( ) As String
Parameters: None
Comment:
The RulestreamLineItem property
This is the current Rulestream Project.
If this property returns a value of “ ”, check the errors collection.

Procedure RulestreamProject
Type: Property Let
Scope: Public
Count of lines: 4
Declaration:
Public Property Let RulestreamProject(ByVal newValue As String)

Parameters:

| Name | Type | ByVal/ByRef | Optional (Default Value) |
|---|---|---|---|
| newValue | String | ByVal | No |

Comment: None

Procedure SaveAllDocumentsFromPath
Type: Function
Scope: Public
Count of lines: 45
Declaration:
Public Function SaveAllDocumentsFromPath(ByVal strFullyQualifiedSourceFilePath, Optional ByVal enuFolderType As RuleStreamFolder=enuWorkingFolder) As Boolean

Parameters:

| | | | Optional |
|---|---|---|---|
| Name | Type | ByVal/ByRef | (Default Value) |
| strFullyQualified- | | ByVal | No |
| SourceFilePath | | | |
| enuFolderType | RuleStream- | ByVal | Yes |
| | Folder | | (enuWorkingFolder) |

Comment:
This method copies all files in the fully qualified path to the selected Rulestream Folder (based on the enumerator).
If True is returned the save is successful.
If False is returned, the errors collection should be checked.

Procedure SaveDocument
Type: Function
Scope: Public
Count of lines: 43
Declaration:
Public Function SaveDocument(ByVal strFileName As String, Optional ByVal enuFolderType As RuleStreamFolder=enuWorkingFolder, Optional ByVal blnCheckin=True) As Boolean

Parameters:

| | | | Optional |
|---|---|---|---|
| Name | Type | ByVal/ByRef | (Default Value) |
| strFileName | String | ByVal | No |
| enuFolderType | RuleStreamFolder | ByVal | Yes |
| | | | (enuWorkingFolder) |
| blnCheckin | | ByVal | Yes |
| | | | (True) |

Comment:
This method saves the document referenced in the “CurrentDocument” property as a specified filename in the selected Rulestream Folder (based on the enumerator).
If True is returned the save is successful.
If False is returned, the errors collection should be checked.
Note: The “CurrentDocument” property is NOT changed to reflect the newly saved document. It continues to represent the same file that it did prior to the save.

Procedure SaveDocumentFromPath
Type: Function
Scope: Public
Count of lines: 46
Declaration:
Public Function SaveDocumentFromPath(ByVal strFullyQualifiedSourceFilePath, ByVal strNewFilename As String, Optional ByVal enuFolderType As RuleStreamFolder=enuWorkingFolder, Optional ByVal blnCheckin=True) As Boolean

Parameters:

| | | | Optional |
|---|---|---|---|
| Name | Type | ByVal/ByRef | (Default Value) |
| strFullyQualified- | | ByVal | No |
| SourceFilePath | | | |
| strNewFilename | String | ByVal | No |
| enuFolderType | RuleStream- | ByVal | Yes |
| | Folder | | (enuWorkingFolder) |
| blnCheckin | | ByVal | Yes |
| | | | (True) |

Comment:
This method copies a fully qualified file to a given filename in the selected Rulestream Folder (based on the enumerator).
If the “strNewFileName” parameter=“ ”, then the file will be copied to the selected location with the same name as the source file.
If True is returned the save is successful.
If False is returned, the errors collection should be checked.
Note: The “CurrentDocument” property is NOT set to reflect the newly saved document.

Procedure SaveDocuments
Type: Function
Scope: Public
Count of lines: 10
Declaration:
Public Function SaveDocuments(Optional ByVal enuFolderType As RuleStreamFolder=enuWorkingFolder) As Boolean

Parameters:

| | | | Optional |
|---|---|---|---|
| Name | Type | ByVal/ByRef | (Default Value) |
| enuFolderType | RuleStreamFolder | ByVal | Yes |
| | | | (enuWorkingFolder) |

Procedure SaveMasterDocument
Type: Function
Scope: Public
Count of lines: 36
Declaration:
Public Function SaveMasterDocument(ByVal strFullyQualifiedFile As String, Optional ByVal blnCheckin As Boolean=True) As Boolean

Parameters:

| Name | Type | ByVal/ByRef | Optional (Default Value) |
|---|---|---|---|
| strFully- | String | ByVal | No |
| QualifiedFile | | | |
| blnCheckin | Boolean | ByVal | Yes |
| | | | (True) |

Comment:
This method saves a single template file to the master Documents file store for the following file access methods:
File System
SmarTeam
If False is returned, the errors collection should be checked.
Note: Matrix uses the rsSWPDM.dll add-in to save template documents to the master documents store

Procedure SaveMasterDocuments
Type: Function
Scope: Public
Count of lines: 42
Declaration:
Public Function SaveMasterDocuments(ByRef objDocuments As Documents, Optional ByVal blnCheckin As Boolean=True) As Boolean

Parameters:

| Name | Type | ByVal/ByRef | Optional (Default Value) |
|---|---|---|---|
| objDocuments | Documents | ByRef | No |
| blnCheckin | Boolean | ByVal | Yes (True) |

Comment:
This method saves a multiple template files to the master Documents file store for the following file access methods:
File System
SmarTeam
These documents are passed as a documents collection object that contains the necessary parent/child relationship information.
If False is returned, the errors collection should be checked.
Note: Matrix uses the rsSWPDM.dll add-in to save template documents to the master documents store

Procedure SaveReleaseDocument
Type: Function
Scope: Public
Count of lines: 40
Declaration:
Public Function SaveReleaseDocument(ByVal strFile As String, Optional ByVal blnCheckin=True, Optional ByVal strProject As String, Optional ByVal lngLineNumber As Long, Optional ByVal lngReleaseID As Long) As Boolean

Parameters:

| Name | Type | ByVal/ByRef | Optional (Default Value) |
|---|---|---|---|
| strFile | String | ByVal | No |
| blnCheckin | | ByVal | Yes (True) |
| strProject | String | ByVal | Yes ( ) |
| lngLineNumber | Long | ByVal | Yes ( ) |
| lngReleaseID | Long | ByVal | Yes ( ) |

Comment:
This method saves a file to the Release Documents file FOLDER.
This method does NOT insert documents into a PDM/PLM system. It is designed to save a copy of a released document to its proper release folder on disk.

Procedure SaveReleaseDocuments
Type: Function
Scope: Public
Count of lines: 40
Declaration:
Public Function SaveReleaseDocuments(ByRef objDocuments As Documents, Optional ByVal blnCheckin As Boolean=True) As Boolean

Parameters:

| Name | Type | ByVal/ByRef | Optional (Default Value) |
|---|---|---|---|
| objDocuments | Documents | ByRef | No |
| blnCheckin | Boolean | ByVal | Yes (True) |

Comment:
This method saves all files to the released documents file store for the following file access methods:
File System
SmarTeam
Matrix
These documents are passed as a documents collection object that contains the necessary parent/child relationship information.
“SaveReleaseDocuments” behaves according to the file access method the application is using.
If False is returned, the errors collection should be checked.

Procedure TemporaryFolder
Type: Property Get
Scope: Public
Count of lines: 9
Declaration:
Public Property Get TemporaryFolder( ) As String
Parameters: None
Comment:
The TemporaryFolder property
This property represents the folder used by Rulestream as a temporary file store during Code Generation and XML/XSLT transformations.

Procedure TerminateModel
Type: Subroutine
Scope: Public
Count of lines: 25
Declaration:
Public Sub TerminateModel( )
Parameters: None
Comment:
TerminateModel clears up the DocumentAccess class at the end of a session.
This method only needs to be called when the application is exiting a line item during Rulestream “runtime”.
This function performs the following tasks: Deletes all working files in the local “PDMDocumentsFolder”
Clears the various object properties
Sets the proper Project Line Item references
This function should NOT be called externally during runtime by a custom function.

Procedure WorkingFolder
Type: Property Get
Scope: Public
Count of lines: 35
Declaration:
Public Property Get WorkingFolder( ) As String
Parameters: None
Comment:
The Working Folder property
This property represents the location of files used during Rulestream runtime when editting Project/Line Item.
This folder is release “0” for a Project/Line Item and is created as a subfolder of the “ReleasesFolder”.

Class Documents (Documents.cls)
Comment:
Module: Documents
DateTime: Jan. 13, 2004 10:47
Author: rcarek
Purpose: The documents collection object represents a group of document objects.
Beyond being a simple collection of objects the “Documents” object contains several methods for population of the collection and the creation of a hierarchical representation of the documents in the collection.
Note: While the collection exists as flat structure of document objects, each object can contain (via its parents and children properties) references to other objects in the collection to define a hierarchical structure.
Count of declaration lines: 17
Count of lines: 337

Properties:

| Name | Value |
|---|---|
| DataBindingBehavior | 0 |
| DataSourceBehavior | 0 |
| Instancing | 5 |
| MTSTransactionMode | 0 |
| Name | Documents |
| Persistable | 0 |

Procedures:

| Name | Scope | Type |
|---|---|---|
| Clear | Friend | Subroutine |
| Class_Initialize | Private | Subroutine |
| Class_Terminate | Private | Subroutine |
| RelationExists | Private | Function |
| Add | Public | Function |
| AddChild | Public | Function |
| AddDocumentFromPath | Public | Function |
| AddDocumentsFromCollection | Public | Function |
| AddDocumentsFromPath | Public | Function |
| AddParent | Public | Function |
| Count | Public | Property Get |
| DocumentExists | Public | Function |
| Item | Public | Property Get |
| LoadDocumentFilesFromPath | Public | Function |
| NewEnum | Public | Property Get |
| Remove | Public | Subroutine |

Procedure Clear
Type: Subroutine
Scope: Friend
Count of lines: 4
Declaration:
Friend Sub Clear( )
Parameters: None
Comment: None

Procedure Class_Initialize
Type: Subroutine
Scope: Private
Count of lines: 5
Declaration:
Private Sub Class_Initialize( )
Parameters: None
Comment:
creates the collection when this class is created

Procedure Class_Terminate
Type: Subroutine
Scope: Private
Count of lines: 5
Declaration:
Private Sub Class_Terminate( )
Parameters: None
Comment:
destroys collection when this class is terminated

Procedure RelationExists
Type: Function
Scope: Private
Count of lines: 20
Declaration:
Private Function RelationExists(ByRef Relations As Relations, ByRef RelationID As String) As Boolean

Parameters:

| Name | Type | ByVal/ByRef | Optional (Default Value) |
|---|---|---|---|
| Relations | Relations | ByRef | No |
| RelationID | String | ByRef | No |

Comment:
Private function

Procedure Add
Type: Function
Scope: Public
Count of lines: 53
Declaration:
Public Function Add(File As Scripting.File, FileName As String, StandardPart As Boolean, Part Number As String, Part NumberFileName As String, ObjectID As String, FileType As String, SourceOptimalPartFile As String) As Document

Parameters:

| | | | Optional |
|---|---|---|---|
| Name | Type | ByVal/ByRef | (Default Value) |
| File | Scripting.File | ByRef | No |
| FileName | String | ByRef | No |
| StandardPart | Boolean | ByRef | No |
| PartNumber | String | ByRef | No |
| PartNumberFileName | String | ByRef | No |
| ObjectID | String | ByRef | No |
| FileType | String | ByRef | No |
| SourceOptimalPartFile | String | ByRef | No |

Comment:
This method is used to add a document object to the collection.
If the document already exists, then the document object is updated with the values passed as parameters. The new/updated document object is returned.

Procedure AddChild
Type: Function
Scope: Public
Count of lines: 30
Declaration:
Public Function AddChild(ByRef Document As Document, Child As String, Optional bExecReference As Boolean=True) As Boolean

Parameters:

| Name | Type | ByVal/ByRef | Optional (Default Value) |
|---|---|---|---|
| Document | Document | ByRef | No |
| Child | String | ByRef | No |
| bExecReference | Boolean | ByRef | Yes (True) |

Comment:
This adds a “Relation” object instance to a document objects children collection.
If the child document does not exist in the collection, then a document object representing the child document is added to the documents collection.

Procedure AddDocumentFromPath
Type: Function
Scope: Public
Count of lines: 25
Declaration:
Public Function AddDocumentFromPath(ByVal strFullyQualifiedFileName As String) As Boolean

Parameters:

| | | | Optional |
|---|---|---|---|
| Name | Type | ByVal/ByRef | (Default Value) |
| strFullyQualifiedFileName | String | ByVal | No |

Comment:
This method is used to add a document to the documents collection based on a fully qualified file path.

Procedure AddDocumentsFromCollection
Type: Function
Scope: Public
Count of lines: 32
Declaration:
Public Function AddDocumentsFromCollection(strFullyQualifiedPath As String, FileCollection As Collection) As Boolean

Parameters:

| | | | Optional |
|---|---|---|---|
| Name | Type | ByVal/ByRef | (Default Value) |
| strFullyQualifiedPath | String | ByRef | No |
| FileCollection | Collection | ByRef | No |

Comment:
This method allows a user to populate the documents collection with all files listed in the collection of file names from the specified fully qualified path.

Procedure AddDocumentsFromPath
Type: Function
Scope: Public
Count of lines: 35
Declaration:
Public Function AddDocumentsFromPath(ByVal strFullyQualifiedPath As String, strFileType As String) As Boolean

Parameters:

| | | | Optional |
|---|---|---|---|
| Name | Type | ByVal/ByRef | (Default Value) |
| strFullyQualifiedPath | String | ByVal | No |
| strFileType | String | ByRef | No |

Comment:
This method is used to add document objects to the documents collection for each file of the declared type from a fully qualified path folder.

Procedure AddParent
Type: Function
Scope: Public
Count of lines: 29
Declaration:
Public Function AddParent(ByRef Document As Document, Parent As String, Optional bExecReference As Boolean=True) As Boolean

Parameters:

| Name | Type | ByVal/ByRef | Optional (Default Value) |
|---|---|---|---|
| Document | Document | ByRef | No |
| Parent | String | ByRef | No |
| bExecReference | Boolean | ByRef | Yes (True) |

Comment:
This adds a “Relation” object instance to a document objects Parents collection.
If the parent document does not exist in the collection, then a document object representing the parent document is added to the documents collection.

Procedure Count
Type: Property Get
Scope: Public
Count of lines: 8
Declaration:
Public Property Get Count( ) As Long
Parameters: None
Comment:
This property is used when retrieving the number of elements in the collection.
Syntax: Debug.Print x.Count

Procedure DocumentExists
Type: Function
Scope: Public
Count of lines: 19
Declaration:
Public Function DocumentExists(FileName As String) As Boolean

Parameters:

| Name | Type | ByVal/ByRef | Optional (Default Value) |
|---|---|---|---|
| FileName | String | ByRef | No |

Comment:
This method is used to determine if a document with the existing file name already exists in the documents collection.

Procedure Item
Type: Property Get
Scope: Public
Count of lines: 11
Declaration:
Public Property Get Item(vntIndexKey As Variant) As Document

Parameters:

| Name | Type | ByVal/ByRef | Optional (Default Value) |
|---|---|---|---|
| vntIndexKey | Variant | ByRef | No |

Comment:
This property is used when referencing an element in the collection vntIndexKey contains either the Index or Key to the collection, this is why it is declared as a Variant
Syntax: Set foo=x.Item(xyz) or Set foo=x.Item(5)

Procedure LoadDocumentFilesFromPath
Type: Function
Scope: Public
Count of lines: 26
Declaration:
Public Function LoadDocumentFilesFromPath(ByVal strFullyQualifiedPath As String) As Boolean

Parameters:

| | | | Optional |
|---|---|---|---|
| Name | Type | ByVal/ByRef | (Default Value) |
| strFullyQualifiedPath | String | ByVal | No |

Comment:
This method loads the file objects of the associated document objects in the collection for the path sent.
A user may choose to create a documents collection without setting the “File” property of each document initially. This method allows the user to populate the “File” properties of each document object (assuming all files are in the same path folder) with a single call at any point they choose.

Procedure NewEnum
Type: Property Get
Scope: Public
Count of lines: 7
Declaration:
Public Property Get NewEnum( ) As IUnknown
Parameters: None
Comment:
This property allows you to enumerate
This collection with the For . . . Each syntax

Procedure Remove
Type: Subroutine
Scope: Public
Count of lines: 10
Declaration:
Public Sub Remove(vntIndexKey As Variant)

Parameters:

| Name | Type | ByVal/ByRef | Optional (Default Value) |
|---|---|---|---|
| vntIndexKey | Variant | ByRef | No |

Comment:
This property us used when removing an element from the collection vntIndexKey contains either the Index or Key, which is why it is declared as a Variant
Syntax: x.Remove(xyz)

Class Error (clsError.cls)
Comment:
Module: Error
DateTime: Jan. 13, 2004 09:13
Author: rcarek
Purpose: All handled errors in DocumentAccess are exposed via an errors collection.
The errors collection contains individual error objects that expose the Number, Source, and Description of the error.
Error objects are created and added to the collection via the LoadError method on the Errors Object
Count of declaration lines: 17
Count of lines: 44

Properties:

| Name | Value |
|---|---|
| DataBindingBehavior | 0 |
| DataSourceBehavior | 0 |
| Instancing | 2 |
| MTSTransactionMode | 0 |
| Name | Error |
| Persistable | 0 |

Procedures:

| Name | Scope | Type |
|---|---|---|
| SetError | Friend | Subroutine |
| Description | Public | Property Get |
| Number | Public | Property Get |
| Source | Public | Property Get |

Procedure SetError
Type: Subroutine
Scope: Friend
Count of lines: 8
Declaration:
Friend Sub SetError(ByVal sDescription As String, ByVal sSource As String, ByVal lNumber As Long)

Parameters:

| Name | Type | ByVal/ByRef | Optional (Default Value) |
|---|---|---|---|
| sDescription | String | ByVal | No |
| sSource | String | ByVal | No |
| lNumber | Long | ByVal | No |

Comment: None

Procedure Description
Type: Property Get
Scope: Public
Count of lines: 7
Declaration:
Public Property Get Description( ) As String
Parameters: None
Comment:
This property represents the description of the specific error that occurred during a method/property call in DocumentAccess.

Procedure Number
Type: Property Get
Scope: Public
Count of lines: 6
Declaration:
Public Property Get Number( ) As Long
Parameters: None
Comment:
This property represents the error number of the specific error that occurred during a method/property call in DocumentAccess.

Procedure Source
Type: Property Get
Scope: Public
Count of lines: 6
Declaration:
Public Property Get Source( ) As String
Parameters: None
Comment:
This property represents the code location (source or method) of the specific error that occurred during a method/property call in DocumentAccess.

Class Errors (clsErrors.cls)
Comment:
Module: Errors
DateTime: Jan. 13, 2004 10:56
Author: rcarek
Purpose: All handled errors that occur within DocumentAccess end up in the errors collection. DocumentAccess was designed based on the concept of Success/Failure.
If a method call is successful, it returns a boolean value of True.
If a method call fails, it returns a boolean value of False and the errors collection will be populated with specific information regarding the reason for failure.
Count of declaration lines: 14
Count of lines: 74

Properties:

| Name | Value |
|---|---|
| DataBindingBehavior | 0 |
| DataSourceBehavior | 0 |
| Instancing | 2 |
| MTSTransactionMode | 0 |
| Name | Errors |
| Persistable | 0 |

Procedures:

| Name | Scope | Type |
|---|---|---|
| Count | | Property Get |
| Item | | Function |
| NewEnum | | Function |
| Add | Friend | Subroutine |
| Remove | Friend | Subroutine |
| Clear | Public | Subroutine |
| LoadError | Public | Subroutine |

Procedure Count
Type: Property Get
Scope:
Count of lines: 5
Declaration:
Property Get Count( ) As Long
Parameters: None
Comment:
This property returns the number of items in the collection

Procedure Item
Type: Function
Scope:
Count of lines: 6
Declaration:
Function Item(index As Variant) As Error

Parameters:

| Name | Type | ByVal/ByRef | Optional (Default Value) |
|---|---|---|---|
| index | Variant | ByRef | No |

Comment:
Return a Error item from the collection

Procedure NewEnum
Type: Function
Scope:
Count of lines: 6
Declaration:
Function NewEnum( ) As IUnknown
Parameters: None
Comment:
This method implements support for enumeration (For Each loops)

Procedure Add
Type: Subroutine
Scope: Friend
Count of lines: 9
Declaration:
Friend Sub Add(newItem As Error, Optional Key As Variant)

Parameters:

| Name | Type | ByVal/ByRef | Optional (Default Value) |
|---|---|---|---|
| newItem | Error | ByRef | No |
| Key | Variant | ByRef | Yes ( ) |

Comment:
Add a new Error item to the collection

Procedure Remove
Type: Subroutine
Scope: Friend
Count of lines: 6
Declaration:
Friend Sub Remove(index As Variant)

Parameters:

| Name | Type | ByVal/ByRef | Optional (Default Value) |
|---|---|---|---|
| index | Variant | ByRef | No |

Comment:
Remove an item from the collection

Procedure Clear
Type: Subroutine
Scope: Public
Count of lines: 5
Declaration:
Public Sub Clear( )
Parameters: None
Comment:
This method removes all items from the collection

Procedure LoadError
Type: Subroutine
Scope: Public
Count of lines: 23
Declaration:
Public Sub LoadError(ByVal sDescription As String, ByVal sSource As String, Optional ByVal lNumber As Long=0)

Parameters:

| Name | Type | ByVal/ByRef | Optional (Default Value) |
|---|---|---|---|
| sDescription | String | ByVal | No |
| sSource | String | ByVal | No |
| lNumber | Long | ByVal | Yes (0) |

Comment:
The LoadError method is used to add an error to the errors collection.
This method is used internally to document access to load custom and application errors into the collection.

Class FileSystemAccess (FileSystemAccess.cls)
Comment: None
Count of declaration lines: 3
Count of lines: 775

Properties:

| Name | Value |
|---|---|
| DataBindingBehavior | 0 |
| DataSourceBehavior | 0 |
| Instancing | 1 |
| Name | FileSystemAccess |

Procedures:

| Name | Scope | Type |
|---|---|---|
| BrowseFileSystem | Friend | Function |
| DeleteDocument | Friend | Function |
| DeleteDocumentFromPath | Friend | Function |
| DeleteMasterDocument | Friend | Function |
| DocAccess | Friend | Property Set |
| GetDocument | Friend | Function |
| GetDocumentByID | Friend | Function |
| GetFolder | Friend | Function |
| GetMasterDocument | Friend | Function |
| GetMasterDocumentFolder | Friend | Function |
| GetReleaseDocument | Friend | Function |
| GetReleasesFolder | Friend | Function |
| IsDocumentCheckedOut | Friend | Function |
| SaveDocument | Friend | Function |
| SaveDocumentFromPath | Friend | Function |
| SaveMasterDocument | Friend | Function |
| SaveMasterDocumentFromFile | Friend | Function |
| SaveReleaseDocument | Friend | Function |
| SaveReleaseDocumentFromFile | Friend | Function |
| ReturnFolder | Private | Function |

Procedure BrowseFileSystem
Type: Function
Scope: Friend
Count of lines: 87
Declaration:
Friend Function BrowseFileSystem(Optional hwndOwner As Long, Optional strFilter As String, Optional ByVal FilterIndex As Long=1) As String

Parameters:

| Name | Type | ByVal/ByRef | Optional (Default Value) |
|---|---|---|---|
| hwndOwner | Long | ByRef | Yes ( ) |
| strFilter | String | ByRef | Yes ( ) |
| FilterIndex | Long | ByVal | Yes (1) |

Comment:
used in call setup

Procedure DeleteDocument
Type: Function
Scope: Friend
Count of lines: 21
Declaration:
Friend Function DeleteDocument(ByRef oDoc As Document) As Boolean

Parameters:

| Name | Type | ByVal/ByRef | Optional (Default Value) |
|---|---|---|---|
| oDoc | Document | ByRef | No |

Comment: None

Procedure DeleteDocumentFromPath
Type: Function
Scope: Friend
Count of lines: 18
Declaration:
Friend Function DeleteDocumentFromPath(ByVal strFullFilePath As String) As Boolean

Parameters:

| Name | Type | ByVal/ByRef | Optional (Default Value) |
|---|---|---|---|
| strFullFilePath | String | ByVal | No |

Comment: None

Procedure DeleteMasterDocument
Type: Function
Scope: Friend
Count of lines: 4
Declaration:
Friend Function DeleteMasterDocument( )
Parameters: None
Comment: None

Procedure DocAccess
Type: Property Set
Scope: Friend
Count of lines: 5
Declaration:
Friend Property Set DocAccess(ByRef newValue As DocumentAccess)

Parameters:

| Name | Type | ByVal/ByRef | Optional (Default Value) |
|---|---|---|---|
| newValue | DocumentAccess | ByRef | No |

Comment:
The DocAccess property

Procedure GetDocument
Type: Function
Scope: Friend
Count of lines: 34
Declaration:
Friend Function GetDocument(ByVal strPath As String, ByVal strFileName As String, ByVal strType As String) As Boolean

Parameters:

| Name | Type | ByVal/ByRef | Optional (Default Value) |
|---|---|---|---|
| strPath | String | ByVal | No |
| strFileName | String | ByVal | No |
| strType | String | ByVal | No |

Comment: None

Procedure GetDocumentByID
Type: Function
Scope: Friend
Count of lines: 86
Declaration:
Friend Function GetDocumentByID(ByVal strModelID As String, Optional ByVal blnGetChildren=False) As Boolean

Parameters:

| Name | Type | ByVal/ByRef | Optional (Default Value) |
|---|---|---|---|
| strModelID | String | ByVal | No |
| blnGetChildren | | ByVal | Yes (False) |

Comment:
Returns a document from released project/lineitem

Procedure GetFolder
Type: Function
Scope: Friend
Count of lines: 27
Declaration:
Friend Function GetFolder(ByVal strFolderPath) As Boolean

Parameters:

| Name | Type | ByVal/ByRef | Optional (Default Value) |
|---|---|---|---|
| strFolderPath | | ByVal | No |

Comment: None

Procedure GetMasterDocument
Type: Function
Scope: Friend
Count of lines: 43
Declaration:
Friend Function GetMasterDocument(ByVal strFileName As String) As Boolean

Parameters:

| Name | Type | ByVal/ByRef | Optional (Default Value) |
|---|---|---|---|
| strFileName | String | ByVal | No |

Comment: None

Procedure GetMasterDocumentFolder
Type: Function
Scope: Friend
Count of lines: 28
Declaration:
Friend Function GetMasterDocumentFolder( ) As Boolean
Parameters: None
Comment: None

Procedure GetReleaseDocument
Type: Function
Scope: Friend
Count of lines: 51
Declaration:
Friend Function GetReleaseDocument(ByVal strFileName As String, ByVal IngReleaseID As Long) As Boolean

Parameters:

| Name | Type | ByVal/ByRef | Optional (Default Value) |
|---|---|---|---|
| strFileName | String | ByVal | No |
| lngReleaseID | Long | ByVal | No |

Comment:
xxx add to SS

Procedure GetReleasesFolder
Type: Function
Scope: Friend
Count of lines: 32
Declaration:
Friend Function GetReleasesFolder( ) As Boolean
Parameters: None
Comment: None

Procedure IsDocumentCheckedOut
Type: Function
Scope: Friend
Count of lines: 5
Declaration:
Friend Function IsDocumentCheckedOut( ) As Boolean
Parameters: None
Comment:
this is filesystem . . . the doc can never be checked out

Procedure SaveDocument
Type: Function
Scope: Friend
Count of lines: 34
Declaration:
Friend Function SaveDocument(ByRef oDoc As Document, ByVal strFullDestinationPath As String) As Boolean

Parameters:

| | | | Optional |
|---|---|---|---|
| Name | Type | ByVal/ByRef | (Default Value) |
| oDoc | Document | ByRef | No |
| strFullDestinationPath | String | ByVal | No |

Comment: None

Procedure SaveDocumentFromPath
Type: Function
Scope: Friend
Count of lines: 24
Declaration:
Friend Function SaveDocumentFromPath(ByVal strFullSourcePath As String, ByVal strFullDestinationPath As String) As Boolean

Parameters:

| | | | Optional |
|---|---|---|---|
| Name | Type | ByVal/ByRef | (Default Value) |
| strFullSourcePath | String | ByVal | No |
| strFullDestinationPath | String | ByVal | No |

Comment: None

Procedure SaveMasterDocument
Type: Function
Scope: Friend
Count of lines: 28
Declaration:
Friend Function SaveMasterDocument(ByVal strFullyQualifiedFile As String) As Boolean

Parameters:

| | | | Optional |
|---|---|---|---|
| Name | Type | ByVal/ByRef | (Default Value) |
| strFullyQualifiedFile | String | ByVal | No |

Comment: None

Procedure SaveMasterDocumentFromFile
Type: Function
Scope: Friend
Count of lines: 28
Declaration:
Friend Function SaveMasterDocumentFromFile(ByVal oFile As Scripting.File, ByVal strFileName As String) As Boolean

Parameters:

| Name | Type | ByVal/ByRef | Optional (Default Value) |
|---|---|---|---|
| oFile | Scripting.File | ByVal | No |
| strFileName | String | ByVal | No |

Comment: None

Procedure SaveReleaseDocument
Type: Function
Scope: Friend
Count of lines: 51
Declaration:
Friend Function SaveReleaseDocument(ByVal strFile As String) As Boolean

Parameters:

| Name | Type | ByVal/ByRef | Optional (Default Value) |
|---|---|---|---|
| strFile | String | ByVal | No |

Comment: None

Procedure SaveReleaseDocumentFromFile
Type: Function
Scope: Friend
Count of lines: 27
Declaration:
Friend Function SaveReleaseDocumentFromFile(ByVal oFile As Scripting.File, ByVal strFileName As String) As Boolean

Parameters:

| Name | Type | ByVal/ByRef | Optional (Default Value) |
|---|---|---|---|
| oFile | Scripting.File | ByVal | No |
| strFileName | String | ByVal | No |

Comment: None

Procedure ReturnFolder
Type: Function
Scope: Private
Count of lines: 17
Declaration:
Private Function ReturnFolder(ByVal strFolderPath As String) As Folder

Parameters:

| Name | Type | ByVal/ByRef | Optional (Default Value) |
|---|---|---|---|
| strFolderPath | String | ByVal | No |

Comment: None

Class LibraryFeature (LibraryFeature.cls)
Comment:
Module: LibraryFeature
DateTime: 1/13/2004 11:01
Author: rcarek
Purpose: The LibraryFeature class object exists as a member of LibraryFeatures collection object.
Each object represents the file name of a SolidWorks Library Feature file that was applied to the SolidWorks file that is referenced in the “File” property of the document object.
The references to inserted Library Features are created during Rulestream at runtime and are stored as custom properties on the file object with the prefix “RSLibFeature”
Count of declaration lines: 17
Count of lines: 29

Properties:

| Name | Value |
|---|---|
| DataBindingBehavior | 0 |
| DataSourceBehavior | 0 |
| Instancing | 2 |
| MTSTransactionMode | 0 |
| Name | LibraryFeature |
| Persistable | 0 |

Procedures:

| Name | Scope | Type |
|---|---|---|
| Name | Public | Property Get |
| Name | Public | Property Let |

Procedure Name
Type: Property Get
Scope: Public
Count of lines: 6
Declaration:
Public Property Get Name( ) As String
Parameters: None
Comment:
The Name property represents the file name of the library feature that was inserted into the SolidWorks part file.

Procedure Name
Type: Property Let
Scope: Public
Count of lines: 4
Declaration:
Public Property Let Name(ByVal newValue As String)

Parameters:

| Name | Type | ByVal/ByRef | Optional (Default Value) |
|---|---|---|---|
| newValue | String | ByVal | No |

Comment: None

Class LibraryFeatures (LibraryFeatures.cls)
Comment:
Module: LibraryFeatures
DateTime: Jan. 13, 2004 09:18
Author: rcarek
Purpose: All Library Features applied to the file referenced in the “File” property of the document object are exposed via the “LibraryFeatures” property.
The collection of “LibraryFeature” objects is populated when the “File” property of a document object is set to a reference of a valid file object.
Count of declaration lines: 13
Count of lines: 64

Properties:

| Name | Value |
|---|---|
| DataBindingBehavior | 0 |
| DataSourceBehavior | 0 |
| Instancing | 2 |
| MTSTransactionMode | 0 |
| Name | LibraryFeatures |
| Persistable | 0 |

Procedures:

| Name | Scope | Type |
|---|---|---|
| Count | | Property Get |
| Item | | Function |
| NewEnum | | Function |
| Add | Friend | Function |
| Clear | Friend | Subroutine |
| Remove | Friend | Subroutine |

Procedure Count
Type: Property Get
Scope:
Count of lines: 5
Declaration:
Property Get Count( ) As Long
Parameters: None
Comment:
Return the number of items in the collection

Procedure Item
Type: Function
Scope:
Count of lines: 6
Declaration:
Function Item(index As Variant) As LibraryFeature

Parameters:

| Name | Type | ByVal/ByRef | Optional (Default Value) |
|---|---|---|---|
| index | Variant | ByRef | No |

Comment:
Return a LibraryFeature item from the collection based on its index or key

Procedure NewEnum
Type: Function
Scope:
Count of lines: 6
Declaration:
Function NewEnum( ) As IUnknown
Parameters: None
Comment:
Implement support for enumeration (For Each loops)

Procedure Add
Type: Function
Scope: Friend
Count of lines: 21
Declaration:
Friend Function Add(ByVal strLibraryFeature As String) As LibraryFeature

Parameters:

| Name | Type | ByVal/ByRef | Optional (Default Value) |
|---|---|---|---|
| strLibraryFeature | String | ByVal | No |

Comment:
Add a new LibraryFeature item to the collection

Procedure Clear
Type: Subroutine
Scope: Friend
Count of lines: 5
Declaration:
Friend Sub Clear( )
Parameters: None
Comment:
Remove all items from the collection

Procedure Remove
Type: Subroutine
Scope: Friend
Count of lines: 7
Declaration:
Friend Sub Remove(index As Variant)

Parameters:

| Name | Type | ByVal/ByRef | Optional (Default Value) |
|---|---|---|---|
| index | Variant | ByRef | No |

Comment:
Remove an item from the collection

Class Relation (Relation.cls)
Comment:
Module: Relation
DateTime: Jan. 13, 2004 13:50
Author: rcarek
Purpose: This object exposes the collection key of another document in the Documents collection that represents a hierarchically related document.
Count of declaration lines: 11
Count of lines: 28

Properties:

| Name | Value |
|---|---|
| DataBindingBehavior | 0 |
| DataSourceBehavior | 0 |
| Instancing | 5 |
| MTSTransactionMode | 0 |
| Name | Relation |
| Persistable | 0 |

Procedures:

| Name | Scope | Type |
|---|---|---|
| RelationID | Public | Property Let |
| RelationID | Public | Property Get |

Procedure RelationID
Type: Property Let
Scope: Public
Count of lines: 11
Declaration:
Public Property Let RelationID(ByVal vData As String)

Parameters:

| Name | Type | ByVal/ByRef | Optional (Default Value) |
|---|---|---|---|
| vData | String | ByVal | No |

Comment:
This property represents the key to another document in the documents collection that exists as a relation (parent or child) to the current document.
This allows the definition of hierarchial structure within the construct of a flat collection of objects.

Procedure RelationID
Type: Property Get
Scope: Public
Count of lines: 6
Declaration:
Public Property Get RelationID( ) As String
Parameters: None
Comment:
used when retrieving value of a property, on the right side of an assignment.
Syntax: Debug.Print X.RelationID

Class Relations (Relations.cls)
Comment:
Module: Relations
DateTime: Jan. 13, 2004 13:53
Author: rcarek
Purpose: All relationships of a given document object are exposed via the “Parents” and “Children” properties. These properties expose the “Relations” type object.
This object contains a collection “Relation” objects.
Note: While the documents collection exists as flat structure of document objects, each object can contain (via its parents and children properties) references to other objects in the collection to define a hierarchical structure.
Count of declaration lines: 16
Count of lines: 72

Properties:

| Name | Value |
|---|---|
| DataBindingBehavior | 0 |
| DataSourceBehavior | 0 |
| Instancing | 5 |
| MTSTransactionMode | 0 |
| Name | Relations |
| Persistable | 0 |

Procedures:

| Name | Scope | Type |
|---|---|---|
| Add | Friend | Function |
| Class_Initialize | Private | Subroutine |
| Class_Terminate | Private | Subroutine |
| Count | Public | Property Get |
| Item | Public | Property Get |
| NewEnum | Public | Property Get |
| Remove | Public | Subroutine |

Procedure Add
Type: Function
Scope: Friend
Count of lines: 18
Declaration:
Friend Function Add(RelationID As String, Optional sKey As String) As Relation

Parameters:

| Name | Type | ByVal/ByRef | Optional (Default Value) |
|---|---|---|---|
| RelationID | String | ByRef | No |
| sKey | String | ByRef | Yes ( ) |

Comment:
create a new object

Procedure Class_Initialize
Type: Subroutine
Scope: Private
Count of lines: 5
Declaration:
Private Sub Class_Initialize( )
Parameters: None
Comment:
creates the collection when this class is created

Procedure Class_Terminate
Type: Subroutine
Scope: Private
Count of lines: 5
Declaration:
Private Sub Class_Terminate( )
Parameters: None
Comment:
destroys collection when this class is terminated

Procedure Count
Type: Property Get
Scope: Public
Count of lines: 6
Declaration:
Public Property Get Count( ) As Long
Parameters: None
Comment:
used when retrieving the number of elements in the collection. Syntax: Debug.Print x.Count

Procedure Item
Type: Property Get
Scope: Public
Count of lines: 8
Declaration:
Public Property Get Item(vntIndexKey As Variant) As Relation

Parameters:

| Name | Type | ByVal/ByRef | Optional (Default Value) |
|---|---|---|---|
| vntIndexKey | Variant | ByRef | No |

Comment:
used when referencing an element in the collection vntIndexKey contains either the Index or Key to the collection, this is why it is declared as a Variant
Syntax: Set foo=x.Item(xyz) or Set foo=x.Item(5)

Procedure NewEnum
Type: Property Get
Scope: Public
Count of lines: 6
Declaration:
Public Property Get NewEnum( ) As IUnknown
Parameters: None
Comment:
this property allows you to enumerate this collection with the For . . . Each syntax

Procedure Remove
Type: Subroutine
Scope: Public
Count of lines: 8
Declaration:
Public Sub Remove(vntIndexKey As Variant)

Parameters:

| Name | Type | ByVal/ByRef | Optional (Default Value) |
|---|---|---|---|
| vntIndexKey | Variant | ByRef | No |

Comment:
used when removing an element from the collection vntIndexKey contains either the Index or Key, which is why it is declared as a Variant
Syntax: x.Remove(xyz)

Module modConstants (modConstants.bas)
Comment: None
Count of declaration lines: 342
Count of lines: 342

Properties:

| Name | Value |
|---|---|
| Name | modConstants |

Procedures: None

Module modDocProps (modDocProps.bas)
Comment: None
Count of declaration lines: 31
Count of lines: 31

Properties:

| Name | Value |
|---|---|
| Name | modDocProps |

Procedures: None

Module modDocuments (modDocuments.bas)
Comment: None
Count of declaration lines: 108
Count of lines: 1361

Properties:

| Name | Value |
|---|---|
| Name | modDocuments |

Procedures:

| Name | Scope | Type |
|---|---|---|
| CleanString | | Function |
| GetPart | Private | Function |
| ProfileSectionToVariantVector | Private | Function |
| CountChars | Public | Function |
| Decrypt | Public | Function |
| DTSInstalled | Public | Function |
| Encrypt | Public | Function |
| FormatReleaseFolder | Public | Function |
| FormatReleaseProject | Public | Function |
| FormLoaded | Public | Function |
| GetINIString | Public | Function |
| GetNameWithoutSuffix | Public | Function |
| KeyExists | Public | Function |
| KeyExists2 | Public | Function |
| LoadGif | Public | Function |
| LongToNull | Public | Function |
| NullToDouble | Public | Function |
| NullToLong | Public | Function |
| NullToString | Public | Function |
| ProcessPathWithSpaces | Public | Function |
| ReadCustomProperty | Public | Function |
| ReplaceQuote | Public | Function |
| SaveINIString | Public | Subroutine |
| SearchArray | Public | Function |
| SelectText | Public | Subroutine |
| Sort Array | Public | Subroutine |
| StringToNull | Public | Function |
| ValueExists | Public | Function |
| WriteCustomProperty | Public | Subroutine |
| ZeroToNull | Public | Function |

Procedure CleanString
Type: Function
Scope:
Count of lines: 16
Declaration:
Function CleanString(ByVal str As String) As String

Parameters:

| Name | Type | ByVal/ByRef | Optional (Default Value) |
|---|---|---|---|
| str | String | ByVal | No |

Comment: None

Procedure GetPart
Type: Function
Scope: Private
Count of lines: 28
Declaration:
Private Function GetPart(startStrg As String, delimiter As String) As String

Parameters:

| Name | Type | ByVal/ByRef | Optional (Default Value) |
|---|---|---|---|
| startStrg | String | ByRef | No |
| delimiter | String | ByRef | No |

Comment:
takes a string separated by “delimiter”,
splits off 1 item, and shortens the string so that the next item is ready for removal.

Procedure ProfileSectionToVariantVector
Type: Function
Scope: Private
Count of lines: 39
Declaration:
Private Function ProfileSectionToVariantVector(ByRef rSections( ) As Variant, ByRef rsection As String) As Long

Parameters:

| Name | Type | ByVal/ByRef | Optional (Default Value) |
|---|---|---|---|
| rSections( ) | Variant | ByRef | No |
| rsection | String | ByRef | No |

Comment: None

Procedure CountChars
Type: Function
Scope: Public
Count of lines: 19
Declaration:
Public Function CountChars(ByVal strTemp As String, ByVal strChar As String) As Long

Parameters:

| Name | Type | ByVal/ByRef | Optional (Default Value) |
|---|---|---|---|
| strTemp | String | ByVal | No |
| strChar | String | ByVal | No |

Comment: None

Procedure Decrypt
Type: Function
Scope: Public
Count of lines: 35
Declaration:
Public Function Decrypt(sEncryptedData As String) As String

Parameters:

| Name | Type | ByVal/ByRef | Optional (Default Value) |
|---|---|---|---|
| sEncryptedData | String | ByRef | No |

Comment:
Decrypts a string using the ENCRYPT_KEY constant

Procedure DTSInstalled
Type: Function
Scope: Public
Count of lines: 15
Declaration:
Public Function DTSInstalled( ) As Boolean
Parameters: None
Comment: None

Procedure Encrypt
Type: Function
Scope: Public
Count of lines: 39
Declaration:
Public Function Encrypt(sData As String) As String

Parameters:

| Name | Type | ByVal/ByRef | Optional (Default Value) |
|---|---|---|---|
| sData | String | ByRef | No |

Comment:
Encrypts a string using the ENCRYPT_KEY constant

Procedure FormatReleaseFolder
Type: Function
Scope: Public
Count of lines: 28
Declaration:
Public Function FormatReleaseFolder(ByVal IngReleaseID As String, ByVal strProjectID As String, ByVal lngLineItem As Long, ByVal strReleaseFolder As String) As String

Parameters:

| Name | Type | ByVal/ByRef | Optional (Default Value) |
|---|---|---|---|
| lngReleaseID | String | ByVal | No |
| strProjectID | String | ByVal | No |
| lngLineItem | Long | ByVal | No |
| strReleaseFolder | String | ByVal | No |

Comment: None

Procedure FormatReleaseProject
Type: Function
Scope: Public
Count of lines: 6
Declaration:
Public Function FormatReleaseProject(ByVal IngReleaseID As String, ByVal strProjectID As String, ByVal lngLineItem As Long) As String

Parameters:

| Name | Type | ByVal/ByRef | Optional (Default Value) |
|---|---|---|---|
| lngReleaseID | String | ByVal | No |
| strProjectID | String | ByVal | No |
| lngLineItem | Long | ByVal | No |

Comment: None

Procedure FormLoaded
Type: Function
Scope: Public
Count of lines: 11
Declaration:
Public Function FormLoaded(ByVal strForm As String) As Boolean

Parameters:

| Name | Type | ByVal/ByRef | Optional (Default Value) |
|---|---|---|---|
| strForm | String | ByVal | No |

Comment: None

Procedure GetINIString
Type: Function
Scope: Public
Count of lines: 19
Declaration:
Public Function GetINIString(ByVal Section As String, ByVal Entry As String, ByVal Default As String, ByVal INIPath As String, Optional ByVal SaveIfNotExists As Boolean=True) As String

Parameters:

| Name | Type | ByVal/ByRef | Optional (Default Value) |
|---|---|---|---|
| Section | String | ByVal | No |
| Entry | String | ByVal | No |
| Default | String | ByVal | No |
| INIPath | String | ByVal | No |
| SaveIfNotExists | Boolean | ByVal | Yes (True) |

Comment: None

Procedure GetNameWithoutSuffix
Type: Function
Scope: Public
Count of lines: 10
Declaration:
Public Function GetNameWithoutSuffix(ByVal strName As String) As String

Parameters:

| Name | Type | ByVal/ByRef | Optional (Default Value) |
|---|---|---|---|
| strName | String | ByVal | No |

Comment: None

Procedure KeyExists
Type: Function
Scope: Public
Count of lines: 15
Declaration:
Public Function KeyExists(Col As Collection, ByVal strKey As String) As Variant

Parameters:

| Name | Type | ByVal/ByRef | Optional (Default Value) |
|---|---|---|---|
| Col | Collection | ByRef | No |
| strKey | String | ByVal | No |

Comment: None

Procedure KeyExists2
Type: Function
Scope: Public
Count of lines: 15
Declaration:
Public Function KeyExists2(Col As Collection, ByVal strKey As String) As Variant

Parameters:

| Name | Type | ByVal/ByRef | Optional (Default Value) |
|---|---|---|---|
| Col | Collection | ByRef | No |
| strKey | String | ByVal | No |

Comment:
for use with NON-Objects

Procedure LoadGif
Type: Function
Scope: Public
Count of lines: 162
Declaration:
Public Function LoadGif(sFile As String, aImg As Variant) As Long

Parameters:

| Name | Type | ByVal/ByRef | Optional (Default Value) |
|---|---|---|---|
| sFile | String | ByRef | No |
| aImg | Variant | ByRef | No |

Comment: None

Procedure LongToNull
Type: Function
Scope: Public
Count of lines: 8
Declaration:
Public Function LongToNull(Data As Variant) As String

Parameters:

| Name | Type | ByVal/ByRef | Optional (Default Value) |
|---|---|---|---|
| Data | Variant | ByRef | No |

Comment: None

Procedure NullToDouble
Type: Function
Scope: Public
Count of lines: 21
Declaration:
Public Function NullToDouble(Data As Variant) As Double

Parameters:

| Name | Type | ByVal/ByRef | Optional (Default Value) |
|---|---|---|---|
| Data | Variant | ByRef | No |

Comment: None

Procedure NullToLong
Type: Function
Scope: Public
Count of lines: 21
Declaration:
Public Function NullToLong(Data As Variant) As Long

Parameters:

| Name | Type | ByVal/ByRef | Optional (Default Value) |
|---|---|---|---|
| Data | Variant | ByRef | No |

Comment: None

Procedure NullToString
Type: Function
Scope: Public
Count of lines: 18
Declaration:
Public Function NullToString(Data As Variant) As String

Parameters:

| Name | Type | ByVal/ByRef | Optional (Default Value) |
|---|---|---|---|
| Data | Variant | ByRef | No |

Comment: None

Procedure ProcessPathWithSpaces
Type: Function
Scope: Public
Count of lines: 40
Declaration:
Public Function ProcessPathWithSpaces(strPath As String)

Parameters:

| Name | Type | ByVal/ByRef | Optional (Default Value) |
|---|---|---|---|
| strPath | String | ByRef | No |

Comment: None

Procedure ReadCustomProperty
Type: Function
Scope: Public
Count of lines: 21
Declaration:
Public Function ReadCustomProperty(ByVal strFullFileNameAndPath, ByVal strPropertyName As String) As String

Parameters:

| | | | Optional |
|---|---|---|---|
| Name | Type | ByVal/ByRef | (Default Value) |
| strFullFileNameAndPath | | ByVal | No |
| strPropertyName | String | ByVal | No |

Comment: None

Procedure ReplaceQuote
Type: Function
Scope: Public
Count of lines: 4
Declaration:
Public Function ReplaceQuote(str As String) As String

Parameters:

| Name | Type | ByVal/ByRef | Optional (Default Value) |
|---|---|---|---|
| str | String | ByRef | No |

Comment: None

Procedure SaveINIString
Type: Subroutine
Scope: Public
Count of lines: 7
Declaration:
Public Sub SaveINIString(ByVal Section As String, ByVal Entry As String, ByVal WriteData As String, INIPath As String)

Parameters:

| Name | Type | ByVal/ByRef | Optional (Default Value) |
|---|---|---|---|
| Section | String | ByVal | No |
| Entry | String | ByVal | No |
| WriteData | String | ByVal | No |
| INIPath | String | ByRef | No |

Comment:
If WriteData=“ ” Then WriteData=“ ”

Procedure SearchArray
Type: Function
Scope: Public
Count of lines: 27
Declaration:
Public Function SearchArray(ArrayToSearch( ) As String, SearchFor As String) As Long

Parameters:

| Name | Type | ByVal/ByRef | Optional (Default Value) |
|---|---|---|---|
| ArrayToSearch( ) | String | ByRef | No |
| SearchFor | String | ByRef | No |

Comment: None

Procedure SelectText
Type: Subroutine
Scope: Public
Count of lines: 12
Declaration:
Public Sub SelectText( )
Parameters: None
Comment: None

Procedure SortArray
Type: Subroutine
Scope: Public
Count of lines: 40
Declaration:
Public Sub SortArray(vArray As Variant, lngLBound As Long, lngUBound As Long)

Parameters:

| Name | Type | ByVal/ByRef | Optional (Default Value) |
|---|---|---|---|
| vArray | Variant | ByRef | No |
| lngLBound | Long | ByRef | No |
| lngUBound | Long | ByRef | No |

Comment: None

Procedure StringToNull
Type: Function
Scope: Public
Count of lines: 23
Declaration:
Public Function StringToNull(ByVal Data As String) As String

Parameters:

| Name | Type | ByVal/ByRef | Optional (Default Value) |
|---|---|---|---|
| Data | String | ByVal | No |

Comment: None

Procedure ValueExists
Type: Function
Scope: Public
Count of lines: 15
Declaration:
Public Function ValueExists(ByRef pvntValue As Variant, ByRef pdicValidValues As Dictionary) As Variant

Parameters:

| Name | Type | ByVal/ByRef | Optional (Default Value) |
|---|---|---|---|
| pvntValue | Variant | ByRef | No |
| pdicValidValues | Dictionary | ByRef | No |

Comment:
checks the validvalues dictionary for the specified value and if found returns the key otherwise returns vbnullstring

Procedure WriteCustomProperty
Type: Subroutine
Scope: Public
Count of lines: 27
Declaration:
Public Sub WriteCustomProperty(ByVal strFullFileNameAndPath, ByVal strPropertyName As String, ByVal strPropertyValue As String)

Parameters:

| | | | Optional |
|---|---|---|---|
| Name | Type | ByVal/ByRef | (Default Value) |
| strFullFileNameAndPath | | ByVal | No |
| strPropertyName | String | ByVal | No |
| strPropertyValue | String | ByVal | No |

Comment: None

Procedure ZeroToNull
Type: Function
Scope: Public
Count of lines: 14
Declaration:
Public Function ZeroToNull(Data As Variant) As String

Parameters:

| Name | Type | ByVal/ByRef | Optional (Default Value) |
|---|---|---|---|
| Data | Variant | ByRef | No |

Comment: None

Module modErrorHandling (modErrorHandling.bas)
Comment:
Define your custom errors here. Be sure to use numbers greater than 512, to avoid conflicts with OLE error numbers.
Count of declaration lines: 6
Count of lines: 57

Properties:

| Name | Value |
|---|---|
| Name | modErrorHandling |

Procedures:

| Name | Scope | Type |
|---|---|---|
| GetErrorTextFromResource | Private | Function |
| RaiseError | Public | Subroutine |

Procedure GetErrorTextFromResource
Type: Function
Scope: Private
Count of lines: 31
Declaration:
Private Function GetErrorTextFromResource(ErrorNum As Long) As String

Parameters:

| Name | Type | ByVal/ByRef | Optional (Default Value) |
|---|---|---|---|
| ErrorNum | Long | ByRef | No |

Comment: None

Procedure RaiseError
Type: Subroutine
Scope: Public
Count of lines: 18
Declaration:
Public Sub RaiseError(ErrorNumber As Long, Source As String)

Parameters:

| Name | Type | ByVal/ByRef | Optional (Default Value) |
|---|---|---|---|
| ErrorNumber | Long | ByRef | No |
| Source | String | ByRef | No |

Comment: None

Form formBrowsePrompt (formBrowsePrompt.form)
Comment: None
Count of declaration lines: 2
Count of lines: 36

Properties:

| Name | Value |
|---|---|
| Appearance | 1 |
| AutoRedraw | False |
| BackColor | −2147483633 |
| BorderStyle | 3 |
| Caption | Browse Method |
| ClipControls | True |
| ControlBox | True |
| DrawMode | 13 |
| DrawStyle | 0 |
| DrawWidth | 1 |
| Enabled | True |
| FillColor | 0 |
| FillStyle | 1 |
| FontTransparent | True |
| ForeColor | −2147483630 |
| HasDC | True |
| Height | 2610 |
| HelpContextID | 0 |
| KeyPreview | False |
| Left | 2715 |
| LinkMode | 0 |
| LinkTopic | Form1 |
| MaxButton | False |
| MDIChild | False |
| MinButton | False |
| MousePointer | 0 |
| Moveable | True |
| Name | frmBrowsePrompt |
| NegotiateMenus | True |
| OLEDropMode | 0 |
| PaletteMode | 0 |
| RightToLeft | False |
| ScaleHeight | 2130 |
| ScaleLeft | 0 |
| ScaleMode | 1 |
| ScaleTop | 0 |
| ScaleWidth | 5085 |
| ShowInTaskbar | False |
| StartUpPosition | 1 |
| Tag | |
| Top | 3315 |
| Visible | True |
| WhatsThisButton | False |
| WhatsThisHelp | False |
| Width | 5175 |
| WindowState | 0 |

Controls:

| Name | ProgID | Caption |
|---|---|---|
| CancelButton | VB.CommandButton | “Cancel” |
| lblInstructions | VB.Label | “What method would |
| | | you like to use to |
| | | locate your file?” |
| OKButton | VB.CommandButton | “OK” |
| optSystem(0) | VB.OptionButton | “Browse my local |
| | | file system” |
| optSystem(1) | VB.OptionButton | “Browse my PDM System” |
| picQuestion | VB.PictureBox | n/a |

Procedures:

| Name | Scope | Type |
|---|---|---|
| CancelButton_Click | Private | Subroutine |
| Form_Load | Private | Subroutine |
| Form_QueryUnload | Private | Subroutine |
| OKButton_Click | Private | Subroutine |
| Selection | Public | Property Get |

Procedure CancelButton_Click
Type: Subroutine
Scope: Private
Count of lines: 5
Declaration:
Private Sub CancelButton_Click( )
Parameters: None
Comment: None

Procedure Form_Load
Type: Subroutine
Scope: Private
Count of lines: 6
Declaration:
Private Sub Form_Load( )
Parameters: None
Comment: None

Procedure Form_QueryUnload
Type: Subroutine
Scope: Private
Count of lines: 10
Declaration:
Private Sub Form_QueryUnload(Cancel As Integer, UnloadMode As Integer)

Parameters:

| Name | Type | ByVal/ByRef | Optional (Default Value) |
|---|---|---|---|
| Cancel | Integer | ByRef | No |
| UnloadMode | Integer | ByRef | No |

Comment: None

Procedure OKButton Click
Type: Subroutine
Scope: Private
Count of lines: 9
Declaration:
Private Sub OKButton_Click( )
Parameters: None
Comment: None

Procedure Selection
Type: Property Get
Scope: Public
Count of lines: 4
Declaration:
Public Property Get Selection( ) As Integer
Parameters: None
Comment: None

1. A computer-aided modeling system comprising:
a computer-aided design system;
a product document management system; and
a knowledge management system operably coupled to the product document management system for storing and retrieving modeling documents and to the computer-aided design system for generating computer-aided design models based on the modeling documents, the knowledge management system having integrated support for the product document management system.

2. A computer-aided modeling system according to claim 1, wherein the knowledge management system comprises a knowledge management application and a document access manager in communication with the product document management system, wherein the knowledge management application interfaces with the product document management system through the document access manager.

3. A computer-aided modeling system according to claim 2, wherein the document access manager is implemented as a dynamic link library.

4. A computer-aided modeling system according to claim 2, further comprising a fileshare accessible by the document access manager, wherein the document access manager selects between the product document management system and the fileshare for managing documents.

5. A computer-aided modeling system according to claim 1, wherein the product document management system includes at least one predefined document management object specific to the knowledge management system for storing knowledge management system documents related to corresponding computer-aided design system documents.

6. A computer-aided modeling system according to claim 5, wherein the product document management system includes a plurality of knowledge management system specific document management objects, each associated with a different type of computer-aided design system document.

7. A computer-aided modeling system according to claim 6, wherein the product document management system includes a part template object associated with corresponding computer-aided design system part documents and an assembly template object associated with corresponding computer-aided design system assembly documents.

8. A computer-aided modeling system according to claim 7, wherein the knowledge management system stores documents in the product document management system using the objects.

9. A computer-aided modeling system according to claim 1, wherein the knowledge management application generates part numbers for computer-aided design system parts based on part number documents stored in the product document management system.

10. A computer-aided modeling system according to claim 9, wherein the knowledge management application maps a part to one of:
an existing part number, if there is an existing part number for the part; and
a new part number, if there is not an existing part number for the part.

11. A computer-aided modeling system according to claim 1, wherein the product document management system is SmarTeam.

12. A computer-aided modeling system according to claim 1, wherein the product document management system is Matrix.

13. A computer-aided modeling system according to claim 1, further comprising an add-in program for the computer-aided design system, the add-in program providing for interaction between the computer-aided design system and the product document management system for creation and management of template documents to be used by the knowledge management system at run-time.

14. A computer-aided modeling system according to claim 13, wherein the add-in program creates a knowledge management system specific menu in the computer-aided design system.

15. A computer-aided modeling system according to claim 13, wherein the add-in program allows a user to connect to the product document management system.

16. A computer-aided modeling system according to claim 13, wherein the add-in program allows a user to locate and open existing documents in the product document management system.

17. A computer-aided modeling system according to claim 13, wherein the add-in program allows a user to insert a document from the product document management system into a computer-aided design model.

18. A computer-aided modeling system according to claim 13, wherein the add-in program allows a user to classify an active document in the product document management system for part number research.

19. A computer-aided modeling system according to claim 13, wherein the add-in program allows a user to unlock active documents in the product document management system.

20. A computer-aided modeling system according to claim 13, wherein the add-in program allows a user to upload a document into the product document management system for use by the knowledge management system.

21. Apparatus for computer-aided design modeling, the apparatus comprising:
means for storing and managing knowledge management documents in a product document management system; and
means for generating instructions to a computer-aided design system based on the knowledge management documents.

22. Apparatus according to claim 21, further comprising:
means for generating part numbers for computer-aided design system parts based on part number documents stored in the product document management system.
